(19) United States
(12) Patent Application Publication
(10) Pub. No.: US 2026/0050682 A1
(43) Pub. Date: Feb. 19, 2026

(54) SYSTEMS AND METHODS FOR MAPPING INTERFACES

(71) Applicant: AS0001, Inc., Carmel, IN (US)

(72) Inventors: Timothy Butler, Carmel, IN (US); Jonathan J. Thompson, Carmel, IN (US)

(73) Assignee: AS0001, Inc., Carmel, IN (US)

(21) Appl. No.: 19/169,737

(22) Filed: Apr. 3, 2025

Related U.S. Application Data
(63) Continuation-in-part of application No. 18/808,778, filed on Aug. 19, 2024, now Pat. No. 12,299,162.

(51) Int. Cl. G06F 21/62; G06F 21/64

(52) U.S. Cl. CPC G06F 21/6218; G06F 21/64

(57) ABSTRACT

Systems, methods, and computer-readable for configuring an integration environment. A system can include one or more processing circuits configured to receive a request corresponding with at least one decentralized compute and data store interface (DCDSI) endpoint of an integration, wherein the request includes a public identifier and private identifier. The processing circuits further to authenticate access to the integration using the public identifier or the private identifier and determine an access scheme of the DCDSI endpoint based on the request, wherein at least one formatted request corresponds with establishing a communication channel with the integration via the DCDSI endpoint. The processing circuits further to generate one or more configurations of an object package corresponding with the formatted request and invoke the object package to establish the communication channel with the integration by executing a DCDSI endpoint request to the DCDSI endpoint using the formatted request.

### CROSS-REFERENCE TO RELATED PATENT APPLICATIONS

The present application is a Continuation-In-Part of U.S. patent application Ser. No. 18/808,778, filed Aug. 19, 2024, and claims the benefit of the foregoing application under 35 U.S.C. § 120. The foregoing application is incorporated herein by reference in its entirety and for all purposes.

### BACKGROUND

The present implementations relate generally to computer security architecture and software for information security and cybersecurity. In a computer networked environment, entities such as people or companies have vulnerabilities that can result in security incidents. Some entities can desire to implement protections, and some entities can desire to offer protections.

### SUMMARY

Some implementations of the present disclosure relate to method for configuring an integration environment. The method can include receiving, by one or more processing circuits, a request corresponding with at least one decentralized compute and data store interface (DCDSI) endpoint of an integration, wherein the request includes at least a public identifier and a private identifier. The method can include authenticating, by the one or more processing circuits, access to the integration using at least one of the public identifier or the private identifier. The method can include determining, by the one or more processing circuits, an access scheme of the at least one DCDSI endpoint based at least on the request, wherein the access scheme corresponds with one or more formatted requests for the at least one DCDSI endpoint, and wherein at least one formatted request of the one or more formatted requests corresponds with establishing a communication channel with the integration via the at least one DCDSI endpoint. The method can include generating, by the one or more processing circuits, one or more configurations of an object package corresponding with the at least one formatted request, wherein the object package is structured based on at least the access scheme. The method can include invoking, by the one or more processing circuits, the object package to establish the communication channel with the integration by executing a DCDSI endpoint request to the at least one DCDSI endpoint using the at least one formatted request.

In some implementations, the one or more configurations include one or more access roles or access permissions of the integration, and wherein establishing the communication channel includes registering, by the one or more processing circuits, the public identifier with the at least one DCDSI endpoint and configuring, by the one or more processing circuits, the one or more access roles or access permissions based on the access scheme for the at least one DCDSI endpoint.

In some implementations, registering the public identifier includes transmitting, by the one or more processing circuits, a registration request based on the one or more formatted requests to the at least one DCDSI endpoint, the registration request including the public identifier, receiving, by the one or more processing circuits, a registration response from the at least one DCDSI endpoint, the registration response including a unique identifier or token corresponding to the public identifier, and storing, by the one or more processing circuits, the unique identifier or token in a configuration database or ledger.

In some implementations, configuring the one or more access roles or access permissions includes identifying, by the one or more processing circuits, a set of available roles or permissions available to the at least one DCDSI endpoint based on accessing the at least one DCDSI endpoint using the one or more formatted requests, determining, by the one or more processing circuits, the one or more access roles or access permissions from the set of available roles or permissions based at least on the access scheme, and mapping, by the one or more processing circuits, the one or more access roles or access permissions to the public identifier based on interfacing with the at least one DCDSI endpoint to cause the at least one DCDSI endpoint to apply or enforce to the one or more access roles or access permissions responsive to at least one communication corresponding with the public identifier.

In some implementations, determining the access scheme includes transmitting, by the one or more processing circuits, a plurality of self-executing requests to the at least one DCDSI endpoint, wherein the plurality of self-executing requests include instructions configured to cause the at least one DCDSI endpoint to retrieve data corresponding with the access scheme, and identifying or generating, by the one or more processing circuits, the access scheme based at least on a response to the plurality of self-executing requests from the at least one DCDSI endpoint, wherein the response includes the data corresponding with the access scheme.

In some implementations, the method can include validating, by the one or more processing circuits, the one or more configurations based on simulating one or more access requests on the at least one DCDSI endpoint to invoke the object package, wherein invoking the object package to perform validation includes determining at least one response to the one or more simulated access requests corresponds with an expected access outcome based on the one or more configurations.

In some implementations, the method can include, responsive to at least one of (i) failing to receive a response to the one or more simulated access requests from the at least one DCDSI endpoint or (ii) a passage of period of time, reconfiguring, by the one or more processing circuits, the one or more configurations by at least one of updating one or more parameters of the object package, wherein the one or more parameters include rules or settings for generating or transmitting the at least one formatted request to the at least one DCDSI endpoint or updating the access scheme or the one or more formatted requests by modifying one or more fields, values, or structures corresponding with the DCDSI endpoint request. The method can include re-transmitting, by the one or more processing circuits, the one or more access requests to the at least one DCDSI endpoint, and receiving, by the one or more processing circuits, a response from the at least one DCDSI endpoint indicating a validation of the communication channel with the integration.

In some implementations, the method can include responsive to validating the one or more configurations, providing, by the one or more processing circuits, an indication via a graphical user interface, wherein the indication corresponds to a confirmation of the communication channel established with the integration.

In some implementations, invoking the object package includes retrieving, by the one or more processing circuits, the one or more configurations of the object package, populating, by the one or more processing circuits, one or more fields or parameters of the at least one formatted request based at least on the access scheme and the one or more configurations, wherein the one or more fields or parameters correspond with one or more data structures or instructions configured to cause the at least one DCDSI endpoint to perform one or more cyber resilience operations, and transmitting, by the one or more processing circuits, the at least one formatted request to the at least one DCDSI endpoint.

In some implementations, authenticating access to the integration includes determining, by the one or more processing circuits, the public identifier is stored or maintained in a registry of authorized public identifiers accessible to the integration, comparing, by the one or more processing circuits, the private identifier to a cryptographically hashed value or token stored in association with the public identifier, and authenticating, by the one or more processing circuits, the access to the integration based on matching the private identifier and the cryptographically hashed value or token.

Some implementations relate to a system for configuring an integration environment. The system can include one or more processing circuits configured to receive a request corresponding with at least one decentralized compute and data store interface (DCDSI) endpoint of an integration, wherein the request includes at least a public identifier and a private identifier. The one or more processing circuits can be configured to authenticate access to the integration using at least one of the public identifier or the private identifier. The one or more processing circuits can be configured to determine an access scheme of the at least one DCDSI endpoint based at least on the request, wherein the access scheme corresponds with one or more formatted requests for the at least one DCDSI endpoint, and wherein at least one formatted request of the one or more formatted requests corresponds with establishing a communication channel with the integration via the at least one DCDSI endpoint. The one or more processing circuits can be configured to generate one or more configurations of an object package corresponding with the at least one formatted request, wherein the object package is structured based on at least the access scheme. The one or more processing circuits can be configured to invoke the object package to establish the communication channel with the integration by executing a DCDSI endpoint request to the at least one DCDSI endpoint using the at least one formatted request.

In some implementations, the one or more configurations include one or more access roles or access permissions of the integration, and wherein to establish the communication channel, the one or more processing circuits are configured to register the public identifier with the at least one DCDSI endpoint and configure the one or more access roles or access permissions based on the access scheme for the at least one DCDSI endpoint.

In some implementations, to register the public identifier, the one or more processing circuits are configured to transmit a registration request based on the one or more formatted requests to the at least one DCDSI endpoint, the registration request including the public identifier, receive a registration response from the at least one DCDSI endpoint, the registration response including a unique identifier or token corresponding to the public identifier, and store the unique identifier or token in a configuration database or ledger.

In some implementations, to configure the one or more access roles or access permissions, the one or more processing circuits are configured to identify a set of available roles or permissions available to the at least one DCDSI endpoint based on accessing the at least one DCDSI endpoint using the one or more formatted requests, determine the one or more access roles or access permissions from the set of available roles or permissions based at least on the access scheme, and map the one or more access roles or access permissions to the public identifier based on interfacing with the at least one DCDSI endpoint to cause the at least one DCDSI endpoint to apply or enforce to the one or more access roles or access permissions responsive to at least one communication corresponding with the public identifier.

In some implementations, to determine the access scheme, the one or more processing circuits are configured to transmit a plurality of self-executing requests to the at least one DCDSI endpoint, wherein the plurality of self-executing requests include instructions configured to cause the at least one DCDSI endpoint to retrieve data corresponding with the access scheme, and identify or generate the access scheme based at least on a response to the plurality of self-executing requests from the at least one DCDSI endpoint, wherein the response includes the data corresponding with the access scheme.

In some implementations, the one or more processing circuits are configured to validate the one or more configurations based on simulating one or more access requests on the at least one DCDSI endpoint to invoke the object package, wherein invoking the object package to perform validation includes determining at least one response to the one or more simulated access requests corresponds with an expected access outcome based on the one or more configurations.

In some implementations, the one or more processing circuits are configured to generate the one or more simulated access requests by modifying the one or more formatted requests based on the one or more configurations, and determine the one or more configurations are validated based at least on receiving a response to the one or more simulated access requests from the at least one DCDSI endpoint.

In some implementations, the one or more processing circuits are configured to, responsive to at least one of (i) failing to receive a response to the one or more access requests from the at least one DCDSI endpoint or (ii) a passage of period of time, reconfigure the one or more configurations by at least one of updating one or more parameters of the object package, wherein the one or more parameters include rules or settings for generating or transmitting the at least one formatted request to the at least one DCDSI endpoint. or updating the access scheme or the one or more formatted requests by modifying one or more fields, values, or structures corresponding with the DCDSI endpoint request. The one or more processing circuits can be configured to re-transmit the one or more access requests to the at least one DCDSI endpoint, and receive a response from the at least one DCDSI endpoint indicating a validation of the communication channel with the integration.

In some implementations, the one or more processing circuits are configured to, responsive to validating the one or more configurations, provide an indication via a graphical user interface, wherein the indication corresponds to a confirmation of the communication channel established with the integration.

Some implementations relate to a non-transitory computer-readable medium (CRM) including one or more instructions stored thereon and executable by one or more processors to receive a request corresponding with at least one decentralized compute and data store interface (DCDSI) endpoint of an integration, wherein the request includes at least a public identifier and a private identifier, authenticate access to the integration using at least one of the public identifier or the private identifier, determine an access scheme of the at least one DCDSI endpoint based at least on the request, wherein the access scheme corresponds with one or more formatted requests for the at least one DCDSI endpoint, and wherein at least one formatted request of the one or more formatted requests corresponds with establishing a communication channel with the integration via the at least one DCDSI endpoint, generate one or more configurations of an object package corresponding with the at least one formatted request, wherein the object package is structured based on at least the access scheme, and invoke the object package to establish the communication channel with the integration by executing a DCDSI endpoint request to the at least one DCDSI endpoint using the at least one formatted request.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1A depicts a block diagram of an implementation of a system for managing and configuring incident responses, according to some implementations.

FIG. 1B depicts a block diagram of a more detailed architecture of certain systems or devices of FIG. 1A, according to some implementations.

FIG. 2 depicts a computer system, according to some implementations.

FIG. 3 depicts an architecture that facilitates data acquisition and analysis, according to some implementations.

FIGS. 4A-4B depicts a flowchart for a method for incident response preparedness and readiness, according to some implementations.

FIG. 5 depicts an example vendor-provider marketplace, according to some implementations.

FIG. 6 depicts a flowchart for a method for capturing the state of capabilities, according to some implementations.

FIG. 7 depicts a block diagram of an implementation of a system for cyber resilience tokenization, according to some implementations.

FIG. 8 depicts a block diagram of a more detailed architecture of certain systems or devices of FIG. 7, according to some implementations.

FIG. 9 depicts a block diagram of a more detailed architecture of certain systems or devices of FIG. 7, according to some implementations.

FIGS. 10A-10I depict an architecture for tokenized cyber resilience data, according to some implementations.

FIG. 11 a block diagram of an implementation of a system for endpoint integration and mapping, according to some implementations.

FIG. 12 depicts a block diagram of a more detailed architecture of certain systems or devices of FIG. 11, according to some implementations.

FIG. 13 depicts a flowchart for a method of endpoint integration and mapping, according to some implementations.

FIG. 14 depicts a block diagram of an implementation of a system for mapping interfaces, according to some implementations.

FIG. 15 depicts a block diagram of an implementation of a system for mapping interfaces, according to some implementations.

FIG. 16 depicts a flowchart for a method for mapping interfaces, according to some implementations.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Referring generally to the FIGURES, systems and methods relate generally to implementing endpoint integrations and mapping. In some implementations, the implementations can include a security architecture that models cyber resilience data using cyber resilience identities and associated metadata. In some implementations, the system represents an implementation of an endpoint integration and mapping system.

Existing cybersecurity systems and architectures exhibit multiple technical limitations, reducing effectiveness in managing and responding to cyber threats. One technical limitation involves the absence of integrated incident response capabilities. Numerous systems operate in isolation, utilizing separate tools for threat detection, response, and recovery, leading to delays in response times, communication challenges between components, and fragmented visibility into the overall security posture. Another limitation involves the absence of streamlined processes for engaging third party vendors for incident response services, often requiring navigation through complex procurement protocols during a cyber incident, which delays mitigation efforts. Systems frequently implement incomplete assessment mechanisms for readiness in incident response, resulting in unclear visibility into system capabilities and constraints, complicating communication with potential response providers. Static defenses, often employed by current systems, fail to adjust to emerging threats. These static defenses introduce vulnerabilities, as attackers continuously evolve their strategies and methods. Systems fail to account for changes in infrastructure and operations, such as the integration of new technologies or modifications in business processes, introducing new potential attack vectors. The reliance on static defenses limits the system from maintaining a robust security posture, increasing exposure to an evolving threat landscape.

The implementations described herein provide technical capabilities for preventing cyber threats, including unauthorized access, data breaches, and cyberattacks, by generating a customized cybersecurity framework tailored to technical requirements. The framework and implementations can be used to identify current cybersecurity vulnerabilities and facilitate connections with vendors offering targeted protection plans. Thereby, the systems can provide enhanced data protections including safeguarding sensitive information such as medical records, financial data, and proprietary business information. The framework and implementations can also reduce economic, and infrastructure burdens associated with data breaches, including expenses related to infrastructure failures, forensic investigations, and legal actions. The cybersecurity models described herein can detect and address vulnerabilities while providing dynamic monitoring of relationships between networks, hardware, devices, and financial entities. The implementations can also improve cybersecurity by enhancing network, infrastructure, technology, and data security. Vendors can use the systems and methods described herein to actively monitor and provide responses to potential threats, improving the overall security posture. The customized cybersecurity frameworks address existing vulnerabilities and anticipate future threats, offering an adaptive and proactive solution to cybersecurity.

Implementation of customized cybersecurity frameworks facilitate technical systems to identify existing vulnerabilities, map vulnerabilities to assets, and provide targeted protection strategies. The technical benefit includes generating remediation recommendations and preventing successful hacking activities, cyberattacks, data breaches, and other cyber incidents. Systems and methods disclosed herein facilitate connections of systems to suitable vendors and other entities, offering security plans customized to vulnerabilities and technical needs identified. Implementations of customized cybersecurity frameworks can improve the process of identifying and addressing vulnerabilities by streamlining resources, facilitating continuous monitoring of cybersecurity status of the system by vendors, providing dynamic responses to potential threats, and maintaining the integrity and security of system infrastructure. Customized frameworks provide technical capabilities to facilitate determinations about cybersecurity strategies by selecting from a range of vendor plans and services, activating plans as needed, and ensuring cybersecurity is actively monitored and managed.

A technical improvement in dynamic cybersecurity architecture comprehension is provided by identifying and mapping cybersecurity vulnerabilities within customized cybersecurity frameworks. The need to maintain separate inventories of network weaknesses, infrastructure vulnerabilities, and operating system susceptibilities can be reduced or eliminated. The implementations of the customized cybersecurity framework can include identifying potential security gaps associated with system identifiers, such as domain identifiers, IP addresses, or subnets. Rather than assessing at least one (e.g., each) subclass of vulnerabilities separately, a computing system utilizes a unified view into the computing environment of the target system and centrally manages the identification of different types of vulnerabilities and associated potential security threats. Vulnerability identification operations can include computer-executed processes to model one or more cybersecurity statuses, determine vulnerabilities based on statuses, and integrate or connect systems to suitable vendors offering appropriate cybersecurity plans.

Additionally, the cybersecurity framework enhances data management and sharing through tokenization of cybersecurity information. Tokenization can encrypt cybersecurity posture and insurance information for secure access and storage, with access controlled by smart contracts. Tokenization can be used to prevent unauthorized access and improves data integrity, enhancing data sharing and trust among stakeholders. Additionally, Distributed Non-Fungible Tokens (DNFTs) can provide transparency in tracking and verifying cybersecurity management events and insurance-related activities. Transparency in these processes can improve the accuracy of cyber risk assessments and reduces the likelihood of fraud, as all parties verify the authenticity of performance history events through mechanisms such as multi-signature wallets or signature verification within smart contracts. Tokenization of cybersecurity information, using NFTs or DNFTs, provides real-time visibility into a cyber risk posture of the client. For example, dynamic visibility can facilitate monitoring of compliance and adjustments to policies based on the current risk status of the client. That is, access to up-to-date information allows insurers to provide accurate and fair policy pricing, aligning incentives between insurers, brokers, and policyholders. Real-time monitoring capabilities can also provide responsive updates to potential threats, enhancing the overall security posture. The ability to adapt to changes in the cyber threat landscape and organizational infrastructure provides a cybersecurity framework that is improved and remains responsive to evolving risks.

Token integration within cybersecurity frameworks provides a unified view of system cybersecurity status. By consolidating information from various security systems into a single platform, the implementations can conduct cyber threat and risk assessments with greater accuracy and efficiency by accessing data mapped to tokens. That is, the implementations facilitate communication and collaboration between systems, vendors, and carriers, ensuring systems can identify cyber risks collectively. Data location mapping, connection of security stacks, and provision of targeted protection strategies can improve alignment of incentives between various cyber resilience entities. Tokenization also enhances systems through improved protection and fair policy pricing.

Decentralized ledger implementation, such as Blockchain, can be used to enhance the security and integrity of the data exchange process. Decentralized ledgers verify that transactions and data entries are immutable and verifiable, providing a secure and transparent audit trail for cybersecurity activities. Blockchain architecture provides a distributed consensus mechanism that validates transactions without requiring a central authority, reducing the risk of data tampering and unauthorized access. The decentralized nature of Blockchain enhances interoperability between different security platforms, allowing seamless integration and communication among various cybersecurity tools and stakeholders. Resilient infrastructure capable of withstanding cyberattacks facilitates secure and efficient data sharing and management. Tokens on a decentralized ledger improve reliability in cyber risk assessments and strengthen stakeholder confidence in implemented security measures.

Integration of decentralized compute and data store interface (DCDSI) endpoints into cybersecurity frameworks streamlines management and execution of endpoint requests across diverse systems with various integrations and implementations. Identifying and mapping endpoint access information into a standardized format enhances compatibility and interoperability between different APIs and decentralized endpoints. This mapping capability reduces errors during data retrieval and enforces accurate access permissions, improving the overall security posture. Integration of endpoint information into object packages dynamically invoked for tasks provides consistent and adaptable system operations, aligning endpoint interactions with current security policies and access rules.

Generating object packages customized to endpoint types increases flexibility and scalability within cybersecurity frameworks. This approach facilitates the incorporation of new endpoints and the updating of existing endpoints without disrupting ongoing operations. That is, the structuring object packages according to endpoint types and mapping access information to predefined schemes integrates endpoints into the broader cybersecurity infrastructure more efficiently with improved accuracy. Additionally, using machine learning models to extract and update access information from relevant documents can maintain the latest endpoint configurations and requirements, minimizing potential for misconfigurations.

The disclosed system provides an improved model for verifying authenticity and integrity of data exchanged through DCDSI endpoints. Incorporating token-based authorization and rule-based access controls into endpoint management processes restricts access to data to authorized entities. Enhanced data security is achieved by preventing unauthorized access while logging and auditing endpoint interactions. Validation of access information against rules, either before or after data retrieval, improves the security framework through access controls and real-time monitoring of endpoint activities. Additionally, the mapping of output data to predefined formats for storage can facilitate consistent organization and accessibility for future analysis, contributing to a technically improved, dynamic, and responsive cybersecurity infrastructure.

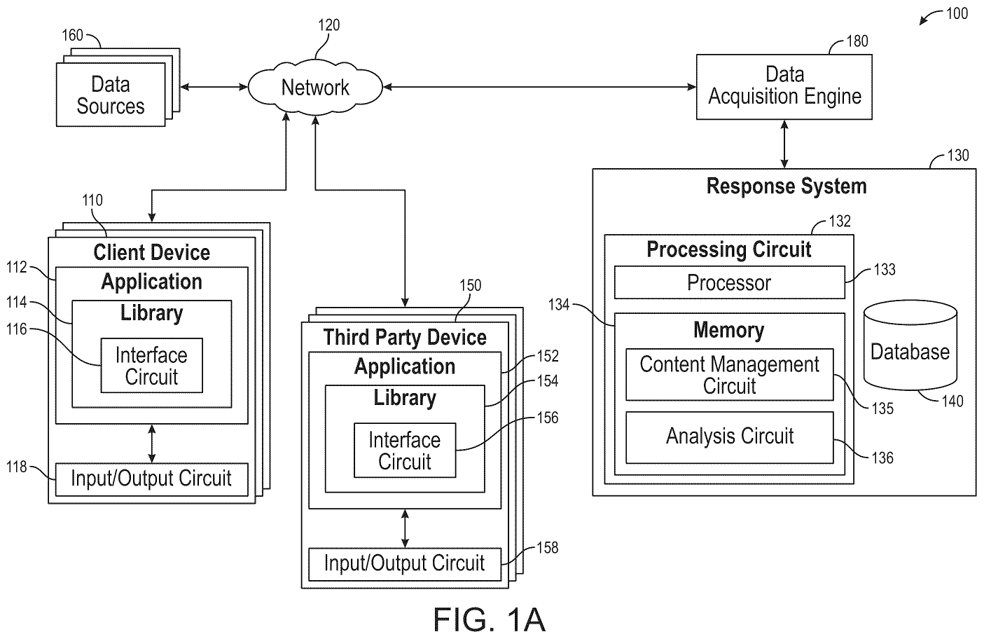

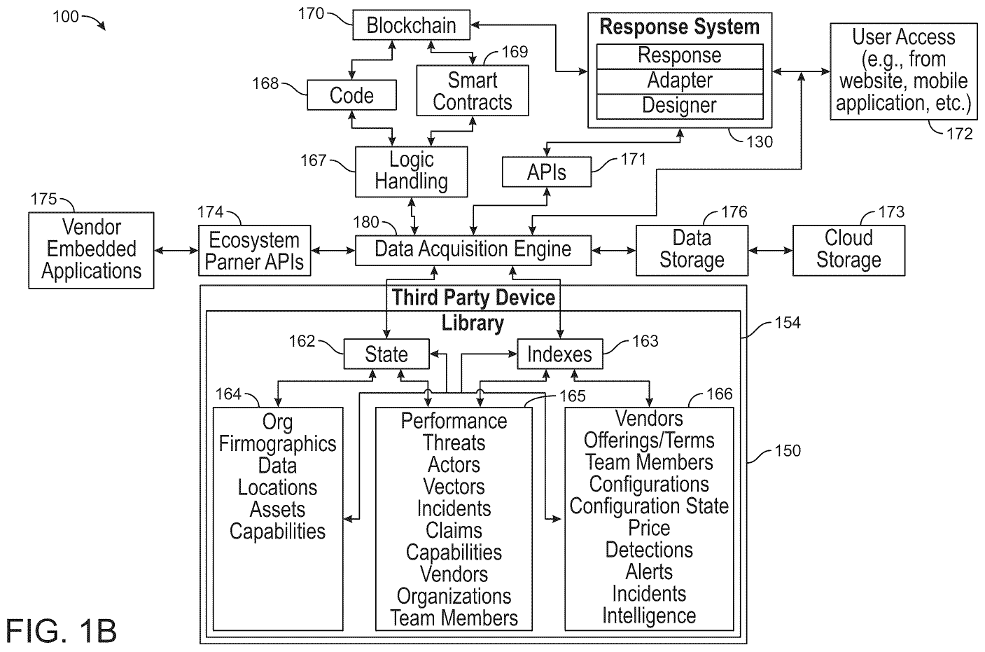

Referring to FIGS. 1A and 1B generally, system 100 is an implementation of a security architecture utilizing modeling to provide an incident response management platform that includes multiple components, such as client device 110, response system 130, third party devices 150, and data sources 160. These components can be interconnected through a network 120 that supports secure communication protocols such as TLS. SSL, and HTTPS. In some implementations, the response system 130 can generate and provide an application for incident response readiness that guides users through the steps to prepare for and manage incidents effectively. The application can integrate with various technologies and vendors to purchase services to resolve issues and provides integration points for incident response workflow management. For example, users can access a marketplace within the application to purchase products, insurance, and services, and can determine the capabilities of their organization, limitations, and threat focus. In some implementations, the response system 130 also presents the readiness of the organization to incident response providers and automatically routes them to pre-associated panel vendors or organization-selected vendors at the point of need, contracting and activating the incident room immediately.

In some implementations, the response system 130 can integrate readiness, including insurer data, into various third party devices via APIs. In some implementations, the response system 130 can map an incident response (IR) plan from a static document or documents to the task enablers in Responder that bring them to life, showing where the tasks used by partners such as IR firms, insurers, and breach counsel are covered by the IR plan and IR playbook. The response system 130 can decompose the response plan into associated actionable tasks and activities by the organization, incident response providers, and other stakeholders, and provides different users and partners with a unified view of tasks, activities, and progress/status tracking.

In some implementations, the response system 130 stores data regarding key milestones in an authoritative data source such as blockchain (e.g., database 140), ensuring that results are traceable and linkable. For example, issues can be identified, tasks can be created, work can be routed to vendors, and proof of resolution can be recorded. In some implementations, the response system 130 can also supports real-time status tracking of policy-aligned tasks to status updates provided for incident response. In some implementations, instant intake is achieved by a remote embeddable widget on a website, which starts an incident response process that begins with a proposal stage and continues through workflows to achieve response readiness based on pre-defined logic and automation. For example, services can be purchased or extended within the application, and in the event of an inbound incident, the application facilitates routing to a claim manager.

In some implementations, the response system 130 can provide an application for incident response readiness that guides users through the steps to ensure they are prepared for any potential incidents. The application can be configured to integrate with technology and vendors to purchase services that are used to resolve issues. For example, the user can access the application through a variety of devices, including client device 110. In particular, the application can offer integration points for incident response workflow management, allowing users to streamline their incident response process. The organization incident readiness feature of the response system 130 offers several features, including the integration of readiness, including insurer data, into various third party systems, such as via an API. By integrating with third party systems, the response system 130 can ensure that users have access to the most up-to-date information regarding the readiness of their organization for potential incidents. In addition, the response system 130 can offer incident response plan mapping from a static plan document to the task enablers in Responder, which brings the tasks used by partners such as IR firms, insurers, and breach counsel to be measurable and identified.

Still referring to FIGS. 1A and 1B generally, the response system 130 can offer a marketplace for purchasing products, insurance, and services that can be used in the event of an incident. The marketplace includes various vendors that offer different products and services, allowing users to choose the best fit for their organization based on their capabilities, limitations, and threat focus. The application also determines organization readiness levels with proof of date, time stamps, and artifacts (e.g., on the blockchain), which can be used to identify any gaps in the incident response plan of their organization. In some implementations, the response system 130 can automate the routing of incidents to pre-associated, panel vendors or organization-selected vendors at the point of need and immediately contracts and activates the incident room (e.g., when a cyber incident occurred or potentially occurred). Accordingly, the system 100 can ensure that the organization can respond to an incident as quickly and efficiently as possible. Additionally, the response system 130 can decompose the response plan into associated actionable tasks and activities by the organization, incident response providers, and others. This allows users to better understand the response plan of their organization and identify areas for improvement.

In general, the application (e.g., graphical user interface provided by content management circuit 135) provides different users/partners with a unified view of tasks, activities, and progress/status tracking. For example, the status tracking can be tied back to incident readiness and managing the incident through resolution. Users can collaborate via the tool instead of via phone calls and emails, which ensures that everyone is working from the same information and avoids any miscommunication. The application can also offers real-time (or near real-time) status tracking of policy aligned tasks to status updates provided for incident response, allowing users to quickly and easily see how their incident response plan is progressing. In some implementations, data regarding key milestones is stored in an authoritative data source such as blockchain (e.g., database 140 (private ledger) or data sources 160 (public ledger)), ensuring that results can be traceable and linkable. Thus, this can allow users to identify areas for improvement in their incident response plan and make changes as necessary. In some implementations, the response system 130 offers an instant intake feature that can be integrated into a remote embeddable widget on a website. For example, the widget can start an incident response process that starts with a proposal stage and continues through workflows to achieve response readiness based on pre-defined logic and automation. This ensures that incidents are quickly identified and resolved, and that the organization is prepared for any potential incidents.

Still referring to FIGS. 1A and 1B generally, the response system 130 of system 100 includes a data acquisition engine 180 and analysis circuit 136 that democratizes posture threats, incidents, and claim data. In particular, all stakeholders in the incident response process can have access to relevant data to make informed decisions. The analysis circuit 136 can use the democratized data in underwriting, claims, and the resilience process to enhance the overall response to an incident. With the data acquisition engine 180, the response system 130 can collect and process data from various sources, such as third party devices 150 and data sources 160, to provide a view of the security posture of the organization. In some implementations, the response system 130 also implement incident response protocols and features via analysis circuit 136 that provide a centralized location for managing and configuring incident responses. For example, an application can walk users through the steps of incident response readiness and integrates with technology and vendors to purchase services to resolve issues. The response system 130 can automate the routing of incident response tasks to pre-associated, panel vendors, or organization-selected vendors at the point of need and immediately contracts and activates the incident room. By decomposing the response plan into associated actionable tasks and activities by the organization, incident response providers, and other stakeholders, the response system 130 ensures that all parties are working together to manage the incident through resolution.

In some implementations, the response system 130 includes a vendor-provider marketplace that allows organizations to purchase products, insurance, and services that enhance their incident response capabilities. For example, the marketplace can be integrated into the response system 130, allowing users to easily access relevant products and services during an incident. Additionally, the response system 130 can determine the capabilities of the organization, limitations, and threat focus to present readiness to incident response providers. In some implementations, the response system 130 can include collection, recall, and proof of state features that provide that data regarding key milestones is stored in an authoritative data source such as the blockchain. This includes capabilities pre-incident, what happened after the incident occurred, what was the root cause, and recording. For example, results are traceable and linkable, and issues are identified, tasks are created, work is routed to vendors, and proof of resolution is recorded. In some implementations, the response system 130 can include a drag and drop file tokenization feature that allows users to securely tokenize and store sensitive files. In particular, this feature is useful when organizations desire to share sensitive information with third parties or with internal stakeholders. The system ensures that the information is secure and that authorized parties can access it. Thus, this feature is designed to streamline the incident response process and ensure better collaboration between all stakeholders.

Referring now to FIG. 1A in more detail, a block diagram depicting an implementation of a system 100 for managing and configuring incident responses. System 100 includes client device 110, response system 130, third party devices 150, and data sources 160. In various implementations, components of system 100 communicate over network 120. Network 120 can include computer networks such as the Internet, local, wide, metro or other area networks, intranets, satellite networks, other computer networks such as voice or data mobile phone communication networks, combinations thereof, or any other type of electronic communications network. Network 120 can include or constitute a display network. In various implementations, network 120 facilitates secure communication between components of system 100. As a non-limiting example, network 120 can implement transport layer security (TLS), secure sockets layer (SSL), hypertext transfer protocol secure (HTTPS), and/or any other secure communication protocol.

In general, the client devices 110 and third party devices 150 can execute a software application (such as application 112 or application 152, e.g., a web browser, an installed application, or other application) to retrieve content from other computing systems and devices over network 120. Such an application can be configured to retrieve an interfaces and dashboards from the response system 130. In one implementation, the client device 110 and third party device 150 can execute a web browser application, which provides the interface (e.g., from content management circuit 135) on a viewport of the client device 110 or third party device 150. The web browser application that provides the interface can operate by receiving input of a uniform resource locator (URL), such as a web address, from an input device (such as input/output circuit 118 or 158, e.g., a pointing device, a keyboard, a touch screen, or another form of input device). In response, one or more processors of the client device 110 or third party device 150 executing the instructions from the web browser application can request data from another device connected to the network 120 referred to by the URL address (e.g., the response system 130). The other device can then provide webpage data and/or other data to the client device 110 or third party device 150, which causes the interface (or dashboard) to be presented by the viewport of the client device 110 or third party device 150. Accordingly, the browser window presents the interface to facilitate user interaction with the interface. In some implementations, the interface (or dashboard) can be presented via an application stored on the client device 110 and third party device 150.

The network 120 can facilitate communication between various nodes, such as the response system 130, third party device 150, client device 110, and data sources 160. In some implementations, data flows through the network 120 from a source node to a destination node as a flow of data packets, e.g., in the form of data packets in accordance with the Open Systems Interconnection (OSI) layers. A flow of packets can use, for example, an OSI layer-4 transport protocol such as the User Datagram Protocol (UDP), the Transmission Control Protocol (TCP), or the Stream Control Transmission Protocol (SCTP), transmitted via the network 120 layered over an OSI layer-3 network protocol such as Internet Protocol (IP), e.g., IPv4 or IPv6. The network 120 is composed of various network devices (nodes) communicatively linked to form one or more data communication paths between participating devices. At least one (e.g., each) networked device includes at least one network interface for receiving and/or transmitting data, typically as one or more data packets. An illustrative network 120 is the Internet; however, other networks can be used. The network 120 can be an autonomous system (AS), e.g., a network that is operated under a consistent unified routing policy (or at least appears to from outside the AS network) and is generally managed by a single administrative entity (e.g., a system operator, administrator, or administrative group).

Client device 110 (sometimes referred to herein as a “mobile device”) can be a mobile computing device, smartphone, tablet, smart watch, smart sensor, or any other device configured to facilitate receiving, displaying, and interacting with content (e.g., web pages, mobile applications, etc.). Client device 110 can include an application 112 to receive and display content and to receive user interaction with the content. For example, application 112 can be a web browser. Additionally, or alternatively, application 112 can be a mobile application. Client device 110 can also include an input/output circuit 118 for communicating data over network 120 (e.g., receive and transmit to response system 130).

In various implementations, application 112 interacts with a content publisher to receive online content, network content, and/or application content. For example, application 112 can receive and present various dashboards and information resources from distributed by the content publisher (e.g., content management circuit 135). Dashboards and/or information resources can include web-based content such as a web page or other online documents. The dashboards information resources can include instructions (e.g., scripts, executable code, etc.) that when interpreted by application 112 cause application 112 to display a graphical user interface such as an interactable web page and/or an interactive mobile application to a user (e.g., dashboards). In various implementations, application 112 can include one or more application interfaces for presenting an application (e.g., mobile application, web-based application, virtual reality/augmented reality application, smart TV application and so on).

Application 112 is shown to include library 114 having an interface circuit 116. The library 114 can include a collection of software development tools contained in a package (e.g., software development kit (SDK), application programming interface (API), integrated development environment (IDE), debugger, etc.). For example, library 114 can include an application programming interface (API). In another example, library 114 can include a debugger. In yet another example, the library 114 can be an SDK that includes an API, a debugger, and IDE, and so on. In some implementations, library 114 includes one or more libraries having functions that interface with a particular system software (e.g., iOS, Android, Linux, etc.). Library 114 can facilitate embedding functionality in application 112. For example, a user can use library 114 to automatically transmit event logs whenever an event occurs on application 112. As a further example, library 114 can include a function configured to collect and report device analytics and a user can insert the function into the instructions of application 112 to cause the function to be called during actions of application 112 (e.g., during testing as described in detail below). In some implementations, interface circuit 116 functionalities are provided by library 114.

In various implementations, interface circuit 116 of system 100 can provide one or more interfaces to users, which can be accessed through an application interface presented in the viewport of client device 110. These interfaces can take the form of dashboards and other graphical user interfaces, offering a variety of functionality to the user. For example, a user can view incident responses, remediate claims, communicate with team members, purchase or extend products and services, and more. The interfaces provided by interface circuit 116 can be customizable and dynamic, allowing users to configure and adjust them to suit their needs. They can also be designed to present real-time data associated with current incident responses, potential incidents or threats, and other important information, allowing users to make informed decisions and take proactive steps to manage risk.

For example, interface circuit 116 can generate dashboards that provide real-time data and insights. These dashboards can be customized to suit the needs of individual users or groups, providing a view of incident responses, potential threats, and the status of remediation efforts. For example, a dashboard might show the status of incident responses across different regions, or highlight areas where additional resources are needed. In another example, the interface circuit 116 can generate a landscape of all currently connected devices to the entity, such as a company or institution. This can include information on the types of devices, their locations, and other data that can help inform incident response efforts. With this information, users can better understand the scope of potential threats, identify vulnerable areas, and take steps to improve security and resilience.

In another example implementation, the application 112 executed by the client device 110 can cause a web browser to the display the interfaces (e.g., dashboards) on the client device 110. For example, the user can connect (e.g., via the network 120) to a website structured to host the interfaces. In various implementations, interface can include infrastructure such as, but not limited to, host devices (e.g., computing device) and a collection of files defining the interface and stored on the host devices (e.g., in database 140). The web browser operates by receiving input of a uniform resource locator (URL) into a field from an input device (e.g., a pointing device, a keyboard, a touchscreen, mobile phone, or another form of input device). In response, the interface circuit 116 executing the interface in the web browser can request data such as from content (e.g., vendor information, settings, current incident response, other dashboards, etc.) from database 140. The web browser can include other functionalities, such as navigational controls (e.g., backward and forward buttons, home buttons). In some implementations, the debugging interface can include both a client-side interface and a server-side interface. For example, a client-side interface can be written in one or more general purpose programming and can be executed by client device 110. The server-side interface can be written, for example, in one or more general purpose programming languages and can be executed by the response system 130.

Interface circuit 116 can detect events within application 112. In various implementations, interface circuit 116 can be configured to trigger other functionality based on detecting events (e.g., transactions, in-app purchases, performing a test of a vendor, scrolling through an incident response plan, sending a contract to a vendor, spending a certain amount of time interacting with an application, etc.). For example, interface circuit 116 can trigger a pop-up window (overlayed on an interface) upon selecting an actionable object (e.g., button, drop-down, input field, etc.) within a dashboard. In various implementations, library 114 includes a function that is embedded in application 112 to trigger interface circuit 116. For example, a user can include a function of library 114 in a transaction confirmation functionality of application 112 that causes interface circuit 116 to detect a confirmed transaction (e.g., purchase cybersecurity protection plans, partnering). It should be understood that events can include any action important to a user within an application and are not limited to the examples expressly contemplated herein. In various implementations, interface circuit 116 is configured to differentiate between different types of events. For example, interface circuit 116 can trigger a first set of actions based on a first type of detected event (e.g., selecting actionable objects within the static response plan) and can trigger a second set of actions based on a second type of detected event (e.g., running a test). In various implementations, interface circuit 116 is configured to collect event logs associated with the detected event and/or events and transmit the collected event logs to content management circuit 135.

In various implementations, the interface circuit 116 can collect events logs based on a designated session. In one example, the designated session can be active from when application 112 is opened/selected to when application 112 is closed/exited. In another example, the designated session can be active based on a user requesting a session to start and a session to end. At least one (e.g., each) session, the interface circuit 116 can collect event logs while the session is active. Once completed, the event logs can be provided to any system described herein. During the session, the event logs can trace at least one (e.g., each) event in the session such that the events are organized in ascending and/or descending order. In some implementations, the events can be organized utilizing various other techniques (e.g., by event type, by timestamp, by malfunctions, etc.).

In various implementations, the interface circuit 116 of the client device 110 (or third party device 150) can start collecting event logs when application 112 is opened (e.g., selected by the user via an input/output circuit 118 of the client device 110), thus starting a session. In some implementations, once the application is closed by the user the interface circuit 116 can stop collecting event logs, thus ending the session. In various implementations, the user can force clear event logs or force reset application 112 such that the current session can reset, thus ending a particular session and starting a new session. Additional details regarding the interface circuit 116 functionalities, and the dashboards and interfaces presented within a viewport of client device 110 are described in additional detail.

The input/output circuit 118 is structured to send and receive communications over network 120 (e.g., with response system 130 and/or third party device 150). The input/output circuit 118 is structured to exchange data (e.g., bundled event logs, content event logs, interactions), communications, instructions, etc. with an input/output component of the response system 130. In one implementation, the input/output circuit 118 includes communication circuitry for facilitating the exchange of data, values, messages, and the like between the input/output circuit 118 and the response system 130. In yet another implementation, the input/output circuit 118 includes machine-readable media for facilitating the exchange of information between the input/output device and the response system 130. In yet another implementation, the input/output circuit 118 includes any combination of hardware components, communication circuitry, and machine-readable media.

In some implementations, the input/output circuit 118 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output circuit 118 can provide an interface for the user to interact with various applications stored on the client device 110. For example, the input/output circuit 118 includes a keyboard, a keypad, a mouse, joystick, a touch screen, a microphone, a haptic sensor, a car sensor, an IoT sensor, a biometric sensor, an accelerometer sensor, a virtual reality headset, smart glasses, smart headsets, and the like. As another example, input/output circuit 118, can include, but is not limited to, a television monitor, a computer monitor, a printer, a facsimile, a speaker, and so on. As used herein, virtual reality, augmented reality, and mixed reality can at least one (e.g., each) be used interchangeably yet refer to any kind of extended reality, including virtual reality, augmented reality, and mixed reality.

In some implementations, input/output circuit 118 of the client device 110 can receive user input from a user (e.g., via sensors, or any other input/output devices/ports described herein). A user input can be a plurality of inputs, including by not limited to, a gesture (e.g., a flick of client device 110, a shake of client device 110, a user-defined custom gesture (e.g., utilizing an API), biological data (e.g., stress level, heart rate, hand geometry, facial geometry, psyche, and so on) and/or behavioral data (e.g., haptic feedback, gesture, speech pattern, movement pattern (e.g., hand, food, arm, facial, iris, and so on), or combination thereof, etc. In some implementations, one or more user inputs can be utilized to perform various actions on client device 110.

For example, a user can use a gesture, such as a flick or a shake, to quickly invoke an incident response through the response system 130 from their client device 110. With the use of biological and behavioral data, a user could trigger an incident response, access the vendor marketplace, or recall proof of state using custom-defined gestures via an API with input/output circuit 118. The drag and drop file tokenization feature can also be activated by a gesture, allowing a user to seamlessly tokenize files and secure them on the blockchain with a simple motion or touch on their client device 110.

Input/output circuit 118 can exchange and transmit data information, via network 120, to all the devices described herein. In various implementations, input/output circuit 118 transmits data via network 120. Input/output circuit 118 can confirm the transmission of data. For example, input/output circuit 118 can transmit requests and/or information to response system 130 based on selecting one or more actionable items within the interfaces and dashboards described herein. In another example, input/output circuit 118 can transmit requests and/or information to third party devices 150 operated one or more vendors. In various implementations, input/output circuit 118 can transmit data periodically. For example, input/output circuit 118 can transmit data at a predefined time. As another example, input/output circuit 118 can transmit data on an interval (e.g., every ten minutes, every ten hours, etc.).

The third party device 150 includes application 152, library 154, interface circuit 156, and input/output circuit 158. The application 152, library 154, interface circuit 156, and input/output circuit 158 can function substantially similar to and include the same or similar components as the components of client device 110, such as application 112, library 114, interface circuit 116, and input/output circuit 118, described above. As such, it should be understood that the description of the client device 110, such as application 112, library 114, interface circuit 116, and input/output circuit 118 of the client device 110 provided above can be similarly applied to the application 152, library 154, interface circuit 156, and input/output circuit 158 of the third party device 150. However, instead of a user of a company or institution operations the third party device 150, a vendor or providers (e.g., goods or services) operates the third party device 150.

The response system 130 can include a logic device, which can be a computing device equipped with a processing circuit that runs instructions stored in a memory device to perform various operations. The processing circuit can be made up of various components such as a microprocessor, an ASIC, or an FPGA, and the memory device can be any type of storage or transmission device capable of providing program instructions. The instructions can include code from various programming languages commonly used in the industry, such as high-level programming languages, web development languages, and systems programming languages. The response system 130 can also include one or more databases for storing data and an interface, such as a content management circuit 135, that receives and provides data to other systems and devices on the network 120.

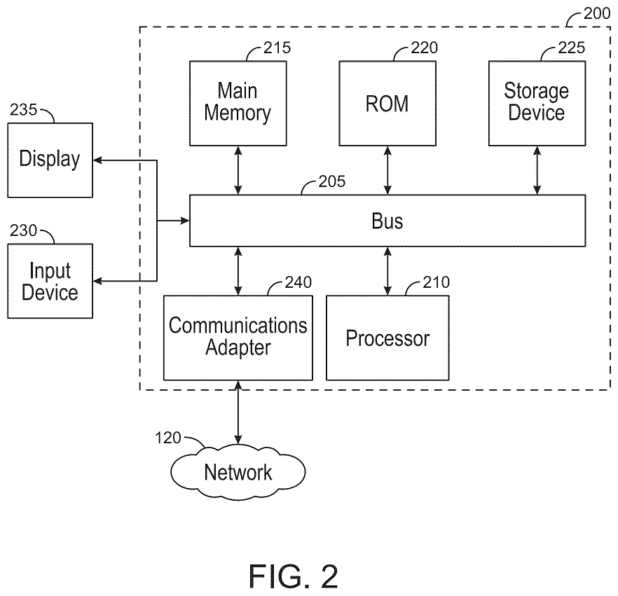

The response system 130 can be run or otherwise be executed on one or more processors of a computing device, such as those described below in FIG. 2. In broad overview, the response system 130 can include a processing circuit 132, a processor 133, memory 134, a content management circuit 135, an analysis circuit 136, a database 140, and a user dataset 142. The interface and dashboards generated by content management circuit 135 can be provided to the client devices 110 and third party devices 150. Generally, the interfaces and dashboards can be rendered at the client devices 110 and/or third party devices 150. The content management circuit 135 can include a plurality of interfaces and properties. The interfaces and dashboards can execute at the response system 130, the client device 110, the third party devices 150, or a combination of the three to provide the interfaces and dashboards. In some implementations, the interfaces and dashboards generated and formatted by content management circuit 135 can be provided within a web browser. In another implementation, the content management circuit 135 executes to provide the interfaces and dashboards at the client devices 110 and third party devices 150 without utilizing the web browser.

The response system 130 can be a server, distributed processing cluster, cloud processing system, or any other computing device. Response system 130 can include or execute at least one computer program or at least one script. In some implementations, response system 130 includes combinations of software and hardware, such as one or more processors configured to execute one or more scripts. Response system 130 is shown to include database 140 and processing circuit 132. Database 140 can store received data. For example, the database 140 can include data structures for storing information such as, but not limited to, the front end information, interfaces, dashboards, incident information, claim information, user information, vendor information, contact information, invoices, a blockchain ledger, etc. The database 140 can be part of the response system 130, or a separate component that the response system 130, the client device 110, or the third party device 150 can access via the network 120. The database 140 can also be distributed throughout system 100. For example, the database 140 can include multiple databases associated with the response system 130, the client device 110, or the third party device 150, or all three. Database 140 can include one or more storage mediums. The storage mediums can include but are not limited to magnetic storage, optical storage, flash storage, and/or RAM. Response system 130 can implement or facilitate various APIs to perform database functions (e.g., managing data stored in database 140). The APIs can be but are not limited to SQL, ODBC, JDBC, NOSQL and/or any other data storage and manipulation API.

Processing circuit 132 includes processor 133 and memory 134. Memory 134 can have instructions stored thereon that, when executed by processor 133, cause processing circuit 132 to perform the various operations described herein. The operations described herein can be implemented using software, hardware, or a combination thereof. Processor 133 can include a microprocessor, ASIC, FPGA, etc., or combinations thereof. In many implementations, processor 133 can be a multi-core processor or an array of processors. Memory 134 can include, but is not limited to, electronic, optical, magnetic, or any other storage devices capable of providing processor 133 with program instructions. Memory 134 can include a floppy disk, CD-ROM, DVD, magnetic disk, memory chip, ROM, RAM, EEPROM, EPROM, flash memory, optical media, or any other suitable memory from which processor 133 can read instructions. The instructions can include code from any suitable computer programming language.

The data sources 160 can provide data to the response system 130. In some implementations, the data sources 160 can be structured to collect data from other devices on network 120 (e.g., client devices 110 and/or third party devices 150) and relay the collected data to the response system 130. In one example, a user and/or entity can have a server and database (e.g., proxy, enterprise resource planning (ERP) system) that stores network information associated with the user and/or entity. In this example, the response system 130 can request data associated with various data stored in the data source (e.g., data sources 160) of the user or entity. For example, in some implementations, the data sources 160 can host or otherwise support a search or discovery engine for Internet-connected devices. The search or discovery engine can provide data, via the data acquisition engine 180, to the response system 130. In some implementations, the data sources 160 can be scanned to provide additional data. The additional data can include newsfeed data (e.g., articles, breaking news, and television content), social media data (e.g., Facebook, Twitter, Snapchat, and TikTok), geolocation data of users on the Internet (e.g., GPS, triangulation, and IP addresses), governmental databases, generative artificial intelligence (GAI) data, and/or any other intelligence data associated with the entity of interest.

The system 100 can include a data acquisition engine 180. In various implementations, the response system 130 can be communicatively and operatively coupled to the data acquisition engine 180. The data acquisition engine 180 can include one or more processing circuits configured to execute various instructions. In various implementations, the data acquisition engine 180 can be configured to facilitate communication (e.g., via network 120) between the response system 130 and systems described herein. The facilitation of communication can be implemented as an application programming interface (API) (e.g., REST API, Web API, customized API), batch files, and/or queries. In various implementations, the data acquisition engine 180 can also be configured to control access to resources of the response system 130 and database 140.

The API can be used by the data acquisition engine 180 and/or computing systems to exchange data and make function calls in a structured format. The API can be configured to specify an appropriate communication protocol using a suitable electronic data interchange (EDI) standard or technology. The EDI standard (e.g., messaging standard and/or supporting technology) can include any of a SQL data set, a protocol buffer message stream, an instantiated class implemented in a suitable object-oriented programming language (e.g., Java, Ruby, C#), an XML file, a text file, an Excel file, a web service message in a suitable web service message format (e.g., representational state transfer (REST), simple object access protocol (SOAP), web service definition language (WSDL), JavaScript object notation (JSON), XML remote procedure call (XML RPC)). As such, EDI messages can be implemented in any of the above or using another suitable technology.

In some implementations, data is exchanged by components of the data acquisition engine 180 using web services. Where data is exchanged using an API configured to exchange web service messages, some or all components of the computing environment can include or can be associated with (e.g., as a client computing device) one or more web service node(s). The web service can be identifiable using a unique network address, such as an IP address, and/or a URL. Some or all components of the computing environment can include circuits structured to access and exchange data using one or more remote procedure call protocols, such as Java remote method invocation (RMI), Windows distributed component object model (DCOM). The web service node(s) can include a web service library including callable code functions. The callable code functions can be structured according to a predefined format, which can include a service name (interface name), an operation name (e.g., read, write, initialize a class), operation input parameters and data type, operation return values and data type, service message format, etc. In some implementations, the callable code functions can include an API structured to access on-demand and/or receive a data feed from a search or discovery engine for Internet-connected devices. Further examples of callable code functions are provided further herein as implemented in various components of the data acquisition engine 180.

The data sources 160 can provide data to the response system 130 based on the data acquisition engine 180 scanning the Internet (e.g., various data sources and/or data feeds) for data associated with a user or entity (e.g., vendor, insurer). That is, the data acquisition engine 180 can hold (e.g., in non-transitory memory, in cache memory, and/or in database 140) the executables for performing the scanning activities on the data sources 160. Further, the response system 130 can initiate the scanning operations. For example, the response system 130 can initiate the scanning operations by retrieving domain identifiers or other user/entity identifiers from a computer-implemented DBMS or queue. In another example, a user can affirmatively request a particular resource (e.g., domain or another entity identifier) to be scanned, which triggers the operations. In various implementations, the data sources 160 can facilitate the communication of data between the client devices 110 and third party devices 150, such that the data sources 160 receive data (e.g., over network 120) from the client devices 110 and third party devices 150 before sending the data other systems described herein (e.g., response system 130). In other implementations and as described herein, the client devices 110 and third party devices 150, and the data sources 160 can send data directly, over the network 120, to any system described herein and the data sources 160 can provide information not provided by any of the client devices 110 and third party devices 150.

As used herein, the terms “scan” and “scanning” refer to and encompass various data collection operations, which can include executing and/or causing to be executed any of the following operations: query(ies), search(es), web crawl(s), interface engine operations structured to allow the data acquisition engine 180 to activate an appropriate system interface to continuously or periodically receive inbound data, document search(es), dataset search(es), retrieval from internal systems of previously received data, etc. These operations can be executed on-demand and/or on a scheduled basis. In some implementations, these operations include receiving data (e.g., device connectivity data, IP traffic data) in response to requesting the data (e.g., data “pull” operations). In some implementations, these operations include receiving data without previously requesting the data (e.g., data “push” operations). In some implementations, the data “push” operations are supported by the interface engine operations.

One of skill will appreciate that data received as a result of performing or causing scanning operations to be performed can include data that has various properties indicative of device properties, hardware, firmware, software, configuration information, and/or IP traffic data. For example, in an implementation, a device connectivity data set can be received. In some implementations, device connectivity data can include data obtained from a search or discovery engine for Internet-connected devices which can include a third party product (e.g., Shodan), a proprietary product, or a combination thereof. Device connectivity data can include structured or unstructured data.

Various properties (sometimes referred to as “attributes”) (e.g., records, delimited values, values that follow particular pre-determined character-based labels) can be parsed from the device connectivity data. The properties can include device-related data and/or IP traffic data. Device-related data can encompass data related to software, firmware, and/or hardware technology deployed to, included in, or coupled to a particular device. Device-related data can include IP address(es), software information, operating system information, component designation (e.g., router, web server), version information, port number(s), timestamp data, host name, etc. IP traffic data can include items included in packets, as described elsewhere herein. Further, IP traffic data included in the device connectivity data can include various supplemental information (e.g., In some implementations, metadata associated with packets), such as host name, organization, Internet Service Provider information, country, city, communication protocol information, and Autonomous System Number (ASN) or similar identifier for a group of devices using a particular defined external routing policy. In some implementations, device connectivity data can be determined at least in part based on banner data exposed by the respective source vendor or insurer. For example, device connectivity data can include metadata about software running on a particular device of a source entity.

In various implementations, vendors and users can utilize Internet-wide scanning tools (e.g., port scanning, network scanning, vulnerability scanning, Internet Control Message Protocol (ICMP) scanning, TCP scanning, UDP scanning, semi-structured and unstructured parsing of publicly available data sources) for collecting data (e.g., states and performance of companies, corporations, users). Further, in addition to this data, other data collected and fused with the data obtained via scanning can be newsfeed data (e.g., articles, breaking news, television), social media data (e.g., Facebook, Twitter, Snapchat, TikTok), geolocation data of users on the Internet (e.g., GPS, triangulation, IP addresses), governmental databases, and any other data associated with the user or entity (e.g., vendor or insurer), their capabilities, configurations, cyber insurance policy, coverage, attestations, questionnaires and overall state of aforementioned attributes.

In some implementations, scanning occurs in real-time such that the data acquisition engine 180 continuously scans the data sources 160 for data associated with a vendor or user (e.g., real-time states of vendors or users, real-time threats, real-time performance). In various implementations, scanning can occur in periodic increments such that the data acquisition engine 180 can scan the Internet for data associated with the vendor or user periodically (e.g., every minute, every hour, every day, every week, and any other increment of time.) In some implementations, data acquisition engine 180 can receive feeds from be various data aggregating systems that collect data associated with vendors or users. For example, the response system 130 can receive vendor or user data from the data sources 160, via the network 120 and data acquisition engine 180. The information collected by the data acquisition engine 180 can be stored in database 140. In some implementations, an entity (e.g., company, vendor, insurer, any service or goods provider, etc.) can submit data to response system 130 and provide information about their products or services, pricing, capabilities, statuses, etc., which can be stored in database 140.

Memory 134 can include analysis circuit 136. The analysis circuit 136 can be configured to perform data fusion operations, including operations to generate and/or aggregate various data structures stored in database 140, which can have been acquired as a result of scanning operations or via another EDI process. For example, the analysis circuit 136 can be configured to aggregate entity data stored in the database 140. The entity data can be a data structure associated with an entity and include various data from a plurality of data channels. In some implementations, the analysis circuit 136 can be configured to aggregate line-of-business data stored in the database 140. The line-of-business data can be a data structure associated with a plurality of line-of-business of an entity and indicate various data from a plurality of data channels based on line-of-business (e.g., information technology (IT), legal, marketing and sales, operations, finance and accounting).

The analysis circuit 136 can also be configured to receive a plurality of user and entity data. In some implementations, the analysis circuit 136 can be configured to receive data regarding the network 120 as a whole (e.g., stored in database 140) instead of data specific to particular users or entities. The received data that the analysis circuit 136 receives can be data that response system 130 aggregates and/or data that the response system 130 receives from the data sources 160 and/or any other system described herein. As previously described, the response system 130 can be configured to receive information regarding various entities and users on the network 120 (e.g., via device connectivity data). Further, the response system 130 can be configured to receive and/or collect information regarding interactions that a particular user or entity has on the network 120 (e.g., via IP traffic data). Further, the response system 130 can be configured to receive and/or collect additional information. Accordingly, the received or collected information can be stored as data in database 140. In various implementations, the database 140 can include user and entity profiles.

The response system 130 can be configured to electronically transmit information and/or notifications relating to various metrics, dashboards (e.g., graphical user interfaces) and/or models it determines, analyzes, fuses, generates, or fits to user data, entity data, and/or other data. This can allow a user of a particular one of the client devices 110 and third party devices 150 to review the various metrics, dashboards, or models which the response system 130 determines. Further, the response system 130 can use the various metrics to identify remediation actions for users and entities. The analysis circuit 136 implements data fusion operations of the response system 130. In various implementations, the analysis circuit 136 can be configured to receive a plurality of data (e.g., user and entity data) from a plurality of data sources (e.g., database 140, client devices 110, third party devices 150, data sources 160) via one or more data channels (e.g., over network 120). At least one (e.g., each) data channel can include a network connection (e.g., wired, wireless, cloud) between the data sources and the response system 130.

In some implementations, the analysis circuit 136 can also be configured to collect a plurality of data from a particular data source or from a plurality of data sources based on electronically transmitting requests to the data sources via the plurality of data channels, managed and routed to a particular data channel by the data acquisition engine 180. A request submitted via the data acquisition engine 180 can include a request for scanning publicly available information exposed by a user or entity. In some implementations, the request submitted via the data acquisition engine 180 can include information regarding access-controlled data being requested from the user or entity. In such cases, the request can include trust verification information sufficient to be authenticated by the target entity (e.g., multi-factor authentication (MFA) information, account login information, request identification number, a pin, certificate information, a private key of a public/private key pair). This information should be sufficient to allow the target entity to verify that a request is valid.

In various implementations, the analysis circuit 136 can be configured to initiate a scan, via the data acquisition engine 180, for a plurality of data from a plurality of data sources based on analyzing device connectivity data, vendor information, scheduling information (e.g., team members), network properties (e.g., status, nodes, element-level (sub-document level), group-level, network-level, size, density, connectedness, clustering, attributes) and/or network information (e.g., IP traffic, domain traffic, subdomain traffic, connected devices, software, infrastructure, bandwidth) of a target computer network environment and/or environments of the entity or associated with the entity. The operations to fuse various properties of data returned via the scan can include a number of different actions, which can parse device connectivity data, packet segmentation, predictive analytics, cross-referencing to data regarding known vulnerabilities, and/or searching data regarding application security history. These operations can be performed to identify costs of vendors, services offered, hosts, ports, and services in a target computer network environment. The target computer network environment can be identified by a unique identifier, such as a domain identifier (e.g., a top-level domain (TLD) identifier, a subdomain identifier, a URL string pointing to a particular directory), an IP address, a subnet, etc. Further, the target computer network environment can be defined with more granularity to encompass a particular component (e.g., an entity identified by an IP address, software/applications/operating systems/exposed API functions associated with a particular port number, IP address, subnet, domain identifier). In some implementations, one or more particular target computer network environments can be linked to an entity profile (e.g., in the database 140). In one example, scanning can include parsing out packet and/or device connectivity data properties that can indicate available UDP and TCP network services running on the target computer network environment. In another example, scanning can include parsing out packet and/or device connectivity data that indicates the operating systems (OS) in use on the target computer network environment.

In various implementations, vendor information can be determined based accessing a vendor device (e.g., third party device 150) or website of the vendor to collect vendor information (e.g., via an API call). In various implementations, vulnerabilities and incidents can be determined based on any software feature, hardware feature, network feature, or combination of these, which could make an entity vulnerable to cyber threats, incidents, such as hacking activities, data breaches, and cyberattacks. In turn, cyber-threats (sometimes referred to herein as “cyber-indents” or “incidents”) increase the probability of cyber-incidents. Accordingly, a vulnerability or incident can be a weakness that could be exploited to gain unauthorized access to or perform unauthorized actions in a computer network environment (e.g., system 100). For example, obsolete computing devices and/or obsolete software can present vulnerabilities and/or threats in a computer network environment. In another example, certain network frameworks can present vulnerabilities and/or threats in a computer network environment. In yet another example, business practices of an entity can present vulnerabilities and/or threats in a computer network environment. In yet another example, published content on the Internet can present vulnerabilities in a computer network environment. In yet another example, third party computing devices and/or software can present vulnerabilities and/or threats in a computer network environment. Accordingly, as shown, all devices (e.g., servers, computers, any infrastructure), all data (e.g., network information, vendor data, network traffic, user data, certificate data, public and/or private content), all practices (e.g., business practices, security protocols), all software (e.g., frameworks, protocols), and any relationship an entity has with another entity can present vulnerabilities and/or threats in a computer network environment that could lead to one or more cyber-incidents.

In broad view, the analysis circuit 136 can also be configured to receive company and vendor information regarding the company/vendor. In some implementations, the analysis circuit 136 can receive a registration request and register user accounts (e.g., accounts). For example, a user of library 114 can register their user account with a client device such that the client device 110 can execute the library 114 and perform various actions. Registering a client device 110 or user (or vendor) can include, but not limited to, providing various identifying information (e.g., device name, geolocation, identifier, etc.), platform designations (e.g., iOS, Android, WebOS, BlackBerry OS, etc.), user actions (e.g., activation gesture, haptic, biometric, etc.), authentication information (e.g., username, password, two-step criteria, security questions, address information, etc.). Once the analysis circuit 136 approves a registration request, the information associated with the request can be stored in database 140. Additionally, a notification can be transmitted to the client device 110 indicating the user, vendor, or client device 110 (or third party device 150) is registered and can utilize the dashboards to perform actions associated with one or more applications.

In various implementations, analysis circuit 136 performs statistical operations on received data to produce statistical measurements describing the received data. For example, analysis circuit 136 can determine capabilities of individuals, objectives, cost estimates, etc. In various implementations, the statistical operations can be calculated based on performing various statistical operations and analysis. In some implementations, received data and previously collected data stored in database 140 can be used to train a machine-learning model. That is, predictions regarding vulnerabilities and incidents could be based on artificial intelligence or a machine-learning model. For example, a first machine-learning model can be trained to identify particular incidents and output a prediction. In this example, a second machine-learning model can be trained to identify remediation actions based on incident. In various implementations, machine learning algorithms can include, but are not limited to, a neural network, convolutional neural network, recurrent neural network, linear regression model, and sparse vector machine). The various computing systems/devices described herein can input various data (e.g., event logs, debugging information and so on) into the machine learning model, and receive an output from the model indicating a particular action to perform. In some implementations, analysis circuit 136 can be configured to perform source testing on one or more networks. Source testing on one or more networks can include performing various test plans. During the source testing, various malfunctions and exceptions can be identified. Additionally, the network can be identified such that the testing occurs on a designated network (e.g., or multiple designated content networks).

Memory 134 also includes content management circuit 135. The content management circuit 135 can be configured to generate content for displaying to users and vendors. The content can be selected from among various resources (e.g., webpages, applications). The content management circuit 135 is also structured to provide content (e.g., via a graphical user interface (GUI)) to the client devices 110 and/or third party devices 150), over the network 120, for display within the resources. For example, in various implementations, a claim dashboard or incident response dashboard can be integrated in a mobile application or computing application or provided via an Internet browser. The content from which the content management circuit 135 selects can be provided by the response system 130 via the network 120 to one or more client devices 110 and/or third party devices 150. In such implementations, the content management circuit 135 can determine content to be generated and published in one or more content interfaces of resources (e.g., webpages, applications).

The content management circuit 135 can be configured to interact with a database management system or data storage vault, where clients can obtain or store information. Clients can use queries in a formal query language, inter-process communication architecture, natural language or semantic queries to obtain data from the DBMS. In some implementations, one or more clients obtain data from the DBMS using queries in a custom query language such as a Visualization API Query Language. In some implementations, the content management circuit 135 can be configured to provide one or more customized dashboards (e.g., stored in database 140) to one or more computing devices (e.g., client devices 110, third party devices 150) for presentation. That is, the provided customized dashboards (also referred to herein as “customized interface”) can execute and/or be displayed at the computing devices described herein. In some implementations, the customized dashboards can be provided within a web browser or installed application. In some implementations, the customized dashboards can include PDF files. In some implementations, the customized dashboards can be provided via email. According to various implementations, the customized dashboards can be provided on-demand or as part of push notifications.

In various implementations, the content management circuit 135 executes operations to provide the customized dashboards to the client devices 110 and third party devices 150, without utilizing the web browser. In various implementations, the customized dashboards can be provided within an application (e.g., mobile application, desktop application). The dashboard from which the content management circuit 135 generates can be provided to one or more users or entities, via the network 120. In some implementations, the content management circuit 135 can select dashboards and/or interfaces associated with the user or entity to be displayed on the client devices 110 or third party devices 150. Additional details regarding the dashboards and the content presented are described in detail.

In an example implementation, an application executed by the client devices 110 and/or third party devices 150 can cause the web browser to display on a monitor or screen of the computing devices. For example, the user can connect (e.g., via the network 120) to a website structured to host the customized dashboards. In various implementations, hosting the customized dashboard can include infrastructure such as host devices (e.g., computing device) and a collection of files defining the customized dashboard and stored on the host devices (e.g., in a database). The web browser operates by receiving input of a uniform resource locator (URL) into a field from an input device (e.g., a pointing device, a keyboard, a touchscreen, mobile phone, or another form of input device). In response, the content management circuit 135 executing the web browser can request data such as from the database 140. The web browser can include other functionalities, such as navigational controls (e.g., backward and forward buttons, home buttons, other navigational buttons or items). The content management circuit 135 can execute operations of the database 140 (or provide data from the database 140 to the client devices 110, and/or third party devices 150 for execution) to provide the customized dashboards at the client devices 110 and/or third party devices 150.

In some implementations, the content management circuit 135 can include both a client-side application and a server-side application. For example, a content management circuit 135 can be written in one or more general purpose programming languages and can be executed by client devices 110 and/or third party devices 150. The server-side content management circuit 135 can be written, for example, in one or more general purpose programming, or a concurrent programming language, and can be executed by the response system 130. The content management circuit 135 can be configured to generate a plurality of customized dashboards and their properties. The content management circuit 135 can generate customized user-interactive dashboards for one or more users and entities, such as the client device 110 and third party devices 150, based on data received, collected, and/or aggregated from the analysis circuit 136, any other computing device described herein, and/or any database described herein (e.g., database 140).

The generated dashboards can include various data (e.g., data stored in database 140 and/or data sources 160) associated with one or more entities including scheduling information, profile information, cybersecurity risk and/or vulnerabilities cybersecurity vulnerabilities (e.g., malware, unpatched security vulnerabilities, expired certificates, hidden backdoor programs, super-user and/or admin account privileges, remote access policies, other policies and procedures, type and/or lack of encryption, type and/or lack of network segmentation, common injection and parameter manipulation, automated running of scripts, unknown security bugs in software or programming interfaces, social engineering, and IoT devices), insurer and vendor information (e.g., policies, contracts, products, services, underwriting, limitations), incident information, cyberattack information (e.g., phishing attacks, malware attacks, web attacks, and artificial intelligence (AI)-powered attacks), remediation items, remediation actions/executables, security reports, data analytics, graphs, charts, historical data, historical trends, vulnerabilities, summaries, help information, domain information, and/or subdomain information. As used herein, a “cyber-incident” can be any incident where a party (e.g., user, individual, institution, company) gains unauthorized access to perform unauthorized actions in a computer network environment. The database 140 can also include data structures for storing information such as system definitions for customized dashboards generated by content management circuit 135, animated or other content items, actionable objects, graphical user interface data, and/or additional information.

The analysis circuit 136 can be configured to determine organization incident readiness. Readiness is the process an organization follows to prepare for a cyber incident before it happens. This includes entering information that can be used at the initiation of an incident by incident response teams and breach counsel. Readiness levels are calculated by binary completion of the n tasks that are included in the readiness activities of the organization. An organization with 10 readiness steps and 5 completed shows as 50%. In some implementations, determining organization incident readiness can include integrating readiness (e.g., insurer data and other vendor data) into third party devices 150. For example, the insurer data of an insurer of the company can be recorded and stored at a third party device 150. In various implementations, determining organization incident readiness can include the analysis circuit determining organization capabilities, limitations, cyber threats, and focus associated with cyber threats. Additionally, organization incident readiness can be provided to incident response providers (e.g., security providers, firmware providers, software providers, infostructure providers). The analysis circuit 136 can also be configured to automatically route incidents and claims to vendors associated with a company or user (e.g., client device 110) and in turn contracting and activating an incident response. In some implementations, a response plan can be submitted by a company and the analysis circuit 136 can decompose and analyze the response plan to determine actionable tasks and activities to complete (e.g., by the company or after contracting with a vendor).

In various implementations, the determined organization incident readiness can be stored (e.g., by the analysis circuit 136) as a block in a blockchain (or on a ledger) that can metadata identifying the readiness including, but not limited to, a time stamp, proof of date, and artifacts. In various implementations, the data regarding key milestones (e.g., capabilities pre-incident, what happened after the incident occurred, root cause, recoding) can be stored on a blockchain (e.g., such that it is immutable). In particular, key milestones can be traceable and linkable within a blockchain (or ledger) such that issues can be identified, actionable tasks can be tracked, work is routed to vendors (e.g., third party device 150), and proof of resolution is recorded. In some implementations, database 140 can include a plurality of ledgers or blockchains and the database 140 can be a node of a plurality of nodes on a ledger or blockchain. It should be understood that the various data and information described herein can be implemented on a blockchain. For example, the blockchain can be used to provide for irrefutable proof in a data set of the data, locations, capabilities, configurations, that were in place prior to an incident. In another example, the block can be used to link the incident occurrence with what worked (e.g., effective in preventing an incident) and what did not work (e.g., vulnerability that led to the incident). For example, the irrefutable permanent ledgers (or blockchain) can be used by users at points in the process where they wish to record proofs on chain. This can include configurations, capabilities, assets, policies, threats, actors, claims, incident reports, cyber threat intelligence artifacts, and any other state-based attribute that needs to be recorded and can be shared with others to irrefutably prove that the state of that attribute was “x” at time “t”. Combinations of attributes for different data, assets, configurations, capabilities, are collected and rolled up to show if any elements have changed through the use of Merkel Trees, allowing a check of the top-most hash of the combination of downstream values facilitating a single checkpoint to determine if any other elements and configurations, combinations of parameters is the same or if they have changed.

In various implementations, the analysis circuit 136 can intake potential or current incidents based on an embedded widget on remote web sites or within remote web applications. This allows an incident response provider or vendor (sometimes referred to herein as “IR providers” or IR vendors”) the ability to seamlessly intake incident response requests for assistance from their web site or one of their sales channel partner sites and have it load into the incident intake process within responder. In turn, an embedded widget could be communicably coupled to the analysis circuit 136 (e.g., via network 120) to allow the analysis circuit to start an incident response process (e.g., at proposal stage) and continue through a workflow to achieve response readiness based on pre-defined logic or rules. This rule mechanism can allow for the user to specify attributes, collection of attributes, order, and routing method for connecting inbound requests to those who are best-fit to execute on the requests. For example, when an inbound instance of an incident response can be routed to a claim manager based on pre-defined logic or rules, such as to route inbound cases to the IR provider that is active currently, or to the provider who specializes in ransomware extortion cases where the ransom exceeds 10 million, or to round-robin inbound cases among a set of panel IR providers, etc.

In some implementations, the analysis circuit 136 can facilities invoice processing within an incident response process across different insurers. Furthermore, throughout an incident response conditions can be modified, added, or removed to route tasks (or work) to different vendors or partners (e.g., third party device 150). In some implementations, the analysis circuit 136 can also be configured to collect incident submission data, normalize the data (e.g., based on historical data or trends), and automatically submit insurance claims based on the normalized data. Moreover, the analysis circuit 136 can connect the underlying root cause to the capability failure or procedural issue and have that data submitted with the insurance claim. For example, the analysis circuit 136 can connect underlying root cause back to the insurers underwriting questions. In various implementations, the analysis circuit 136 can integrate organization incident readiness into all related parties to a company. As such, the analysis circuit 136 can integrate incident response activation and collaborative across business, teams, insurers, etc. Further, the analysis circuit 136 can be configured to link the root cause of an incident to the capability failure or procedural issue and then link back the insurers underwriting questions.

The content management circuit 135 can also be configured to allow a user (e.g., of a company) to purchase and extended services via the generated dashboards. In some implementations, the content management circuit 135 allows the user (e.g., via a step through process) to integrate into technology and vendors to resolve issues (e.g., incidents) and/or prevent incidents in the future. For example, the dashboards can provide users integration points for incident response workflow management. As such, the content management circuit 135 can generate dashboards (and/or interfaces) on an application (e.g., application 112 or application 152) for purchasing products, insurances, and services. In particular, the generated dashboards can provide users of the application with a unified (or universal) view of tasks, activities, and progress/status tracking of incidents, claims, etc. The dashboards can also tie back to incident readiness and managing the incidents through resolution. The content management circuit 135 can also generate the dashboards to include collaboration tools (e.g., video calls, calendar, chats), and the dashboards can include real-time status tracking of policies, incidents, claims, insurers such that policy aligned tasks and status updated can be provide for incident responses and claims.

Referring now to FIG. 1B, a block diagram depicting a more detailed architecture of certain systems or devices of system 100. System 100 includes the data acquisition engine 180 and response system 130 described in detail with reference to FIG. 1A. However, it should be understood that the response system 130 also encompasses the capability to generate content and dashboards tailored for at least one (e.g., each) aspect of the response process, including the response, adapter, and designer components. These content and dashboards are generated by the content management circuit 135.

To illustrate further, the response system 130 facilitates the presentation of diverse information related to security and threats of an organization through the adapter dashboard and architecture. This facilitates an understanding of the security landscape and helps inform decision-making processes. Additionally, the dashboard functionality can be customized by the vendor and/or organization using the designer dashboard and architecture. This empowers them to tailor the visual representation of data, making it more intuitive and aligned with their requirements. Furthermore, the responder dashboard and architecture provided by the response system 130 allows the vendor and/or organization to effectively prepare for, track, and update incidents and readiness. This dashboard encompasses the entire incident response lifecycle, from the initial incident detection and response through to the final incident closure and claim submission. By leveraging the responder dashboard and architecture, the vendor and/or organization can facilitate smooth incident management, streamline processes, and facilitate efficient collaboration among stakeholders.

In the depicted architecture, both organizations and vendors operating the third party devices 150 or client devices 110 have the ability to store states 162 and indexes 163 within the library 154 (or library 114). In some implementations, these states 162 and indexes 163 can be determined based on data derived from various datasets, including the organization dataset 164, performance dataset 165, and vendor dataset 166.

In some implementations, the organization dataset 164 encompasses a wide range of information such as firmographics, data related to locations, assets, and capabilities of the third party or client organization. This dataset provides an understanding of the profile and resources of the organization. In some implementations, the performance dataset 165 includes diverse sets of data, including threat data, actor data, vector data, incident data, claim data, capability data, vendor data, organization data, and team member data. These performance-related datasets capture information for assessing the security posture, incident history, and overall operational performance of the organization. They facilitate effective monitoring, analysis, and decision-making in incident response activities. In some implementations, the vendor dataset 166 contains information related to offerings (cybersecurity protection plans), terms, team member data, configuration data, configuration state data, pricing data, detection data, alert data, incident data, and intelligence data. This dataset allows organizations to gain insights into the capabilities and services provided by vendors, facilitating informed decision-making when selecting and collaborating with vendors.

In general, the states 162 and indexes 163, derived from the datasets, are utilized as input by the data acquisition engine 180 (or analysis circuit 136) to output a security posture. In some implementations, the data acquisition engine 180 is configured to scan and perform data collection based on accessing vendor embedded applications 175, via ecosystem partner APIs 174. This facilitates integration with vendor systems, allowing for efficient retrieval and synchronization of relevant data. In the depicted architecture, the states 162 and indexes 163 improve the efficient operations of the response system 130. These states 162 and indexes 163 can stored within the library 154 (or library 114) and are determined based on data from various datasets, including the organization dataset 164, performance dataset 165, and vendor dataset 166.

In some implementations, the states 162 represent the current condition or status of the organization or vendor operating the third party 150 or client devices 110. They encapsulate information such as system configurations, security policies, incident response readiness, and other relevant parameters. By maintaining these states, the response system 130 can quickly access and reference the most up-to-date information about the environment of the organization or vendor. Additionally, in some implementations, the indexes 163 serve as pointers or references to data or resources within the library 154 (or library 114). They streamline the retrieval and access of information, ensuring efficient data processing and analysis. These indexes are designed to optimize search operations and allow access to relevant datasets, contributing to the overall responsiveness and effectiveness of the response system 130.

Accordingly, to verify the accuracy and currency of the states 162 and indexes 163, the data acquisition engine 180 can be configured to scan and collect data by interacting with the vendor embedded applications 175. The communication can occur through ecosystem partner APIs 174, establishing a connection between the response system 130 and the embedded applications 175 used by vendors. Through this communication, the data acquisition engine 180 can retrieve real-time (or near real-time) information from the systems of the vendor, including offerings, configurations, alerts, incidents, and other relevant data. In some implementations, the data acquisition engine 180 can utilize the retrieved data to update and synchronize the states 162 and indexes 163, providing that the response system 130 has the latest and accurate information to support incident response activities.

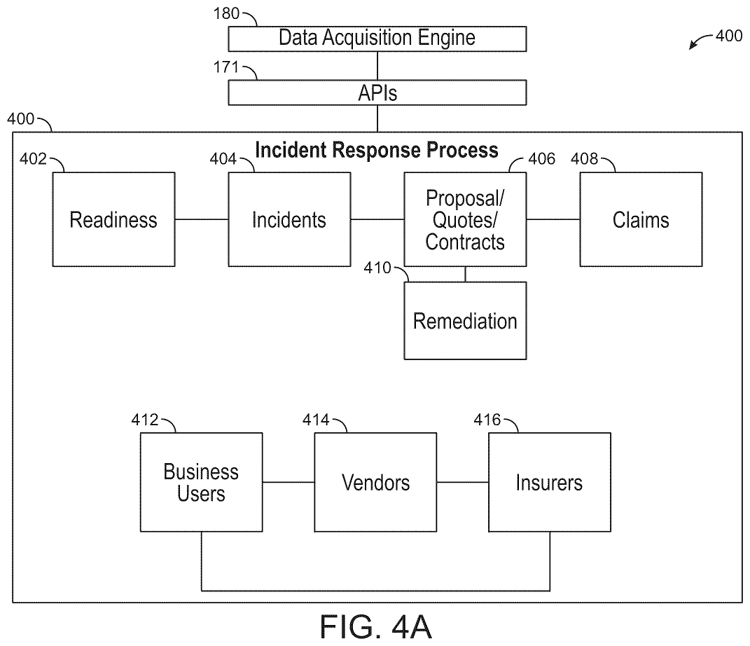

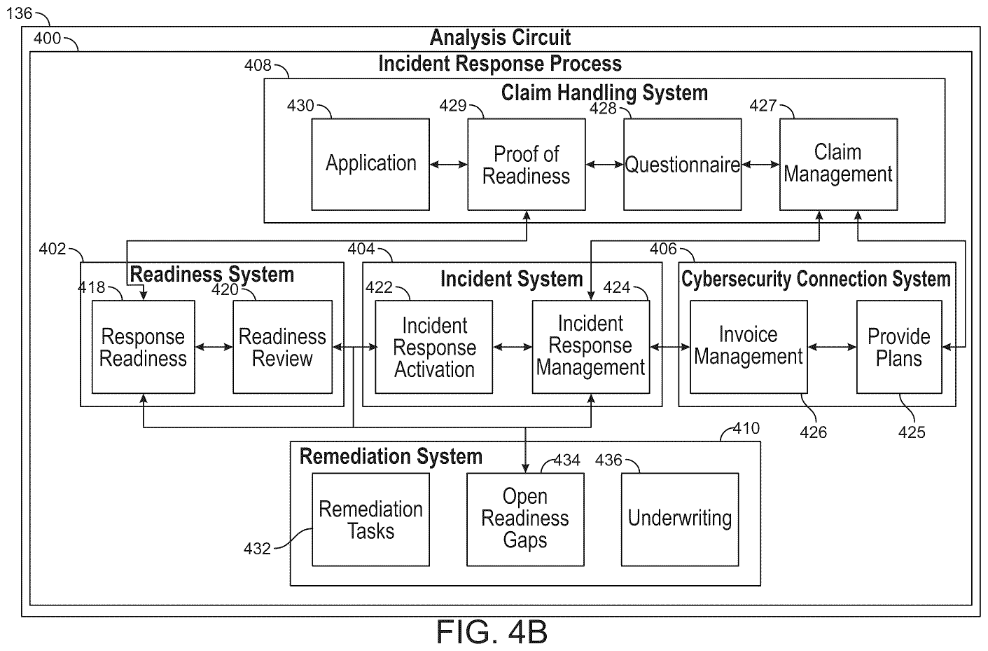

Expand further on states 162 and indexes 163, the data acquisition engine 180 can maintain the security posture of the organization. That is, the data acquisition engine 180 can actively check an API of the vendor for any changes in the configuration “State,” the data acquisition engine 180 that the security posture remains up to date and aligned with the evolving environment. By recording these configuration updates to the corresponding index, the data acquisition engine 180 and response system 130 establishes a view of the security landscape of the organization. This approach goes beyond static assessments and provides a dynamic and real-time perspective on the security posture of the organization. By linking the configuration data with real incident data and other relevant metadata, the response system 130 enhances the accuracy and actionability of the match, facilitating quick and effective response to potential threats. In various implementations, this continuous monitoring and adaptation of the security posture over time is provided and/or presented in a posture stream (as shown with reference to FIG. 4A), which captures and analyzes the evolving information. As new data points are gathered and recorded in the posture stream, the response system 130 can execute proactive incident response activities.

As used herein, a “security posture” refers to the current state and overall cybersecurity profile of an organization or vendor. It is determined based on various factors and information collected from entity data, including system configurations, security policies, incident response readiness, and/or other relevant parameters. In some implementations, the data acquisition engine 180 (or analysis circuit 136) scans and collects data from vendor embedded applications through ecosystem partner APIs, ensuring the accuracy and currency of the states and indexes used to represent the security posture. In various implementations, the analysis circuit 136 utilizes a distributed ledger to tokenize and broadcast the security posture, ensuring transparency and immutability. The analysis circuit 136 can also be configured to model the security posture and multiple security objectives to generate a set of cybersecurity attributes specific to the entity.

Furthermore, the data acquisition engine 180 is shown to gather data from blockchain 170 (e.g., ledgers storing various immutable information about entities, vendors, and/or corporations) via code 168 and smart contracts 169 that are executed by logic handling 167 (e.g., of the data acquisition engine 180). In some implementations, data acquisition engine 180 can communicate with response system 130 directly (e.g., via a wired or hard-wired connection) or via APIs 171. To allow user access and interaction with the dashboards and content generated by the response system 130, user access 172 is provided. Users, including organizations, vendors and/or entities, can access the dashboards and content through dedicated applications such as application 112 or application 152. These applications can be accessed through user devices, such as client device 110, or through third party devices 150.

Additionally, user access 172 to the dashboards and content can be provided to users (e.g., organizations, vendors, entities) via an application (e.g., application 112 or application 152) a user device (e.g., 110) and/or third party device 150. Additional, fewer, or different systems and devices can be used. It is important to note that the depicted system and devices are not exhaustive and/or additional, fewer, or different systems and devices can be employed depending on implementation requirements. The architecture can be tailored to suit the unique needs of organizations, vendors and/or entities, allowing for flexibility and customization in the deployment of the response system 130.

In addition to gathering data from the blockchain 170, the response system 130 can establish a communication channel with the blockchain 170. This communication allows the response system 130 to interact with the blockchain 170 in a secure and decentralized manner. By accessing the blockchain 170, the response system 130 can leverage its inherent properties of immutability, transparency and/or distributed consensus to enhance the integrity and reliability of incident-related data and information. Accordingly, the response system 130 can use blockchain 170 to record and verify incident data, maintain an auditable trail of actions and transactions and/or ensure the integrity of information throughout the incident response process.

It will be recognized that some or all of the figures are schematic representations for purposes of illustration. The figures are provided for the purpose of illustrating one or more implementations with the explicit understanding that they will not be used to limit the scope or the meaning of the claims.

Referring now to FIG. 2, a depiction of a computing system 200 is shown. The computing system 200 that can be used, for example, to implement a system 100, response system 130, client devices 110, third party devices 150, data sources 160, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information and/or instructions to be executed by the processor 210. Main memory 215 can also be used for storing position information, temporary variables, or other intermediate information during execution of instructions by the processor 210. The computing system 200 can further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 can be coupled via the bus 205 to a display 235, such as a liquid crystal display, or active matrix display, for displaying information to a user. An input device 230, such as a keyboard including alphanumeric and other keys, can be coupled to the bus 205 for communicating information and/or command selections to the processor 210. In another implementation, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some implementations, the computing system 200 can include a communications adapter 240, such as a networking adapter. Communications adapter 240 can be coupled to bus 205 and can be configured to facilitate communications with a computing or communications network 120 and/or other computing systems. In various illustrative implementations, any type of networking configuration can be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein can be achieved by the computing system 200 in response to the processor 210 executing an implementation of instructions contained in main memory 215. Such instructions can be read into main memory 215 from another computer-readable medium (e.g., CRM, non-transitory memory, etc.), such as the storage device 225. Execution of the implementation of instructions contained in main memory 215 causes the computing system 200 to perform the illustrative processes described herein. One or more processors in a multi-processing implementation can also be employed to execute the instructions contained in main memory 215. In alternative implementations, hard-wired circuitry can be used in place of or in combination with software instructions to implement illustrative implementations. Thus, implementations are not limited to any specific combination of hardware circuitry and software.

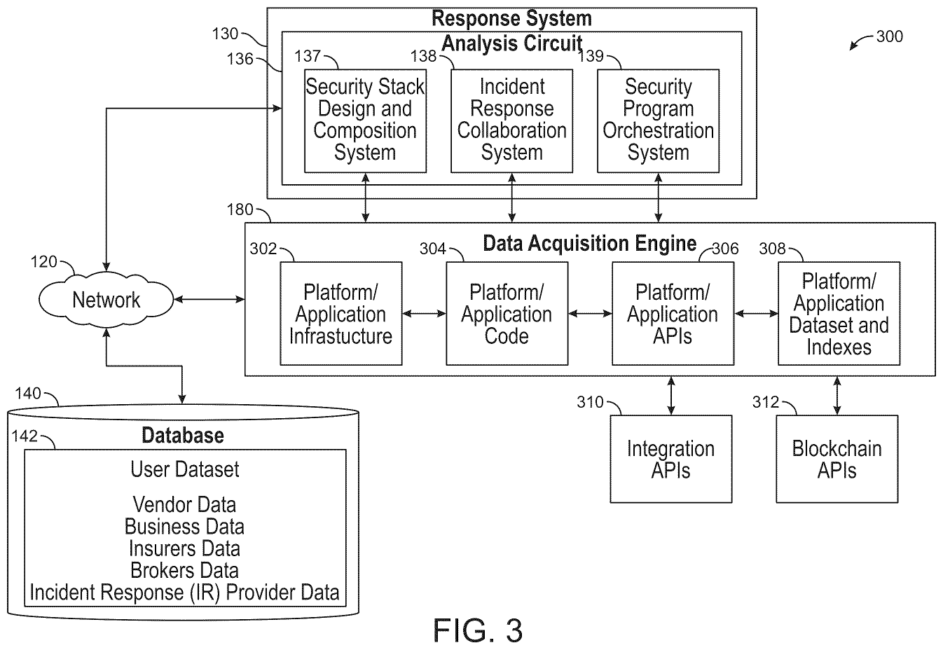

Referring now to FIG. 3, the data acquisition engine 180 and analysis circuit 136 of the response system 130, as depicted in FIG. 1A, depict an architecture 300 that facilitates efficient data acquisition and analysis. In some implementations, a user dataset 142, containing diverse data associated with different entities and users, can be securely stored in the database 140. The systems and devices illustrated in FIG. 3 communicate and exchange information over the network 120, which facilitates integration and collaboration among the components.

The data acquisition engine 180 encompasses various components designed to support the execution of application 112 and application 152. These components include, but are not limited to, the platform application infrastructure 302, platform application code 304, platform application APIs 306, and/or platform application datasets and indexes 308. Together, these elements form the support of the data acquisition engine 180, providing the structures and resources to ensure the efficient functioning of the applications. Additionally, integration APIs 310 and blockchain APIs 312 are integrated into the data acquisition engine 180, facilitating execution of API requests, data retrieval from blockchains, access to data sources 160, and/or integration with various vendors and third parties for streamlined data exchange. These integration APIs 310 facilitate the secure and reliable flow of information, ensuring the responsiveness and effectiveness of the data acquisition process.

The analysis circuit 136 is shown to include, but is not limited to, a security stack designer and composition (SSDC) system 137, an incident response collaboration (IRC) system 138, and/or a security program orchestration (SPO) system 139. For example, the SSDC system 137 walk users through identifying what data and computations are most important, where the data resides, what vendor product, service, and/or procedural capabilities are in place to prevent/detect/respond to cyber-attacks, and/or based on these visualized gaps, determine what to prioritize.

The analysis circuit 136 includes several components that improve the capabilities of the response system 130. One of these components is the security stack designer and composition (SSDC) system 137, which is configured to guide users through the process of identifying and addressing potential vulnerabilities and gaps in their security infrastructure. In some implementations, the SSDC system 137 provides users with a systematic approach to evaluate the significance of their data and computational processes, determining their criticality in the context of cybersecurity. By utilizing the SSDC system 137, users can gain insights into the locations where their data is stored and processed, allowing for understanding of potential security risks. In general, the SSDC system 137 employs various techniques to identify locations where data is stored and processed within infrastructure of the organization. In particular, by leveraging data mapping and inventory techniques that allows the SSDC system 137 to identify data repositories, databases, file systems, and/or other storage systems where data is stored. For example, the SSDC system 137 can analyze network traffic and data flows within a network of an organization to identify sources and destinations of data. By monitoring network communication and analyzing data packets, the SSDC system 137 can trace the path of data transmission and determine the endpoints where data is stored or processed.

Additionally, the SSDC system 137 can utilize data discovery and scanning mechanisms (e.g., using data acquisition engine 180) to identify data repositories within infrastructure of an organization. This can involve scanning file systems, databases, data storage 176, cloud storage 173, and/or other data repositories to identify the locations where sensitive or critical data resides. In some implementations, the SSDC system 137 can integrate with data classification tools or metadata repositories (e.g., data sources 160) to gather information about the nature and sensitivity of the data. By understanding the characteristics and classification of data, the SSDC system 137 can identify the specific locations where sensitive data is stored or processed. By combining these techniques, the SSDC system 137 can provide organizations with a view of the locations where data is stored and processed. It allows organizations to understand the data flow across their infrastructure and gain insights into the potential security risks associated with data storage and processing environments.

For example, an organization that utilizes both on-premises servers and cloud storage 173 for data storage. The SSDC system 137 can perform an analysis of the network of the organization and infrastructure, monitoring data flows between different systems. It would identify the on-premises servers, databases, and/or file systems where certain data is stored. Additionally, it would detect the cloud storage providers and cloud repositories where data is stored. By mapping out these locations, the SSDC system 137 provides the organization with a clear understanding of the data storage landscape and allows them to apply appropriate security measures to protect the data in at least one (e.g., each) location.

In some implementations, the SSDC system 137 facilitates an assessment of the existing vendor products, services, and/or procedural capabilities that are currently in place to prevent, detect, and/or respond to cyber-attacks. This evaluation allows users to identify any gaps or areas of improvement in their security stack. Through visualizations and analysis, the SSDC system 137 helps users prioritize their security measures based on identified gaps and vulnerabilities. By highlighting areas that require attention, the SSDC system 137 empowers organizations to allocate their resources effectively and take proactive steps to enhance their overall security posture. Moreover, the SSDC system 137 is designed to be dynamic and adaptable, accommodating the ever-evolving threat landscape and the changing needs of organizations. It provides a user-friendly interface that simplifies the complex task of security stack design and composition, making it accessible to users with varying levels of technical expertise.

In some implementations, the IRC system 138 can be configured to collect, aggregate, and/or generate data and data structure that can be presented via application 112 and application 152 and can be configured to determine level of importance related to matter pre-incidents, pre-associate to internal incident team members, cyber insurers, breach counsel, incident response firms, and/or security vendors to reduce the time it takes to activate and triage live incidents in the future. By leveraging the capabilities of the IRC system 138, organizations can efficiently manage incidents, reduce response times, and/or ensure collaboration among various stakeholders.

In some implementations, the IRC system 138 can collect and aggregate relevant data. This can include gathering information from various sources such as incident reports, security logs, system alerts, and/or user-generated data. The IRC system 138 employs data collection mechanisms to capture and centralize this information, ensuring that incident responders have a consolidated view of the incident landscape. The term “incident landscape” refers to the overall environment and context in which incidents occur within systems and networks of the organization. It encompasses the various factors, elements, and/or conditions that shape the occurrence and impact of security incidents. The incident landscape includes aspects such as the infrastructure of the organization, network architecture, data assets, applications, user activities, potential vulnerabilities, and/or threat landscape. Understanding the incident landscape is important for incident responders as it allows them to gain insights into the unique security challenges of the organization, identify potential attack vectors, assess risks, and/or develop effective incident response strategies. By mapping and analyzing the incident landscape using the IRC system 138, organizations can proactively strengthen their defenses, detect and respond to incidents promptly, and/or minimize the impact of security breaches.

In some implementations, the IRC system 138 can generate data structures that facilitate the organization and presentation of incident-related information. These data structures facilitate the categorization, classification, and/or correlation of incident data, making it easier for incident responders to analyze and make informed decisions. The IRC system 138 can employ various techniques such as data modeling, schema design, and/or indexing to create efficient and structured data representations. By leveraging the data and data structures generated by the IRC system 138, organizations can determine the level of importance related to pre-incident matters. This involves assessing the potential impact and severity of different incident scenarios, identifying assets and systems, and/or evaluating the potential risks and vulnerabilities. This information helps organizations prioritize their incident response efforts, allocating appropriate resources and attention to high-priority incidents.

In some implementations, the IRC system 138 also facilitates pre-association of internal incident team members, cyber insurers, breach counsel, incident response firms, and/or security vendors. By establishing these pre-associations, organizations can expedite the activation and triaging of live incidents in the future. The IRC system 138 can maintain a database of trusted contacts and partners, allowing incident responders to quickly engage the expertise and support when responding to incidents. This reduces response times and enhances the overall efficiency of technology and incident handling. Moreover, the IRC system 138 facilitates seamless collaboration among various stakeholders involved in incident response. It provides a unified platform where team members can share information, communicate, and/or coordinate their efforts. The IRC system 138 can include features such as real-time messaging, task assignment, document sharing, and/or incident status tracking, facilitating collaboration and ensuring that stakeholders are aligned and working towards a common goal.

The security program orchestration (SPO) system 139 can be configured to manage and adapt a security program of an organization to address changes in the security posture and cyber threats. In some implementations, it operates by receiving inputs that indicate the changing state of the security posture, which can come from various sources such as technical indicators or human-assisted inputs through APIs or social media sharing. These inputs provide valuable information about emerging threats, vulnerabilities, or changes in the security landscape of the organization. Once the SPO system 139 receives these inputs, it analyzes and evaluates the information to determine the adjustments and changes to be implemented in the security program. This involves identifying areas or aspects of the security program that can be modified, such as updating security policies, configurations, access controls, or implementing additional security measures.

The orchestration aspect of the SPO system 139 coordinates and manages the implementation of these changes across the various vendor tools and configurations of the organization. It ensures that the modifications are applied consistently and effectively across different security systems and technologies, minimizing any potential gaps or inconsistencies that could compromise the overall security posture of the organization. Furthermore, the SPO system 139 can be configured to automate and streamline the process of implementing security program changes, reducing the manual effort and potential errors associated with manual intervention. It can leverage automation capabilities to efficiently propagate changes to the appropriate security tools, configurations, and/or policies, ensuring that the security program of the organization remains up-to-date and aligned with the evolving threat landscape.

Referring to the interplay of the analysis circuit 136 generally, the SSDC system 137 designs and composes the security stack. It guides users through the process of identifying data, determining its storage locations, and/or understanding the vendor products, services, and/or procedural capabilities to protect against, detect, and/or respond to cyber-attacks. By visualizing the existing gaps and vulnerabilities, the SSDC system 137 helps organizations prioritize their security efforts and make informed decisions to strengthen their security posture. The IRC system 138 focuses on collaboration and information sharing during incident response. It collects, aggregates, and/or generates data to be presented via applications 112 and application 152. This system facilitates the efficient and effective communication among internal incident team members, cyber insurers, breach counsel, incident response firms, and/or security vendors. By pre-associating relevant parties and establishing clear lines of communication, the IRC system 138 reduces the time it takes to activate and triage live incidents in the future, leading to improved incident response capabilities. The SPO system 139, on the other hand, plays a crucial role in managing the security program of the organization. It receives inputs indicating changes in the security posture or emerging cyber threats, whether through technical indicators or human-assisted inputs. Leveraging these inputs, the SPO system 139 determines adjustments in the security program and orchestrates the implementation of those changes across the various vendor tools and configurations of the organization. This ensures that the security program remains up-to-date and aligned with the evolving threat landscape, enhancing the overall security resilience of the organization.

Accordingly, together, these three systems create a powerful synergy within the security ecosystem of the organization. The SSDC system 137 helps design a robust security infrastructure, the IRC system 138 facilitates collaboration and information sharing during incident response, and/or the SPO system 139 ensures the agility and adaptability of the security program of the organization. By working in tandem, these systems contribute to a proactive approach to improve security, empowering organizations to mitigate risks, respond effectively to incidents, and/or continuously improve their security posture in a rapidly evolving threat landscape.

Referring now to FIGS. 4A-4B, a method 400 for incident response preparedness and readiness through the final incident closure and claim submission. Response system 130 (e.g., in particular analysis circuit 136) or third party device 150 can be configured to perform method 400. Further, any computing device or system described herein can be configured to perform method 400. Additionally, the functions and features described in method 400 can be performed on an application. The data acquisition engine 180 can communicate using APIs with the response system 130.

In broad overview of the incident response process (e.g., method 400), the analysis circuit 136 can implement method 400. The analysis circuit can include various computing systems such as readiness system 402, incident system 404, cybersecurity connection system 406, claim handling system 408, and/or remediation system 410 can at least one (e.g., each) be systems configured to implement steps within an incident response process. In particular, FIG. 4B shows exemplary activities or tasks performed in at least one (e.g., each) of the steps shown in FIG. 4A. Throughout the steps and activities data and data structures can be utilized (e.g., aggregate, collected, or generated) including data of business users 412, vendors 414, and/or insurers 416. APIs 171 and API request and returns can be sent and received by the one or more processing circuits to perform method 400. Additionally, fewer, or different operations can be performed depending on the particular implementation. In some implementations, some or all operations of method 400 can be performed by one or more processors executing on one or more computing devices, systems, or servers. In various implementations, at least one (e.g., each) operation can be re-ordered, added, removed, or repeated.

Referring to method 400 in more detail, the analysis circuit 136 can execute a readiness step by readiness system 402, where a readiness analysis is executed. In some implementations, during the readiness step by readiness system 402, the analysis circuit 136 can perform response readiness 418 and readiness review 420. During the response readiness 418, the analysis circuit 136 evaluates the level of preparedness of the organization to effectively respond to incidents. It assesses various factors such as the availability of incident response teams, the adequacy of incident response plans and procedures, the integration of incident response tools and technologies, and/or the establishment of communication channels and protocols. This evaluation helps identify any gaps or deficiencies in the response capabilities of the organization, ensuring measures are taken to address them.

Simultaneously (or in a logical order), the readiness review 420 conducted by the analysis circuit 136 involves a thorough examination of the overall readiness of the organization for incident response. It encompasses a review of the incident response framework of the organization, including its policies, procedures, documentation, and/or training programs. The analysis circuit 136 examines whether the incident response framework of the organization aligns with industry best practices, regulatory requirements, and/or internal objectives. It also assesses the ability of the organization to effectively coordinate and collaborate with external stakeholders, such as incident response providers, cyber insurers, breach counsel, and/or other relevant parties.

In some implementations, the readiness system 402 is configured to access the entity data of an organization and utilize this information to determine the security posture of the organization. The readiness system 402 can take into account various parameters such as the cybersecurity policies of the entity, system configurations, incident response readiness, and/or others. It can then model the security posture along with a plurality of security objectives of the organization to generate a set of cybersecurity attributes.

The analysis circuit 136 can also execute an incident step by incident system 404, where an incident analysis is executed. In some implementations, during the incident step by incident system 404, the analysis circuit 136 can perform incident response activation 422 and incident response management 424. During the incident response activation 422, the analysis circuit 136 triggers the actions to initiate the incident response process. It activates the predefined incident response plans, procedures, and/or resources to ensure a swift and coordinated response. This includes notifying the incident response team, engaging relevant stakeholders and vendors, and/or initiating communication channels to exchange information.

In some implementations, the incident system is configured to maintain the relationship between the entity and third party cybersecurity providers. That is, it is configured to model a plurality of cybersecurity protection plans between the entity and a third party. In particular, it provides a framework for integrating third party cybersecurity solutions into the systems of the entity, ensuring that these solutions align with the security objectives of the entity and can effectively address its cybersecurity needs.

Simultaneously (or in a logical order), the analysis circuit 136 executes incident response management 424, which involves the ongoing coordination, monitoring, and/or control of the incident response activities. For example, it ensures that the incident response team follows the established procedures, communicates effectively, and/or collaborates seamlessly to address the incident. The analysis circuit 136 provides real-time insights and updates on the status of the incident, facilitates information sharing between team members, and/or tracks the progress of incident containment, eradication, and/or recovery efforts. By effectively managing the incident response, the analysis circuit 136 helps minimize the impact of the incident and accelerates the return to normal operations. By performing the incident response activation 422, it initiates a rapid and coordinated response, while the incident response management 424 ensures effective coordination and control throughout the incident response process. This incident analysis and response approach facilitated by the analysis circuit 136 allows organizations to mitigate the impact of incidents, minimize downtime, and/or protect their assets and operations.

The analysis circuit 136 can also execute a proposal/quote/contract step by cybersecurity connection system 406, where a proposal/quote/contract generation is executed. In some implementations, during the proposal/quote/contract step by cybersecurity connection system 406, the analysis circuit 136 can perform invoice management 426. During the proposal/quote/contract step by cybersecurity connection system 406, the analysis circuit 136 leverages its capabilities to generate proposals, quotes, and/or contracts. It takes into account the requirements, parameters, and/or preferences of the involved parties, ensuring that the proposed terms align with their respective needs. The analysis circuit 136 utilizes relevant data, such as pricing information, service level agreements (SLAs), and/or contractual obligations, to generate customized proposals and quotes. In some implementations, within the proposal/quote/contract step by cybersecurity connection system 406, the analysis circuit 136 incorporates invoice management 426 functionality. This feature facilitates the handling and tracking of invoices related to the proposed services or products. The analysis circuit 136 ensures that accurate and timely invoices are generated, shared, and/or managed throughout the invoicing process. It can include features such as invoice creation, validation, tracking, and/or payment processing, streamlining the financial aspect of the proposal/quote/contract lifecycle.

In some implementations, the cybersecurity connection system 406 can be configured to determine and provide (e.g., connect) a cybersecurity protection plan, utilizing one or more protection parameters. The plans can correspond to a new cybersecurity attribute that has been identified as to protect the organization. The cybersecurity connection system 406 makes this protection plan available to the entity, which can then choose to activate it based on its needs and acceptance of the terms of the plan.

The analysis circuit 136 can also execute a claims step by claim handling system 408, where claims are generated and tracked. In some implementations, during the claims step by claim handling system 408, the analysis circuit 136 can perform proof of readiness 429, provide an application 430 (e.g., application 112 and application 152), generate and provide questionnaires 428, and/or perform claim management 427. In some implementations, proof of readiness 429 involves gathering and presenting evidence to substantiate the readiness of the organization in handling incidents and responding effectively. The analysis circuit 136 collects relevant data, such as incident response plans, documentation, training records, and/or compliance certifications, to demonstrate the preparedness of the organization. Additionally, the analysis circuit 136 provides an application 430, such as application 112 and application 152, to facilitate the claims process. This application serves as a centralized platform where users can access and submit their claims. It streamlines the entire claims workflow, facilitating efficient communication, documentation, and/or tracking of the claims from initiation to resolution.

In some implementations, the claim handling system 408 is configured to monitor the environmental data of the entity while modeling at least one of the plurality of cybersecurity protection plans. That is, the claim handling system 408 monitors for any anomalies or signs of potential cybersecurity incidents in the environment of the entity. When it detects a new cybersecurity incident associated with the entity from the environmental data, it generates a report, allowing the entity or vendor to promptly respond to the incident and prevent further damage.

In some implementations, as part of the claims step by claim handling system 408, the analysis circuit 136 also generates and provides questionnaires 428. These questionnaires are designed to gather information related to the incident or the claim being submitted. They serve as a structured means to collect relevant details and documentation that are used for claim evaluation and processing. Moreover, the analysis circuit 136 encompasses claim management 427 functionalities during the claims step by claim handling system 408. This includes activities such as claim validation, documentation management, claim status tracking, and/or communication with involved parties. The analysis circuit 136 ensures that claims are effectively managed, providing transparency and visibility into the progress and status of at least one (e.g., each) claim.

The analysis circuit 136 can also execute a remediation step by remediation system 410, where remediations are executed. In some implementations, during the remediation step by remediation system 410, the analysis circuit 136 can perform remediation tasks 432, open readiness issues and gaps 434, and/or execute underwriting 436 (e.g., of organizations to determine what type of vendor plans, products, or services they can qualify for). The execution of remediation tasks 432 includes implementing actions or measures to mitigate vulnerabilities, resolve security gaps, and/or address any identified weaknesses in the security infrastructure of the organization. The analysis circuit 136 can provide guidance and instructions to stakeholders, outlining the steps to remediate the identified issues effectively.

In some implementations, the remediation system 410 is configured to execute one or more remediation actions to mitigate a vulnerability or security gap. It bases its actions on the security posture of the entity. If a vulnerability is detected or a security gap is identified, the remediation system 410 executes to address the issue, employing a range of remediation actions such as patching software, modifying system configurations, or enhancing security policies.

Additionally, the analysis circuit 136 facilitates the process of opening readiness issues and gaps 434. It identifies areas where the organization can have shortcomings or deficiencies in its preparedness for potential incidents or security threats. By highlighting these gaps, the analysis circuit 136 helps organizations prioritize and allocate resources to address the identified issues and enhance their overall readiness posture. Moreover, the analysis circuit 136 can execute underwriting 436, which involves evaluating organizations to determine the type of vendor plans, products, or services they can qualify for. Through an assessment, the analysis circuit 136 analyzes various factors, such as the security measures of the organization, incident response capabilities, risk management practices, and/or compliance with industry standards. Based on the evaluation, the analysis circuit 136 provides insights and recommendations on suitable vendor offerings that align with the requirements of the organization and level of readiness.

In some implementations, the readiness system 402 is configured to continuously update the security posture of the entity. It does this by monitoring dynamic changes in the entity data, which can involve alterations in system configurations, updates to security policies, new cyber threats, and/or shifts in the cyber risk landscape. This continuous updating of the security posture ensures that the security status of the organization reflects the most current conditions. It allows the analysis circuit 136 to react to emerging threats or vulnerabilities, providing real-time protection for the data and systems of the entity.

In some implementations, the readiness system 402 can also be configured to tokenize and broadcast the security posture to a distributed ledger. This process involves converting the security posture into a format suitable for recording on a blockchain (e.g., a type of distributed ledger). It then broadcasts this tokenized data across the network of computers that maintain the ledger. Additionally, the readiness system 402 provides a public address of the tokenized updated security posture on the distributed ledger. This public address can be accessed by a plurality of third-parties for verification. This transparent and immutable record-keeping enhances trust among stakeholders and provides a verifiable proof of the security posture of the entity.

In some implementations, the readiness system 402 is further configured to generate a security roadmap. This roadmap includes a plurality of phases associated with the modeling of the set of cybersecurity attributes. At least one (e.g., each) cybersecurity attribute of the set is assigned a phase associated with the security roadmap of the entity. For example, the roadmap serves as a strategic plan that outlines the steps the entity can take to enhance its security posture. It provides a clear pathway to achieving the security objectives of the entity, ensuring that efforts are well-coordinated, and resources are optimally utilized. By assigning at least one (e.g., each) cybersecurity attribute to a phase of the roadmap, the readiness system 402 ensures that at least one (e.g., each) aspect of the security of the entity is appropriately addressed.

In some implementations, the cybersecurity connection system 406 can create and set in motion a cybersecurity protection obligation, in provide plans 425, between the entity and the third party upon receiving an activation of the cybersecurity protection plan. The cybersecurity protection obligation can be a binding agreement or contract that outlines the responsibilities and roles of the entity and the third party in securing the systems and data of the entity. This protection obligation is characterized by several protection attributes, which can involve various elements such as the scope of protection, the duration of the contract, the cybersecurity services to be provided, the response time in the event of a security incident, and/or the terms of service termination or renewal. Moreover, the cybersecurity connection system 406 can identify multiple cybersecurity protection plans (e.g., at provide plans 425) associated with various third-parties. These could include a wide array of cybersecurity service providers, at least one (e.g., each) offering distinct protection plans. For instance, a first cybersecurity protection plan could be offered by a first third party, while a second cybersecurity protection plan could be offered by a different third party. At least one (e.g., each) of these protection plans can be associated with the new cybersecurity attribute identified during the modeling process, indicating that they are specifically designed to address this aspect of the cybersecurity needs of the entity.

In some implementations, at least one (e.g., each) cybersecurity protection plan, in turn, is associated with one of several availability states. These states provide an immediate understanding of the status regarding its accessibility for the entity. The “available now” state means that the plan is currently accessible for implementation. The “available pending” state signifies that the plan will become accessible in the future, perhaps subject to certain conditions or the passing of a certain period. Conversely, an “unavailable” state denotes that the plan is not currently accessible, possibly due to it being phased out, fully subscribed, or not being offered in the region of the entity. Additional or fewer states can be added. This system of availability states allows the entity to quickly determine which plans are viable options for enhancing their cybersecurity posture.

In some implementations, the incident system 404 can establish a data (e.g., continuous, in real-time, periodically) monitoring channel between the entity and the third party. This communication stream allows for real-time (or near real-time) detection and response to any potential cybersecurity incidents. To achieve this, a first communication connection is established using a first application programming interface (API) between the computing system of the entity (e.g., client device 110) or one or more entity assets (e.g., client device 110) and the incident system 404. This connection allows the incident system 404 to continuously monitor the systems and data of the entity for any signs of a cybersecurity incident. Simultaneously, a second communication connection is established using a second API between a third party computing system (e.g., third party device 150) and the incident system 404. This connection allows the third party, often a cybersecurity service provider, to also monitor the systems and data of the entity, providing an additional layer of protection and vigilance.

Moreover, the claim handling system 408 can be configured to quickly respond to any detected cybersecurity incidents. Upon detection of a new cybersecurity incident, the claim handling system 408 generates alerts and provides a real-time dashboard for the entity and vendor. This dashboard provides an overview of the cybersecurity posture of the entity, data of the detected incident, recommended response actions, and/or updates on the response process. This real-time information allows the entity to rapidly understand and react to the cybersecurity incident, minimizing potential damage and downtime.

In some implementations, the remediation system 410 can use predictive analytics to identify potential security gaps before they can be exploited. It analyses patterns in the data and behaviors of the entity, as well as trends and threats in the broader cybersecurity landscape, to predict where vulnerabilities might arise. Upon identifying a potential security gap, the remediation system 410 proactively executes one or more remediation actions. These actions could involve updating security policies, patching software vulnerabilities, reconfiguring system settings, providing cybersecurity training to employees, or implementing additional cybersecurity measures.

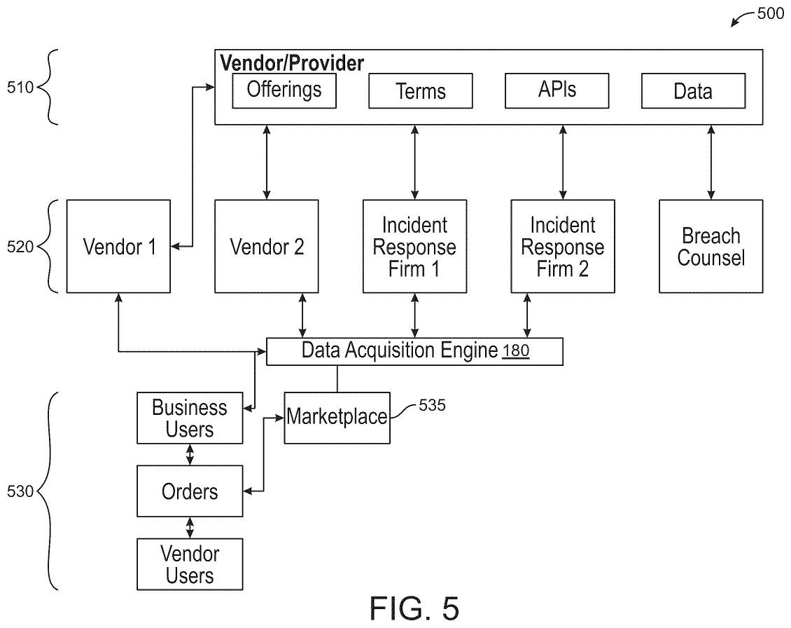

Referring now to FIG. 5, a vendor-provider marketplace 500, according to some implementations. The vendor-provider marketplace 500 depicts generally the interactions between vendors 510 and users 530 (e.g., directly or through partners) as well as vendors 510 to vendors 520. For example, at least one (e.g., each) vendor 520 can include, but is not limited to, offerings, terms, APIs, and/or data that can be provided and/or exchanged with to the response system 130 via the data acquisition engine 180 and other vendors, incident response firms, and/or breach counsel (e.g., law firm) (collectively referred to as “vendors 520”). In some implementations, those vendors 520 can communicate with the data acquisition engine 180 of FIG. 1A to generate dashboards of an application (e.g., application 112, application 152) and store data in database 140 for future use.

Expanding on the vendor-provider marketplace 500 depicted in FIG. 5, this marketplace serves as a central hub for interactions between vendors 510, users 530, and/or vendors 520, facilitating the exchange of offerings, terms, APIs, and/or data. At least one (e.g., each) vendor 510 within the marketplace encompasses a range of products, services, and/or resources that can be made available to users 530 directly or through the engagement of vendors 520. These vendors 520, which include incident response firms, breach counsel (such as law firms), and/or other relevant entities, play a crucial role in providing expertise and additional support to enhance incident response capabilities (e.g., a type of cybersecurity attribute). Through communication with the data acquisition engine 180, the vendors 520 can actively engage in generating dashboards within the application interfaces (e.g., application 112, application 152). These dashboards offer real-time insights and analytics, allowing users 530 to visualize and assess their incident response readiness, track ongoing incidents, and/or access relevant data stored in the database 140 for future reference. The data acquisition engine 180 serves as a communication bridge, allowing vendors 520 to contribute information and leverage the functionalities of the response system 130. It should be understood that the vendors 510, vendors 520, and/or users 530 depicted in the vendor-provider marketplace 500 can be executed by computer systems, exemplified by the computing system 200 shown in FIG. 2. These computer systems facilitate collaboration, data exchange, and/or transactional activities within the marketplace, ensuring a dynamic and efficient ecosystem for incident response management.

In certain implementations, the vendor-user interaction within the marketplace 535 extends beyond mere browsing and exploration. Vendors 510 and users 530 have the capability to place orders directly through the marketplace 535, initiating a streamlined process facilitated by the data acquisition engine. This integration of ordering functionality enhances the efficiency and convenience of the marketplace, facilitating transactions between vendors and users. Notably, the marketplace 535 serves as a platform for programmatic connectivity, allowing new partners to establish collaborative relationships efficiently. The marketplace incorporates contracting workflows and partnering processes, which are seamlessly facilitated through the application interface. Once a partnership is ratified, the partners can immediately engage in business activities within the platform, leveraging the full range of services and offerings available. This includes the ability to submit proposals, engage in reselling, establish technical connectivity for provisioning and licensing, establish API connections for data sharing, utilization, and/or presentation on the platform, and/or leverage pre-defined programmable logic for user, vendor, and/or partner interactions.

In some implementations, the marketplace 535 introduces dynamic and automated workflows that facilitate routing of inbound orders to the appropriate partner based on predefined criteria. This programmable logic ensures that orders are seamlessly directed to the designated partner for processing and fulfillment. Furthermore, programmatic activation of contracts and seamless order fulfillment processes are executed, ensuring a smooth and rapid delivery of the purchased offering, whether it is a product or service. The marketplace ecosystem facilitates the seamless integration of vendors, partners, and/or users, streamlining the entire order management process and facilitating timely and efficient delivery of products and services.

Distinguishing itself from other vendor marketplaces, this embedded marketplace 535 is seamlessly integrated within the applications and APIs 171 spanning the entire system architecture. This integration allows vendor offerings to be presented to users precisely when they need them, seamlessly integrating within the user flow during various stages of cybersecurity incident response planning, testing, and/or execution. Moreover, the marketplace becomes an integral part of the design and composition processes for constructing a robust cybersecurity stack, as well as during security program orchestration and adaptation to ensure the ongoing effectiveness of the cybersecurity program. By embedding the marketplace within the applications and APIs, users 530 have immediate access to an array of vendor offerings precisely at the point of need. Whether users are developing their incident response plans, conducting tests, executing response strategies, or adapting their security programs, the marketplace seamlessly integrates within their workflow, providing timely and relevant vendor options to enhance their cybersecurity capabilities (e.g., cybersecurity attributes). This unique approach eliminates the need for users to navigate separate platforms or search for vendors independently, streamlining the entire process and promoting efficiency in decision-making and procurement.

Additionally, this embedded marketplace fosters a holistic approach to cybersecurity management, facilitating collaboration between users 530 and vendors 510 throughout the entire ecosystem. By offering vendor options during incident response planning, testing, and/or execution, users can make informed decisions and select the most suitable solutions to mitigate risks effectively. Similarly, during the design and composition of their cybersecurity stack, users 530 can access a diverse range of vendor offerings directly within the application interface, allowing them to build a tailored security infrastructure. Additionally, during security program orchestration and adaptation, the marketplace 535 provides users with valuable insights and options to enhance the effectiveness and resilience of their security programs, ensuring continuous protection against evolving threats.

It should be understood that the embedded architecture of the marketplace allows for flexibility and scalability, accommodating additional systems, devices, data structures, and/or data sources as required. The marketplace can adapt to the evolving needs of users and vendors, expanding its offerings and functionalities to meet the dynamic nature of the cybersecurity landscape. This adaptability ensures that the marketplace remains a valuable resource for users, providing access to the latest innovations and vendor solutions while facilitating seamless collaboration and partnership within the cybersecurity ecosystem.

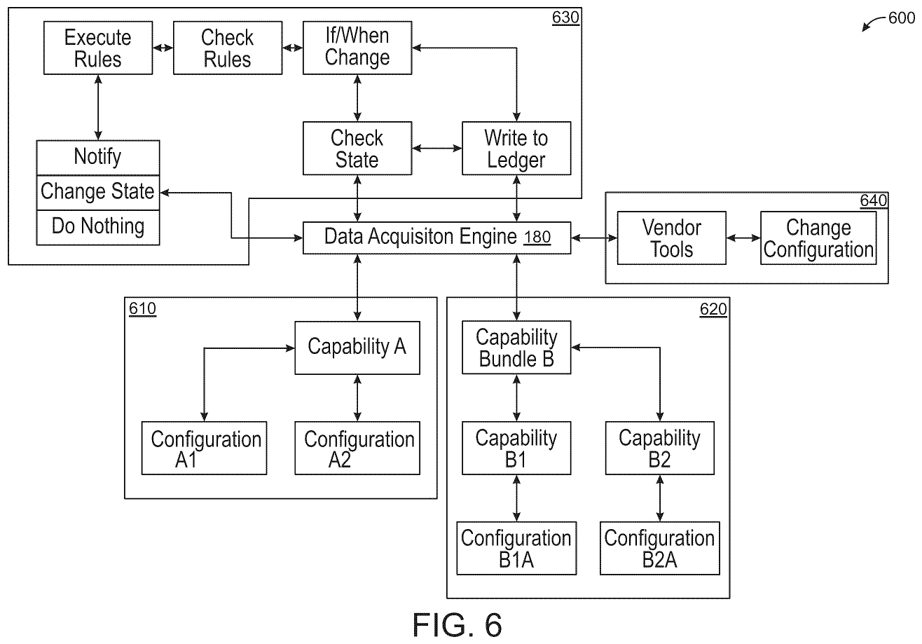

Referring now to FIG. 6, a method 600 for capturing the state of capabilities (sometimes referred to herein as “cybersecurity attributes”) (e.g., vendor technologies or configurations) in place and in use by users, retrieving state, and/or sharing of state at points in time as well as over a time period. Response system 130 (e.g., in particular analysis circuit 136 or data acquisition engine 180) or third party device 150 can be configured to perform method 600. Further, any computing device or system described herein can be configured to perform method 600. Additionally, the functions and features described in method 600 can be performed on an application.

In broad overview of method 600, capabilities 610 and 620 associated with a corporation of business can be received (e.g., capability A with configuration A1 and configuration A2, and/or capability bundle B with capability B1 and B2, where capability B1 has a configuration BIA and capability B2 has a configuration B2A). The capabilities 610 and 620 can be checked (e.g., check state) and the capabilities can be written to a ledger (e.g., database and/or blockchain 170) in steps 630. Once the capabilities 610 and 620 are received, a thorough check is conducted to verify their state and ensure their accuracy and validity. This check entails examining the current status and parameters of at least one (e.g., each) capability, evaluating factors such as readiness, compatibility, and/or compliance with established standards or requirements. By performing this assessment, any discrepancies or issues pertaining to the capabilities can be identified and addressed.

In some implementations, following the verification process, the next step involves recording the capabilities into a ledger. This ledger serves as a secure and reliable storage medium, which can take the form of a database or a blockchain 170. The capabilities, along with their associated configurations, are meticulously documented and stored within the ledger, ensuring the integrity and traceability of the information. This facilitates access to the capabilities data, their respective configurations, and/or any historical changes or updates that can occur over time. By writing the capabilities to the ledger, organizations gain a centralized and auditable repository that securely maintains a record of their capabilities. Additionally, the ledger ensures transparency and accountability by providing an immutable and tamper-proof audit trail of the capabilities and their configurations.

In turn in steps 630, a process can occur if a state has changed including, but not limited to, checking rules, execute rules, and/or notifying, changing state, and/or do nothing. If a change occurred (e.g., trigger condition, e.g., capability A changed, the data acquisition engine 180 can determine to change it back (or role it back), capability B changed and in turn then vendor technology is configured to change Y associated with the business or corporation) then the one more processing circuits can programmatically connect to vendor technology to change a configuration (e.g., utilizing API calls). In some implementations, at steps 640, the data acquisition engine 180 can communicate with vendor tools to change particular configurations.

Upon detecting a change in state, the data acquisition engine 180 evaluates the trigger condition, such as the alteration of capability A or capability B. Based on this evaluation, a decision is made regarding the appropriate course of action. For example, if capability A experiences a change, the data acquisition engine 180 can determine that a rollback is to be performed to revert the capability back to its previous state. Similarly, if capability B undergoes a change, the vendor technology associated with the business or corporation can be configured to adjust Y accordingly, aligning it with the modified capability. To effectuate these changes, the processing circuits within the data acquisition engine 180 (or within response system 130) establish programmatic connections with the vendor technology responsible for managing the configurations (e.g., at step 640). Moving forward to step 640, the data acquisition engine 180 actively engages in communication with the vendor tools to implement the desired changes. Through this interaction, the data acquisition engine 180 can efficiently orchestrate the configuration changes to align the capabilities with the desired state.

With reference to FIG. 6, the one or more processing circuits can utilize the various data structures (e.g., assets, locations, capabilities, threats) to collect, attribute, and/or adapt to determine if a trigger condition occurred (e.g., historical data of the corporation or business can be used to determine if a trigger condition occurred) In turn, the one or more processing circuits can execute one or more functions such as make an API request (e.g., to vendor, insurer, or business), store information in a database, and/or update a blockchain ledger (e.g., at step 630). Additionally, fewer, or different operations can be performed depending on the particular implementation. In some implementations, some or all operations of method 600 can be performed by one or more processors executing on one or more computing devices, systems, or servers.

In some implementations, in order to identify the occurrence of a trigger condition, historical data of the corporation or business is often utilized. This historical data provides valuable insights into the past behavior and patterns of the organization, allowing the processing circuits to make informed decisions regarding trigger condition identification. Upon determining that a trigger condition has indeed occurred, the one or more processing circuits initiate a series of functions and operations to address the situation. These functions can include making API requests to relevant entities such as vendors, insurers, or other businesses. Through these API requests, the processing circuits can retrieve crucial information or initiate actions to respond to the trigger condition effectively. Additionally, in certain implementations, the processing circuits can update a blockchain ledger, providing a secure and immutable record of the trigger condition and any associated changes made as a result.

In various implementations, at least one (e.g., each) operation can be re-ordered, added, removed, or repeated. This system will be used to deliver state of a business security configuration to facilitate insurance underwriting, whereby the facts of the state of the business user computing environment are known, and/or provable. This provides the underwriting insurer the ability to collect irrefutable proof-of-state of the business environment as part of their pre-underwriting and risk selection process and can be then used to facilitate programmatic binding as part of their application process. The system can be further utilized to provide programmatically and dynamically adaptable insurance products that change the coverage level based on the factual changes in state of the computing environment at the insured through the policy period. This allows the insurer to ensure that the insured has followed the underwriting criteria throughout the term of the policy. Cyber insurance renewals can be programmatically generated and automatically bound based on the binary data provided by the system during renewal as the insurer knows what the compliance history has been for the insured as well as the facts of the current state of the vendor capabilities and configurations in the insureds computing environment.

In various implementations, the underwriting process begins by collecting data from the security tools and configurations of the insured. This data can then be analyzed and matched against the underwriting requirements defined by the insurer. The collected data acts as irrefutable proof of the insured security posture, providing the insurer with a holistic understanding of the risk associated with the business environment of the insured. In some implementations, once the data has been collected and matched to underwriting requirements, the processing circuits can wrap this information with the context and metadata through a broker. The broker acts as an intermediary, consolidating and structuring the data in a standardized format that can be seamlessly transmitted to the quoting API of the insurer. This integration improves the underwriting application process, allowing the insurer to access the factual data of the security configuration and computing environment of the insured. With this data in hand, the insurer can programmatically assess the risk and make informed decisions regarding coverage and policy terms. This automated and dynamic approach empowers insurers to offer adaptable insurance products that can be adjusted based on the factual changes in the computing environment throughout the policy period, ensuring ongoing compliance with underwriting criteria and tailored coverage for the insured. Additionally, the system facilitates the automatic generation and binding of cyber insurance renewals based on the binary data provided during the renewal process. By utilizing the compliance history and the up-to-date facts of the computing environment of the insured, the insurer can renew the policy while maintaining an understanding of the risk profile of the insured and providing continuous coverage.

### Cyber Resilience Tokenization

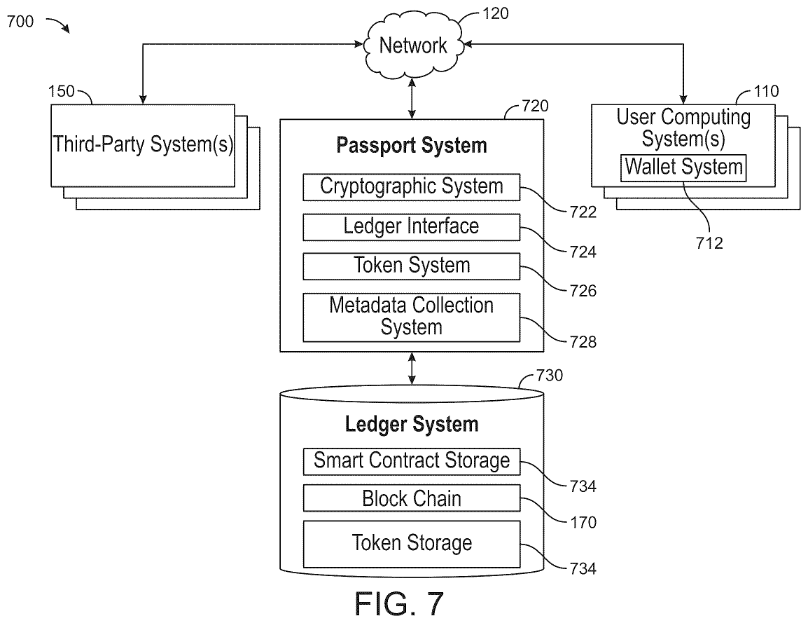

Referring to FIG. 7, a block diagram 700 of an implementation of a system for cyber resilience tokenization is shown, according to some implementations. The implementation shown in FIG. 7 can include client device 110 (also referred to herein as “client devices 110” and/or “user computing system(s) 110”), third party devices 150 (also referred to herein as “third party system(s) 150” and/or “third party device 150”), a passport system 720, and/or a ledger system 730. In some implementations, the client device 110 can include a wallet system 712. In some implementations, the passport system 720 can include a cryptographic system 722, a ledger interface 724, a token system 726, and/or a metadata collection system 728. In some implementations, the ledger system 730 can include smart contract storage 732, blockchain 170, and/or token storage 734. These components can be interconnected through a network 120 that supports secure communications profiles (e.g., TLS, SSL, HTTPS, etc.). In some implementations, the passport system 720 can incorporate the same or similar features and/or functionality as described regarding the response system 130 of FIG. 1A. Although the various computing elements of FIG. 7 can be described in the singular form (e.g., client device 110, third party device 150, etc.), it should be understood that the implementation shown in FIG. 7 can include two or more of any device/system described herein (e.g., two or more client device 110, two or more third party devices 150, etc.).

At least one (e.g., each) system or device of FIG. 7 can include one or more processors, memories, network interfaces (sometimes referred to herein as a “network circuit”) and user interfaces. The memory can store programming logic that, when executed by the processor, controls the operation of the corresponding computing system or device. The memory can also store data in databases. For example, memory can store programming logic that when executed by a processor within a processing circuit, causes a database to update parameters or store a system or event log. The network interfaces can allow the computing systems and devices to communicate wirelessly or otherwise. The various components of devices in system 100 can be implemented via hardware (e.g., circuitry), software (e.g., executable code), or any combination thereof. Devices, systems, and/or components in FIG. 7 can be added, deleted, integrated, separated, and/or rearranged in various implementations of the disclosure.

Generally, the client device 110, third party devices 150, passport system 720, and/or ledger system 730, wallet system 712, cryptographic system 722, ledger interface 724, token system 726, metadata collection system 728, smart contract storage 732, blockchain 170, token storage 734, and/or network 120 can include one or more logic devices, which can be one or more computing devices equipped with one or more processing circuits that run instructions stored in a memory device to perform various operations. The processing circuit can be made up of various components such as a microprocessor, an ASIC, or an FPGA, and/or the memory device can be any type of storage or transmission device capable of providing program instructions. The instructions can include code from various programming languages commonly used in the industry, such as high-level programming languages, web development languages, and/or systems programming languages. The client device 110, third party devices 150, passport system 720, and/or other various components of FIG. 7 can also include one or more databases for storing data that receive and provide data to other systems and devices on the network 120.

Generally, the passport system 720 can execute and/or be utilized to execute various processes and/or tasks corresponding with modeling cyber resilience data. For example, the passport system 720 can provide a single sign-on gateway (e.g., using an identity management system like AuthO) facilitating access to the associated security posture of the user, threat, incident, and/or insurance data sets using data sets encapsulated within various tokens. For example, the passport system 720 can generate a token (e.g., a passport) linked to various additional tokens and further linked to a control structure restricting access to one or more of the additional tokens based on rules (e.g., RBACs). For example, a cyber resilience identifier (e.g., passport) of an entity can include entity data and/or additional cyber resilience data stored in tokens, and the passport system 720 can provide and/or restrict access to one or more portions of the tokenized data based on various conditions, entity types, data types, regulations, and so on. That is, an entity can have a container with access controls and a passport created by the passport system 720 linked to both sensitive (e.g., private) and non-sensitive (e.g., public) data, and the passport system 720 can deny access (e.g., to sensitive data) and provide access (e.g., to non-sensitive data) based the access control (e.g., whether the user to access the data is a customer, insurer, vendor, MDR/XDR provider, etc.).

Generally, the passport system 720 can provide secure access to token-related data and facilitate interactions between different cybersecurity systems and data sources of FIG. 7 (e.g., client device 110, third party devices 150, ledger system 730, etc.) based on various access controls. For example, the passport system 720 can create a cyber resilience identity with tokens and rule-based access controls controlling access to the tokens. For example, the passport system 720 can generate a passport for a third party linked to controls such that the third party can access their own data within the token structure. In some implementations, a third party entity can use the passport system 720 to access performance tokens stored in the token structure, such as in a passport associated with the cybersecurity status of an entity, with RBAC rules restrict other entities from viewing or modifying these tokens. Another example can include third party vendors having access to their own evaluation tokens that include the results of security assessments relevant to their services, without the ability to access data from other vendors.

In some implementations, the passport system 720 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the passport system 720 can include an interface circuit and function circuit.

In some implementations, the passport system 720 can model cyber resilience data using cyber resilience identities and associated metadata. For example, the passport system 720 can use templates to structure cyber resilience data and apply attributes to model various cyber resilience metrics (e.g., threat detection capabilities, response readiness). In some implementations, the passport system 720 can receive or identify cyber resilience data. For example, the passport system 720 can collect data from various sources, including security incident reports, vulnerability assessments, and/or system performance metrics. In some implementations, the passport system 720 can encrypt a portion of the cyber resilience data. For example, the passport system 720 can apply cryptographic techniques to secure sensitive information within the cyber resilience dataset, such as private keys or confidential incident data. In some implementations, the passport system 720 can generate a metadata object including metadata of cyber resilience data. For example, the metadata object can include information such as data creation timestamps, data source identifiers, and/or encryption keys. In some implementations, the passport system 720 can generate a cyber resilience identity including at least a link with the metadata object, a unique identifier (UID), and/or a performance event dataset. For example, the cyber resilience identity can include a URI linking to the metadata object, a UID for tracking the identity, and/or a dataset summarizing key performance events.

In some implementations, the passport system 720 can encapsulate the cyber resilience identity within a container including a control structure restricting one or more updates and redemptions of the metadata object. For example, the container can use access controls and permission rules to prevent unauthorized modifications or access to the metadata object. In some implementations, the passport system 720 can determine at least one access data structure being compatible with the control structure. For example, the passport system 720 can analyze data structures such as access control lists (ACLs) or role-based access controls (RBAC) to facilitate compatibility with the control structure. In some implementations, the passport system 720 can broadcast, using the control structure, the cyber resilience identity to a ledger or distributed ledger. For example, the passport system 720 can publish the cyber resilience identity to a blockchain or distributed ledger, and the identity can be securely recorded and accessed by authorized entities via the distributed ledger.

In some implementations, the token system 726 can generate various tokens. In some implementations, the token system 726 can generate cyber resilience identities (e.g., a passport including a token linked to various additional tokens with metadata). That is, generating the cyber resilience identities can include generating tokens that include metadata objects or metadata with information corresponding to components and/or metrics of the cybersecurity posture of the entity, such as firmographic information, security safeguards, threat detection capabilities, incident response data, compliance metrics, or other relevant cybersecurity information. For example, the token system 726 can generate, mint, or otherwise create unified safeguard tokens, unified requirements tokens, performance tokens, coverage tokens, incident readiness tokens, insurability readiness tokens, gap tokens, effectiveness tokens, and/or various additional tokens. For example, the token system 726 can structure a token to encapsulate data sets related to different aspects of cybersecurity such that a set of tokens can facilitate an evaluation of the security status of the entity (e.g., by an insurer or vendor). The various tokens generated by the token system 726 and encapsulated in cyber resilience identities are described in greater detail herein.

In some implementations, the cyber resilience identities can include a coverage token. The coverage token can be structured to store information about insurance policies, including policy numbers, premium amounts, and/or coverage data. That is, the token system 726 can generate a coverage token when the insurance coverage data of the entity is to be documented and managed. For example, the coverage token can be created to include policy information such as the insured client, domain, and/or premium data. In generating the cyber resilience identities, the coverage token generated by the token system 726 can include data on insurance coverage, retention terms, and/or claims associated with the policy. For example, the coverage token can store data related to premium payment schedules, policy numbers, and/or claim UIDs that are linked to an insurance policy of an entity corresponding to a cyber resilience identity.

In some implementations, the cyber resilience identities can include an effectiveness token. The effectiveness token can be structured to store a record of the security effectiveness of the organization over time, linking to historical data through performance tokens and capturing outcomes related to incidents and claims. That is, the token system 726 can generate an effectiveness token to document and evaluate the results of past and ongoing security measures within an organization. For example, the effectiveness token can be generated to include the unique effectiveness token UID, the creation date, a list of performance tokens, and/or outcomes related to security incidents and claims. In generating the cyber resilience identities, the effectiveness token generated by the token system 726 can include references to associated performance tokens, incident tokens, and/or claims tokens, providing a longitudinal view of security effectiveness. For example, the effectiveness token can include data indicative of how various incidents have impacted the security posture of the organization over time, including the effectiveness of response efforts and any gaps identified during evaluations.

In some implementations, the cyber resilience identities can include a gaps token. The gaps token can be structured to record and track information about vulnerabilities and compliance issues within the IT infrastructure of the organization. That is, the token system 726 can generate a gaps token to identify and monitor security gaps that could affect the cybersecurity posture of the organization. For example, the gaps token can be generated to include a unique gap UID, timestamp, description of the vulnerability, impact description, severity rating, and/or recommended actions for remediation. In generating the cyber resilience identities, the gaps token generated by the token system 726 can include metadata about at least one (e.g., each) identified gap, including the category of the threat, impact on confidentiality, integrity, and/or availability, and/or references to external resources for further information. For example, the gaps token can capture the severity of a local privilege escalation vulnerability in the IT infrastructure of the organization and provide recommendations for mitigating the threat.

In some implementations, the cyber resilience identities can include an IOCs (Indicators of Compromise) token. The IOCs token can be structured to store and describe indicators of malicious activity detected within an environment of the organization. That is, the token system 726 can generate an IOCs token when there is a need to catalog and track known indicators of compromise that are associated with cybersecurity incidents. For example, the IOCs token can be generated to include a unique indicator UID, type of indicator (e.g., file hash), description of the indicator, and/or a pattern representing the malicious activity. In generating the cyber resilience identities, the IOCs token generated by the token system 726 can include data such as the confidence level in the indicator, the type of malicious activity it represents, and/or the pattern or signature detected. For example, the IOCs token can store information about a malicious file hash associated with a known malware instance, helping to identify and respond to similar threats in the future.

In some implementations, the cyber resilience identities can include an incident token. The incident token can be structured to capture data about a cybersecurity incident, including the type, date, outcome, and/or associated claims data. That is, the token system 726 can generate an incident token when to document and manage the lifecycle of a cybersecurity incident within an organization. For example, the incident token can be generated to include a unique incident UID, the title of the incident, incident data such as the type of attack, impacted data, response actions taken, and/or the associated costs. In generating the cyber resilience identities, the incident token generated by the token system 726 can include references to related tokens, such as TTPs (Tactics, Techniques, and/or Procedures) tokens, IOCs tokens, and/or breach team data, providing an overview of the incident. For example, the incident token can document the timeline of a ransomware attack, the response efforts, the root cause analysis, and/or the financial impact on the organization.

In some implementations, the cyber resilience identities can include a performance token. The performance token can be structured to provide a record of evaluations associated with safeguards and requirements within an organization (e.g., at a time). That is, the token system 726 can generate a performance token when to store the results of evaluations and assessments related to the cybersecurity safeguards of the organization. For example, the performance token can be generated to include a unique performance token UID, the date of creation, safeguard results, safeguard transformation results, and/or comparison results against predefined requirements. In generating the cyber resilience identities, the performance token generated by the token system 726 can include outcomes of safeguard evaluations, transformation proofs, and/or any identified gaps in compliance at a point in time. For example, the performance token can track the effectiveness of endpoint security measures, document how well the measures meet the thresholds, and/or identify areas for improvement.

In some implementations, the cyber resilience identities can include a ransom token. The ransom token can be structured to capture data about a ransomware incident, including ransom demands, payment data, and/or outcomes. That is, the token system 726 can generate a ransom token to document and manage the specifics of a ransomware event within an organization. For example, the ransom token can be generated to include a unique ransom UID, the incident UID it is associated with, data of the ransomware attack such as the group involved, payment wallet address, currency type, and/or the outcome of the payment. In generating the cyber resilience identities, the ransom token generated by the token system 726 can include references to the breach team involved, post-incident follow-up data, and/or information about the threat actor. For example, the ransom token can document the financial impact of the ransom payment, the success rate of data decryption, and/or ongoing risks posed by the threat actor.

In some implementations, the cyber resilience identities can include a TTPs (Techniques, Tactics, and/or Procedures) token. The TTPs token can be structured to provide an overview of a detected cybersecurity threat event, outlining the tactics, techniques, and/or procedures identified. That is, the token system 726 can generate a TTPs token to document and analyze adversarial behaviors detected during a cybersecurity incident. For example, the TTPs token can be generated to include a unique TTP UID, event data such as the event code, provider, start and end time, and/or description of the event, as well as information about the threat, including the tactic employed, techniques used, procedures followed, and/or the threat actor involved. In generating the cyber resilience identities, the TTPs token generated by the token system 726 can include observations from the event, such as the actions taken by the adversary, the outcome of those actions, and/or any data artifacts observed. For example, the TTPs token can document a phishing attack, including how the attack was executed, the tools used by the attacker, and/or the impact on the organization.

In some implementations, the cyber resilience identities can include a unified asset token. The unified asset token can be structured to provide information about the assets managed within an organization, including types, operational statuses, and/or associated identifiers. That is, the token system 726 can generate a unified asset token when to document and manage the lifecycle of assets within the IT infrastructure of the organization. For example, the unified asset token can be generated to include a unique asset UID, the date of creation, asset data such as type, name, description, location, and/or owner, and/or the operational status of the asset. In generating the cyber resilience identities, the unified asset token generated by the token system 726 can include identifiers and sources related to the asset, such as inventory data, cloud provider information, and/or any additional metadata. For example, the unified asset token can document the operational status of the server, its cloud instance data, and/or any associated identifiers such that an organization can track and monitor assets.

In some implementations, the cyber resilience identities can include an incident readiness token. The incident readiness token can be structured to capture the attributes that demonstrate the preparedness of the organization for responding to cybersecurity incidents. That is, the token system 726 can generate an incident readiness token to document and verify an ability of the organization to handle cybersecurity incidents effectively. For example, the incident readiness token can be generated to include a unique incident readiness UID, the associated passport UID, and/or a description of the readiness of the organization to respond to cybersecurity incidents. In generating the cyber resilience identities, the incident readiness token generated by the token system 726 can include attributes such as the incident response plan, training and awareness programs, tools and technologies used, and/or testing exercises conducted. For example, the incident readiness token can document the annual incident response plan updates of the organization, quarterly training sessions of the organization, and/or various additional tools and technologies of the organization in place to detect and mitigate cybersecurity threats.

In some implementations, the cyber resilience identities can include an insurability readiness token. The insurability readiness token can be structured to capture attributes for an organization to qualify for cybersecurity insurance, including risk assessments, security measures, and/or incident history. That is, the token system 726 can generate an insurability readiness token to document and assess the preparedness of the organization for obtaining cybersecurity insurance. For example, the insurability readiness token can be generated to include a unique insurability readiness UID, the carrier UID, the associated passport UID, and/or a description of the preparedness of the organization for cybersecurity insurance. In generating the cyber resilience identities, the insurability readiness token generated by the token system 726 can include attributes such as risk assessments, security measures, documentation and compliance, and/or incident history. For example, the insurability readiness token can document the annual risk assessments of the organization, the implementation of strong cybersecurity controls, and/or the effective mitigation of past incidents, providing an overview of the qualifications of the organization for cybersecurity insurance.

In some implementations, the cyber resilience identities can include or be associated with a passport, which can be a token or a distinct entity interacting with other tokens. The passport can be structured to encapsulate information about an entity, including firmographic data, indicators of cybersecurity readiness, and more. That is, the token system 726 can generate or link to a passport to provide certain information corresponding to the cybersecurity posture and readiness of the entity for insurance purposes. For example, the passport can contain or link to various tokens, such as unified safeguard tokens, unified requirements tokens, performance tokens, coverage tokens, incident readiness tokens, insurability readiness tokens, gap tokens, effectiveness tokens, and/or various additional tokens. For example, the token system can generate a cyber resilience identity or passport providing access to metadata inclusive of various cyber resilience data (e.g., legal structure of the entity, number of protected records of the entity, preparedness for cyber insurance of the entity, etc.) through linked tokens. Additional, token system can 102 can generate the passport linked with a control structure to limit access to data and updates, as further described herein.

In some implementations, the wallet system 712 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor. ASIC. FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the wallet system 712 can include an interface circuit and function circuit.

In some implementations, the wallet system 712 can include a storage mechanism for holding digital assets, including cyber resilience tokens, private keys, and/or access credentials. In some examples, the wallet system 712 can perform cryptographic operations to encrypt and decrypt token-related data and sign transactions, authenticating the client device 110 during interactions with the passport system 720 and the ledger system 730. The wallet system 712 can manage permissions and access control so that authorized can entities initiate or authorize updates to the cyber resilience tokens stored within the ledger system 730. In some implementations, the wallet system 712 can communicate with dynamic non-fungible tokens (DNFTs) or other various tokens associated with the cyber resilience identity. For example, the wallet system 712 can store and manage multiple NFTs or DNFTs representing different aspects of a cybersecurity posture (e.g., cyber resilience status) of an organization or entity. The wallet system 712 can facilitate updates to the tokens by performing cryptographic operations that validate and record changes to the cybersecurity data encapsulated within the DNFTs. The wallet system 712 can also provide an interface that authorized entities use to access and manage the DNFTs, facilitating the review and assessment of the cybersecurity posture of the entity over time.

In some implementations, the wallet system 712 can store, create, and/or update a variety of tokens associated with the cybersecurity posture of an organization or entity. The wallet system 712 can create and update performance tokens, which can include results of cybersecurity events, assessments, or incident responses (e.g., a security breach response or a periodic vulnerability assessment). The wallet system 712 can create and maintain unified tokens, which can include data representing the state of various cybersecurity elements over time (e.g., safeguards implemented across the organization, internal and third party requirements compliance, or asset management). The wallet system 712 can capture and record evaluation tokens, which can include cybersecurity data captured at multiple points in time (e.g., snapshots of the organization cybersecurity posture at regular intervals). The wallet system 712 can aggregate and store roll-up tokens, which can include combined data from unified and real-time tokens to provide a view of the cybersecurity performance over a specified period (e.g., annual security performance summary). The wallet system 712 can create and update resilience tokens, which can include tokens representing different dimensions of the organization cybersecurity posture (e.g., tokens for cybersecurity resilience metrics). The wallet system 712 can further provide interfaces for entities to access, manage, and/or review the various tokens.

In some implementations, the systems or components of FIG. 7 can communicate over network 120. Network 120 can include computer networks such as the Internet, local, wide, metro or other area networks, intranets, satellite networks, other computer networks such as voice or data mobile phone communication networks, combinations thereof, or any other type of electronic communications network. Network 120 can include or constitute a display network. As a non-limiting example, network 120 can implement transport layer security (TLS), secure sockets layer (SSL), hypertext transfer protocol secure (HTTPS), and/or any other secure communication protocol. In some implementations, network 120 can be composed of various network devices (nodes) communicatively linked to form one or more data communication paths between participating devices. The network 120 can facilitate communication between the various nodes, such as the client device 110, third party devices 150, passport system 720, etc. (e.g., using an OSI layer-4 transport protocol such as the User Datagram Protocol (UDP), the Transmission Control Protocol (TCP), Stream Control Transmission Protocol (SCTP), etc.). At least one (e.g., each) networked device can include at least one network interface for receiving and/or transmitting data, typically as one or more data packets. An illustrative network 120 is the Internet (however, other networks can be used). Network 120 can be an autonomous system (AS), e.g., a network that is operated under a consistent unified routing policy (or at least appears to from outside the AS network) and is generally managed by a single administrative entity (e.g., a system operator, administrator, or administrative group).

In some implementations, the ledger system 730 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the ledger system 730 can include an interface circuit and function circuit.

In some implementations, the ledger system 730 can be a ledger or a decentralized ledger. For example, the ledger system 730 can include a distributed ledger technology (DLT) that supports immutable record-keeping and secure data transactions. The ledger system 730 can store various types of tokens and cybersecurity data, including performance tokens, unified tokens, evaluation tokens, roll-up tokens, and/or resilience tokens. The ledger system 730 can securely record updates and changes to tokens (e.g., providing data integrity and traceability). For example, the ledger system 730 can use blockchain to provide a tamper-evident record of token-related transactions.

In some implementations, the ledger system 730 can include smart contract storage 732, blockchain 170, and/or token storage 734. In some implementations, the smart contract storage 732, blockchain 170, and/or token storage 734 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the smart contract storage 732, blockchain 170, and/or token storage 734 can include an interface circuit and function circuit.

In some implementations, smart contract storage 732 can manage and execute predefined agreements related to token transactions and updates. In one example, smart contract storage 732 can store role-based access controls (RBACs or other rule-based control systems) or other access control mechanisms restricting access or updates to tokenized cyber resilience data stored via the ledger system 730. In some examples, the smart contract storage 732 can store rules or other data to automate processes such as token validation, data access control, and/or compliance checks. For example, smart contract storage 732 can store smart contracts that define the rules and logic for managing token transactions and updates. In some examples, smart contract storage 732 can manage contract templates that specify access permissions, including RBACs to restrict access based on user roles. That is, the smart contract storage 732 can implement RBAC to control permissions for executing transactions or modifying token data. Smart contract storage 732 can execute stored access controls/smart contracts to enforce access permissions, validate transactions, and/or verify compliance of entities or organizations with various cyber resilience parameters. In some implementations, smart contract storage 732 can process transactions according to terms, parameters, or rules to restrict access to tokens or other cyber resilience data.

In some implementations, blockchain 170 can include a decentralized ledger that records and validates token transactions. For example, blockchain 170 can utilize consensus mechanisms (e.g., proof of provenance, proof of work, proof of stake) to validate transactions involving tokenized cyber resilience data across a distributed network. In some examples, blockchain 170 can provide a tamper-evident and/or immutable record of token data by employing cryptographic techniques (e.g., hashing functions) to record and verify token transactions. That is, blockchain 170 can provide transparency and traceability of token-related activities by securely recording token transactions on a distributed computing architecture.

In some implementations, token storage 734 can store tokenized cyber resilience data. For example, token storage 734 can store and/or manage tokens including performance tokens, unified tokens, evaluation tokens, and/or roll-up tokens generated and/or provided by the token system 726. In some examples, token storage 734 interfaces with blockchain 170 to manage and organize token data. For example, token storage 734 can handle different token types, including performance tokens, unified tokens, evaluation tokens, and/or roll-up tokens. Token storage 734 can utilize data structures such as relational databases, NoSQL databases, or file systems to organize and manage tokens and/or corresponding data. In some examples, token storage 734 can maintain data accuracy by integrating with blockchain 170 to validate and update token records.

In some implementations, the passport system 720 can include one or more systems and/or subsystems to model cyber resilience data using cyber resilience identities and associated metadata (e.g., cryptographic system 722, ledger interface 724, token system 726, and/or metadata collection system 728). In some implementations, the cryptographic system 722, ledger interface 724, token system 726, and/or metadata collection system 728 can include one or more processing circuits, including processor(s) and memory. The memory can have instructions stored thereon that, when executed by processor(s), cause the one or more processing circuits to perform the various operations described herein. The operations described herein can be implemented using software, hardware, or a combination thereof. The processor(s) can include a microprocessor, ASIC, FPGA, etc., or combinations thereof. In many implementations, the processor(s) can be a multi-core processor or an array of processors. Memory can include, but is not limited to, electronic, optical, magnetic, or any other storage devices capable of providing processor(s) with program instructions. The instructions can include code from any suitable computer programming language. In some implementations, the cryptographic system 722, ledger interface 724, token system 726, and/or metadata collection system 728 can include an interface circuit and function circuit.

In some implementations, the metadata collection system 728 can receive or identify cyber resilience data. That is, receiving or identifying can include the metadata collection system 728 acquiring, processing, and/or categorizing data from various sources, such as cybersecurity events, system performance metrics, and/or vulnerability assessments stored on ledger system 730. For example, the metadata collection system 728 can gather and/or organize data attributes like event timestamps, sources, and/or types corresponding to the cyber resilience status of the entity and other cyber protection information of the entity. Additionally, the metadata collection system 728 can link these data attributes to cyber resilience metrics and update the corresponding records to reflect changes in the cyber protection posture of the entity.

In some implementations, the cryptographic system 722 can encrypt a portion of the cyber resilience data. That is, encrypting can include the cryptographic system 722 securing sensitive data using cryptographic techniques tailored to the requirements of the data. For example, the cryptographic system 722 can apply encryption algorithms to protect sensitive data, such as performance metrics or identifiers of an organization or entity. Further, the cryptographic system 722 can utilize key management techniques to facilitate secure data encryption and decryption process such that authorized entities can access the encrypted data. Additionally, the cryptographic system 722 can use asymmetric encryption to secure data before it is stored or transmitted. For example, the cryptographic system 722 can apply hashing algorithms to verify the integrity of data associated with cyber resilience events and assessments such that the data remains unaltered during transmission or storage.

In some implementations, the token system 726 and/or metadata collection system 728 can generate a metadata object including metadata of cyber resilience data. That is, the token system 726 can create structured metadata objects that include information about tokenized data, such as fields, tags, headers, and/or other relevant attributes like data type, source, and/or context. For example, the token system 726 can organize metadata into formats that provide descriptions and classifications for at least one (e.g., each) element of cyber resilience data. Further, the metadata collection system 728 can collect and integrate various metadata elements, such as timestamps, source identifiers, and/or data relevance indicators, into the metadata object. Additionally, the token system 726 can structure the metadata to improve the understanding and usability of the collected cyber resilience data.

In some implementations, the token system 726 can generate a cyber resilience identity including at least a link with the metadata object, a unique identifier (UID), and/or a performance event dataset. That is, generating can include creating, associating, and/or linking metadata objects, unique identifiers, and/or performance datasets with an identifier of an organization or entity. For example, the token system 726 can generate a passport that links to metadata stored in one or more tokens, at least one (e.g., each) containing data related to different aspects of the cyber resilience of the entity. The passport can include a unique identifier for tracking and linking the metadata object to other associated tokens. Further, the performance event dataset within the passport can capture and store cyber resilience performance data, such as that stored in multiple performance tokens, which can be collected at different points in time. For example, the token system 726 can issue or mint tokens linked to a single token that reference metadata objects and include unique identifiers for tracking, and the token system 726 can embed performance metrics and historical data within the tokens to provide insights into cyber resilience.

In some implementations, the token system 726 can encapsulate the cyber resilience identity within a container that includes a control structure restricting one or more updates and redemptions of the metadata object. That is, encapsulating can include implementing token gating mechanisms or smart contracts to enforce rules on who can update or redeem the cyber resilience identity, based on predefined criteria and access control policies. For example, the token system 726 can establish a control structure that allows a customer to view relevant data within their own passport while restricting the access of the insurer to tokenized data for underwriting decisions. Generally, the passport system 720 can implement a control structure that enforces rules on who can update or redeem the cyber resilience identity based on predefined criteria (e.g., entity type, user preferences/selections, etc.).

In some implementations, the ledger interface 724 can determine at least one access data structure that is compatible with the control structure. That is, determining can include analyzing various data structures to identify or determine alignment with the access control policies and update restrictions defined by the control structure. For example, the ledger interface 724 can evaluate different data structures to verify compatibility with access levels and permissions for interacting with the cyber resilience identity. Additionally, the ledger interface 724 can select and implement data structures that support the secure and compliant management of access and updates within the token system 726.

The control structure (e.g., implemented as a smart contract) governs access to a token structure containing various tokens, such as performance tokens, unified tokens, evaluation tokens, and/or roll-up tokens. The token structure can include metadata, such as unique identifiers (UIDs), creation timestamps, and/or links to related data sets. The smart contract specifies predefined rules for accessing and updating these tokens. The ledger interface 724 can process the smart contract to extract rules that define role-based access control (RBAC) permissions. For example, the smart contract can specify that at least one (e.g., each) third party can access their own data within the token structure. In some implementations, a third party entity can have access its own performance tokens stored in the token structure, such as in a passport associated with the cybersecurity status of an entity. The RBAC rules restrict other entities from viewing or modifying these tokens. Another example can include third party vendors having access to their own evaluation tokens that include the results of security assessments relevant to their services, without the ability to access data from other vendors.

The ledger interface 724 can configure the selected access data structure to enforce these RBAC permissions as extracted from the smart contract. That is, the configuration can include mapping the access permissions to the token structure, linking at least one (e.g., each) token type to the appropriate access control mechanisms. For example, performance tokens related to a particular third party can be linked to a role of the third party. Similarly, unified tokens related to internal compliance can be accessible by authorized roles within the organization itself (e.g., excluding third party access). The ledger interface 724 can integrate the configuration within the ledger system 730 to apply the rules of the control structure to token-related operations. The RBAC can facilitate access to tokens to entities or individuals that have been granted access or authorized to read, update, or add. For example, the control structure can use an access level of an entity or individual to determine whether to allow a user to read data but not update or add to the data (e.g., a third party insurer can access performance datasets on performance tokens linked to a passport of the prosecutive insured, but can be restricted from modifying certain performance data stored thereon), to have full rights (e.g., read/update/add, etc.), and so on. That is, the passport system 720 can provide an access level or permissions to a person or entity attempting to access or otherwise interact with tokenized data corresponding to a cyber resilience identity, and the access level/permissions can be used by the passport system 720 to restrict or allow the user or entity to perform various actions related to the tokens.

In some implementations, if the smart contract is modified, the ledger interface 724 can reconfigure the access data structures to match the updated RBAC rules. For example, if the smart contract is updated to change access permissions for a particular third party entity, the ledger interface 724 can adjust the RBAC configurations to reflect this change such that the access control mechanisms allows access and is consistent with the control structure. In some implementations, an access data structure can function as a token or another access control mechanism within the token structure. That is, the access data structure can facilitate operations, such as reading, writing, adding, or removing metadata objects associated with tokens in the cyber resilience identity (e.g., also operating and implemented as a token). For example, an access control token can link to other tokens representing performance, evaluation, or resilience data. The access control token can encapsulate the permissions for interacting with the tokens and can include metadata defining allowed operations and roles or entities authorized to perform at least one (e.g., each) operation. Additionally, an access data structure can implement write access to one or more metadata objects within the token structure. For example, an access control token can identify which entities have permission to update particular aspects of the cyber resilience identity, such as modifying performance metrics or altering the status of an evaluation token. Another access data structure can be used to manage read permissions, restricting a third party entity to viewing metadata associated with its own tokens within the structure without granting modification rights. In some implementations, an access control structure can function as a token that defines hierarchical permissions across multiple tokens. For example, a control structure token can specify that a designated role within an organization has the authority to add or remove tokens from the cyber resilience identity. Additionally, the access control token can be used to facilitate interactions with other tokens within the token structure to apply these permissions.

In some implementations, the ledger interface 724 can broadcast, using the control structure, the cyber resilience identity to a ledger or distributed ledger. That is, broadcasting can include publishing, sharing, or otherwise transmitting a passport (e.g., cyber resilience identity) of an entity. For example, the ledger interface 724 can transmit the cyber resilience identity to a blockchain or similar distributed ledger to maintain an immutable record of the cyber resilience identity and associated data. Additionally, the ledger interface 724 can store the cyber resilience identity locally (e.g., in a back-end database or other local data store). Further, the ledger interface 724 can transmit or send the cyber resilience identity (e.g., via a shareable link) to various entities, who can access a portion of the data corresponding with the cyber resilience identity but not access another portion of the data based on various access controls.

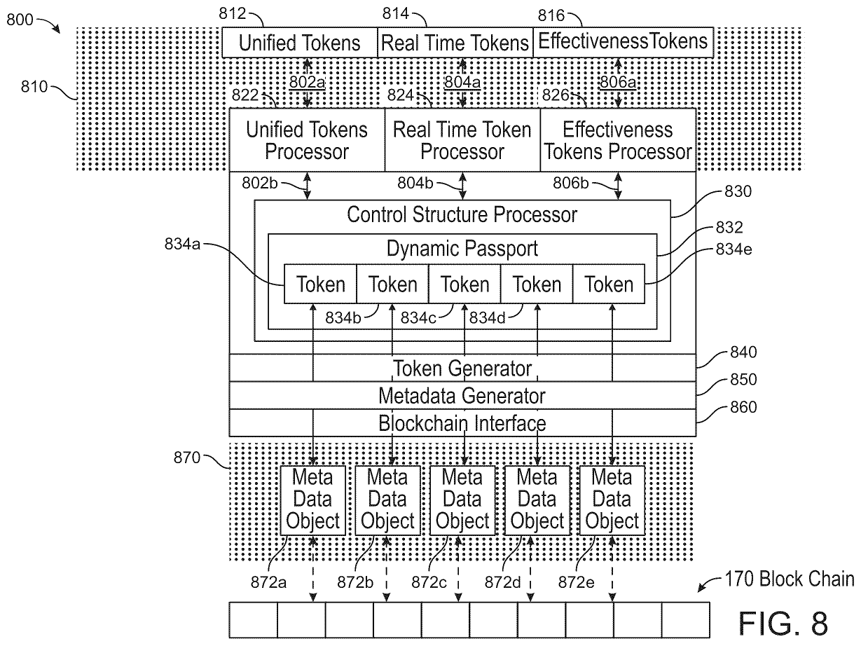

Referring now to FIG. 8, a block diagram 800 of an architecture of certain systems or devices of FIG. 7 is shown, according to some implementations. The implementation shown in FIG. 8 can include a token interface 810 including unified tokens 812, real-time tokens 814, and/or effectiveness tokens 816. The implementation shown in FIG. 8 can also include a smart contract control structure 820 including a unified token processor 822, a real-time token processor 824, and/or an effectiveness token processor 826. Further, the smart contract control structure 820 can include a control structure processor 830, a token generator 840, a metadata generator 850, and/or a blockchain interface 860. In some implementations, the control structure processor 830 can include a dynamic passport 832, and/or dynamic passport 832 can include tokens 834a-834c (collectively, 834). At least one (e.g., each) of the tokens 834 can be linked to a metadata interface 870 including one or more metadata objects 872a-872e (collectively, metadata objects 872). In some implementations, the implementation shown in FIG. 8 can include blockchain 170.

In some implementations, FIG. 8 depicts an example smart contract control structure 820. In some examples, the unified token processor 822, real-time token processor 824, and/or effectiveness token processor 826 can detect a presence of a token (fungible, non-fungible, partially-fungible, etc.), and can transmit the token to a compatibility processor (e.g., unified token processor 822, real-time token processor 824, effectiveness token processor 826) compatible with that particular token. The detection can be responsive to an action by the token interface 810 to transmit the tokens to the smart contract control structure 820. In some examples, the token interface 810 can include a communication channel between one or more of the smart contract control structure 820 and one or more of the unified tokens 812, real-time tokens 814, and/or effectiveness tokens 816. The token interface 810 can include an application programming interface compatible with the smart contract control structure 820 to detect various cyber resilience tokens. At least the token interface 810 or the smart contract control structure 820 can execute one or more instructions to determine whether one or more of the tokens are compatible with the smart contract control structure 820.

In some implementations, the unified token processor 822 can perform detection of unified tokens 812 via a link 802a or other communication channel (e.g., via a network such as network 120). The detection can be responsive to receiving a unified token from token system 726, client device 110, or third party devices 150, over link 802a. The unified token processor 822 can be configured to be compatible with a unified token 812, or can be generated to be compatible with a particular unified token 812. For example, the unified token processor 822 can be integrated with or store a hash based on a unified token 812 and a hash processor operable to generate a hash based on any unified token 812. The unified token processor 822 can generate a hash in response to detecting the presence of the unified token 812, and can determine whether the unified token 812 is compatible with the smart contract control structure 820 by comparing the generated hash with the stored hash. The unified token processor 822 can include logic to detect a unified token 812 passed to it, by, for example, a JSON object or a header argument. Additionally, the unified token processor 822 can provide the detected unified token to the control structure processor 830 via link 802b.

In some implementations, the real-time token processor 824 can perform detection of real-time tokens 814 via link 804a. The detection can be responsive to receiving a real-time token 814 from token system 726, client device 110, or third party devices 150, over link 804a. For example, the real-time token processor 824 can be integrated with or store a hash based on a real-time token 814 and a hash processor operable to generate a hash based on any real-time token 814. The real-time token processor 824 can generate a hash in response to detecting the presence of the real-time token 814, and can determine whether the real-time token 814 is compatible with the smart contract control structure 820 by comparing the generated hash with the stored hash. The real-time token processor 824 can include logic to detect a real-time token 814 passed to it, by, for example, a JSON object or a header argument. Additionally, real-time token processor 824 can provide the detected real-time token 814 to the control structure processor 830 via link 804a.

In some implementations, the effectiveness token processor 826 can perform detection of effectiveness tokens 816 via link 806a. The detection can be responsive to receiving an effectiveness token 816 from token system 726, client device 110, or third party devices 150, over link 806a. For example, the effectiveness token processor 826 can be integrated with or store a hash based on an effectiveness token 816 and a hash processor operable to generate a hash based on any effectiveness token 816. The effectiveness token processor 826 can generate a hash in response to detecting the presence of the effectiveness token 816, and can determine whether the effectiveness token 816 is compatible with the smart contract control structure 820 by comparing the generated hash with the stored hash. The effectiveness token processor 826 can include logic to detect an effectiveness token 816 passed to it, by, for example, a JSON object or a header argument. Additionally, the effectiveness token processor 826 can provide the detected effectiveness token 816 to the control structure processor 830 via link 806b.

In some implementations, the smart contract control structure 820 can include a control structure processor 830 configured to generate and/or store tokens 834. The tokens 834 can include one or more unified tokens 812, real-time tokens 814, and/or effectiveness tokens 816. That is, responsive to receiving one or more of the unified tokens 812, real-time tokens 814, and/or effectiveness tokens 816 from the unified token processor 822, real-time token processor 824, and/or/or effectiveness token processor 826, the control structure processor 830 can receive the tokens 834 via links 802b, 804b, and/or 806b. In some implementations, the control structure processor 830 can generate a container metadata object, such as a wrapper, where a control structure (e.g., a smart contract) is wrapped or otherwise linked to dynamic passport 832, which can further include links to metadata (e.g., stored data, fields, etc.) of tokens 834. For example, the dynamic passport 832 can be encapsulated in a container with a control structure and can generated by metadata generator 850 as part of the metadata interface 870. The container linking dynamic passport 832 and the control structure can provide access to the tokenized cyber information based on the control structure.

In some implementations, the control structure processor 830 can generate a dynamic passport 832 including a token with a link to (e.g., encapsulated in) a container. The link can be established via a digital signature or cryptographic hash that securely associates the dynamic passport 832 with corresponding metadata. The dynamic passport 832 can be provided to a metadata interface 870 such that a blockchain (e.g., blockchain 170) can verify and store the metadata securely on the chain. Additionally, the control structure processor 830 can encapsulate the dynamic passport 832 and tokens 834 within the smart contract control structure 820 to provide the container. For example, encapsulating can include encrypting the data and setting permissions for data access. That is, the encapsulation can restrict outputs of the container metadata object and the metadata objects 872. For example, when the dynamic passport 832 and tokens 834 are encapsulated, the control structure processor 830 can output when conditions or permissions are verified. In another example, when the dynamic passport 832 and tokens 834 are encapsulated in a container, the control structure processor 830 can output when a valid decryption key is presented. For example, the control structure processor 830 can authorize transactions after verifying that compliance and regulatory requirements are met based on data of the tokens 834.

In some implementations, the control structure processor 830 can be configured to perform segmentation or allocation of tokens 834 of the dynamic passport 832 based on parameters by accessing the metadata of a token and container and evaluating compliance with cyber resilience standards. Accordingly, the control structure processor 830 can automatically pool (or tranche) asset tokens (associated with underlying assets) based on parameters. For example, the parameters can be programmed into smart contracts of the control structure processor 830. For example, the dynamic passport 832 can include one or more segmented allocations of the tokens 834 (e.g., with token 834a and 834b segmented into an allocation and tokens 834c-834e segmented into another allocation). While not shown in FIG. 8, a segmented allocation smart contract control structure can be within the smart contract control structure 820 and be operated by the control structure processor 830. In some examples, this integration facilitates automated re-segmentation based on real-time data analysis. In another example, this integration facilitates compliance checks and performance tracking without external system intervention.

In some implementations, at least one (e.g., each) of the tokens 834 can include metadata objects 872. For example, links 809 can connect at least one (e.g., each) token 834 to a respective metadata object 872. In some examples, the metadata interface 870 can be utilized to connect at least one (e.g., each) token 834 to its metadata object 872. For example, the token 834a can be connected to the metadata object 872a via the link 809a, the token 834b can be connected to the metadata object 872b via the link 809b, and so on.

In some examples, the metadata interface 870 can include a communication channel between one or more of the tokens in the smart contract control structure 820 and metadata objects of blockchain 170. That is, metadata objects 872 can be accessed and verified through blockchain transactions to verify integrity and authenticity. Furthermore, blockchain 170 can store links to the metadata objects 872 or store the metadata objects 872 in blocks of the blockchain 170. For examples, the blockchain 170 can store the metadata objects 872 in blocks to verify that participants have consistent and unalterable access to the cyber resilience information stored in the tokens 834 of the dynamic passport 832.

In some implementations, the token interface 810 can include an application programming interface compatible with the smart contract control structure 820 to detect various cyber resilience tokens. In some examples, at least the token interface 810 or the smart contract control structure 820 can execute one or more instructions to determine whether one or more of the tokens (e.g., tokens 834 or corresponding unified tokens 812, real-time tokens 814, and/or effectiveness tokens 816) are compatible with the smart contract control structure 820.

In some implementations, the token generator 840 (e.g., token system 726) can generate one or more tokens (e.g., fungible, semi-fungible, or non-fungible tokens, collectively referred to herein as “controllable electronic records”) in accordance with a token obtained at one or more of the unified token processor 822, real-time token processor 824, and/or effectiveness token processor 826. For example, the token generator 840 can generate tokens based on a number of new metadata objects indicated by an obtained token, and linked with respective smart contract control structures. For example, the token generator 840 can generate a cyber resilience identity (e.g., dynamic passport 832) with links to one or more tokens at least one (e.g., each) linked with a particular smart contract control structure 820 with which the respective token is compatible. The token generator 840 can thus generate a corresponding number of keys that can control restrictions on output by the particular metadata object linked with the particular smart contract control structure compatible with the particular token. The token generator 840 can modify and delete tokens (e.g., tokens 834) linked with cyber resilience identity (e.g., dynamic passport 832), to update control of a partial distribution or exchange of metadata object control.

In some implementations, the metadata generator 850 can generate one or more metadata objects (e.g., metadata objects 872) in accordance with a token obtained at one or more of the unified token processor 822, real-time token processor 824, and/or effectiveness token processor 826 (e.g., at a compatibility processor). That is, the metadata object can include metadata of cyber resilience data. For example, metadata generator 850 can generate multiple tokens based on a number of new metadata objects linked with respective smart contract control structures and encapsulated in a container with a cyber resilience identity (e.g., passport). For example, the metadata generator 850 can generate one or more metadata objects 872 at least one (e.g., each) linked to respective tokens 834 and further linked, via the tokens 834, to the dynamic passport 832 with a particular smart contract control structure 820 by which the metadata object co is controlled. In some examples, the metadata generator 850 can modify and delete metadata objects linked with tokens or smart contract control structures to update control of a partial transfer of metadata object control. Further, the metadata generator 850 can modify and/or update tokens and/or associated information of existing tokens (e.g., tokens 834) corresponding to a cyber resilience identity (e.g., dynamic passport 832).

In some implementations, the blockchain interface 860 can include an API compatible with the blockchain 170 via metadata generator 850. The blockchain interface 860 can selectively add, modify, and/or delete blocks from the blockchain 170. The blockchain interface 860 can add, modify, and/or delete blocks in accordance with restrictions or interfaces of the blockchain 170, and/or can add, modify, and/or delete blocks independently of the restrictions or interfaces of the blockchain 170 at any portion or index of the blockchain 170.

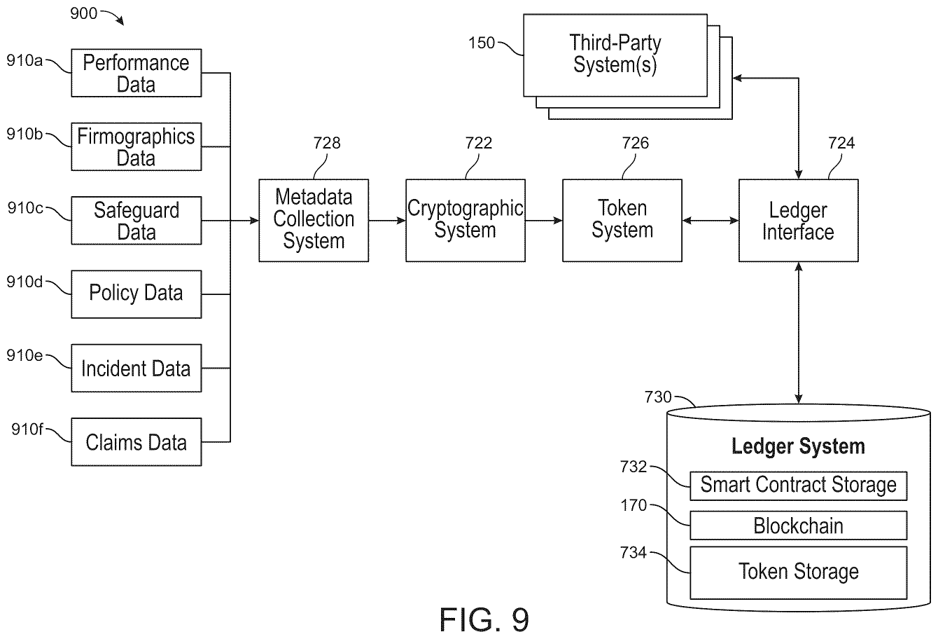

Referring now to FIG. 9, a block diagram 900 of an architecture of certain systems or devices of FIG. 7 is shown, according to some implementations. The implementation shown in FIG. 9 includes third party devices 150 and ledger system 730. The ledger system 730 can include smart contract storage 732, blockchain 170, and/or token storage 734. The implementation shown in FIG. 9 can also include metadata collection system 728, cryptographic system 722, token system 726, and/or ledger interface 724. The implementation shown in FIG. 9 can also include performance data 910a, firmographics data 910b, safeguard data 910c, policy data 910d, incident data 910e, and/or claims data 910f (collectively, cyber resilience data 910).

In some implementations, the metadata collection system 728 can receive or identify cyber resilience data 910. For example, the metadata collection system 728 can collect or retrieve performance data 910a (e.g., metrics related to cybersecurity incidents or system performance), firmographics data 910b (e.g., company size, industry type, or geographic location), safeguard data 910c (e.g., implemented security controls or measures), policy data 910d (e.g., security policies or compliance requirements), incident data 910e (e.g., records of security breaches or system failures), and/or claims data 910f (e.g., insurance claims or risk assessments) of an entity or organization. In some examples, the metadata collection system 728 can integrate data from various cybersecurity tools and databases (e.g., third party devices 150, blockchain 170, etc.) to compile a cyber resilience dataset. In some implementations, the metadata collection system 728 can provide the received or identified cyber resilience data to the cryptographic system 722.

In some implementations, the cryptographic system 722 can encrypt a portion of the cyber resilience data. For example, the cryptographic system 722 can apply symmetric encryption algorithms (e.g., AES) to secure sensitive data such as performance data 910a or firmographics data 910b. In another example, the cryptographic system 722 can use asymmetric encryption techniques (e.g., RSA) to protect keys and authentication credentials. Further, the cryptographic system 722 can implement hashing algorithms (e.g., SHA-256) to verify the integrity of the data by generating unique hash values for at least one (e.g., each) data record. In some implementations, the cryptographic system 722 can provide the portion of encrypted cyber resilience data to the token system 726.

In some implementations, the token system 726 can generate a metadata object including metadata of cyber resilience data. For example, the token system 726 can create metadata objects that encapsulate encrypted performance data, safeguard records, and/or compliance data. In some implementations, the token system 726 can include additional metadata such as timestamps, data sources, and/or integrity checks. In some implementations, the token system 726 can generate a cyber resilience identity including at least a link with the metadata object, a unique identifier (UID), and/or a performance event dataset. For example, the cyber resilience identity can include a UID to uniquely identify the entity, a link to a metadata object (e.g., data of one or more tokens), and/or include a dataset with performance events or incidents. In some implementations, the token system 726 can encapsulate the cyber resilience identity within a control structure restricting one or more updates and redemptions of the metadata object. The control structure can be a data structure or other system including a cyber resilience identifier (e.g., passport) with linked tokens and restricting accessing to metadata object (e.g., data) of certain tokens. In some implementations, the token system 726 can determine at least one access data structure being compatible with the control structure. For example, the token system 726 can utilize various access management techniques, such as access control lists (ACLs), role-based access controls (RBACs), or attribute-based access controls (ABACs), to verify that the access data structure aligns with the permissions and restrictions defined within the control structure. The passport system 720 can assess these access data structures to determine whether the structures comply with predefined standards or policies (e.g., determining whether an entity or authorized user has the appropriate credentials or attributes to access, modify, or update the metadata objects encapsulated within the control structure). Additionally, the token system 726 can dynamically adjust the access parameters based on changes in roles, permissions, or security requirements such that the control structure remains consistent with the evolving access needs of various entities and users involved in managing or interacting with the cyber resilience identity.

In some implementations, access controls, such as role-based access controls (RBACs) or access parameters, can be implemented in various forms to manage permissions for entities interacting with the metadata object (e.g., token). Access controls can include any method or mechanism that limits, restricts, or authorizes access to certain data based on predefined criteria. Examples of access controls could involve establishing rules that dictate who can view, modify, or delete data elements within the metadata object or cyber resilience identity. Such controls can be used to regulate access across different entities, such as allowing a third party like an insurer to view certain data, modify data, or be restricted from accessing other sensitive data. These access controls can also be configured within a broader access management framework, such as ACLs or RBACs, that dynamically adapts to the roles and permissions associated with different users or systems.

In some implementations, the token system 726 can generate a cyber resilience identity including at least a link with the metadata object, a unique identifier (UID), and/or a performance event dataset. For example, the cyber resilience identity can incorporate a UID to uniquely identify the entity, link to the metadata object to reference encrypted data, and/or include a dataset detailing performance events or incidents. The token system 726 can encapsulate the cyber resilience identity within a control structure restricting one or more updates and redemptions of the metadata object. Further, the token system 726 can determine at least one access data structure that aligns with the control structure. For example, the token system 726 can use access control lists or role-based access controls to verify alignment with the control structure for control over which data elements can be accessed or modified by different entities. In some implementations, the ledger interface 724 can broadcast, using the control structure, the cyber resilience identity to a ledger or distributed ledger. For example, the ledger interface 724 can interact with the ledger system 730, including smart contract storage 732, blockchain 170, and/or token storage 734, to submit the cyber resilience identity and associated metadata and publish the cyber resilience identity to blockchain 170. In some examples, the ledger interface 724 can also communicate with third-party devices 150 to share and verify the cyber resilience identity across different platforms and networks (e.g., to transmit to a vendor or insurer).

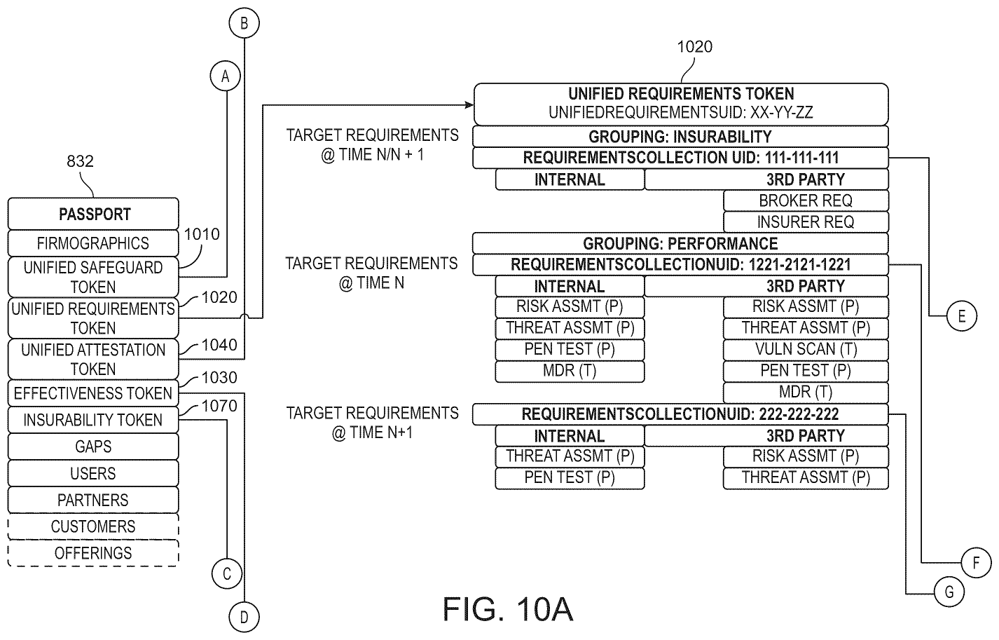

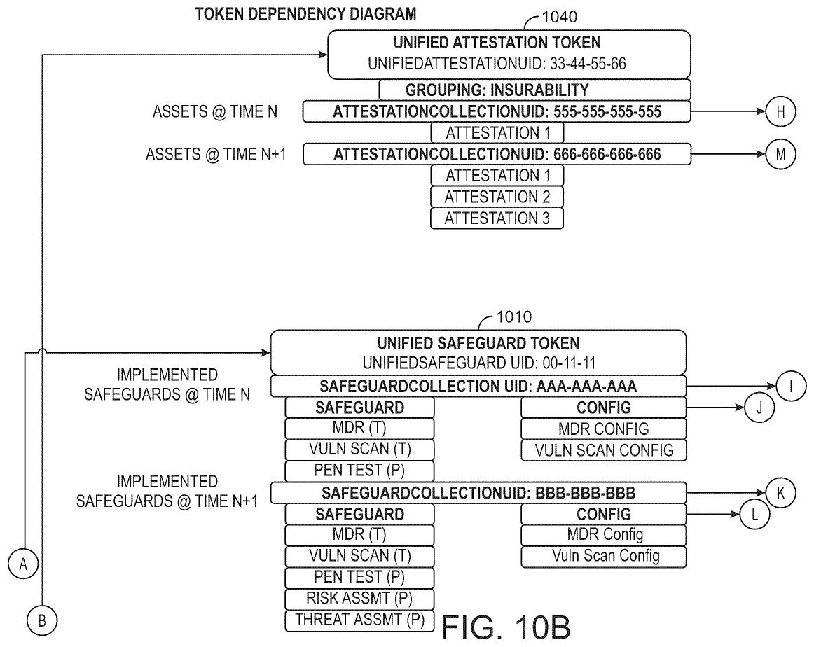

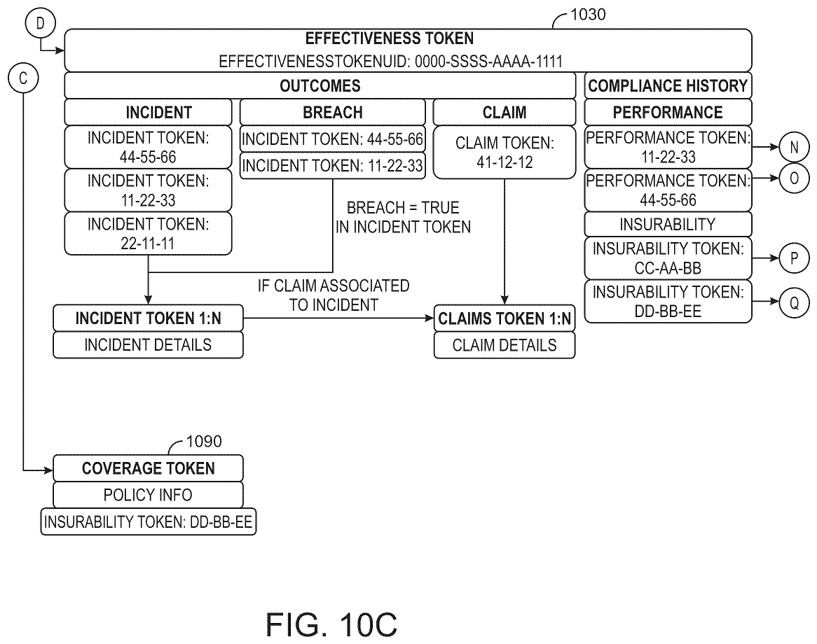

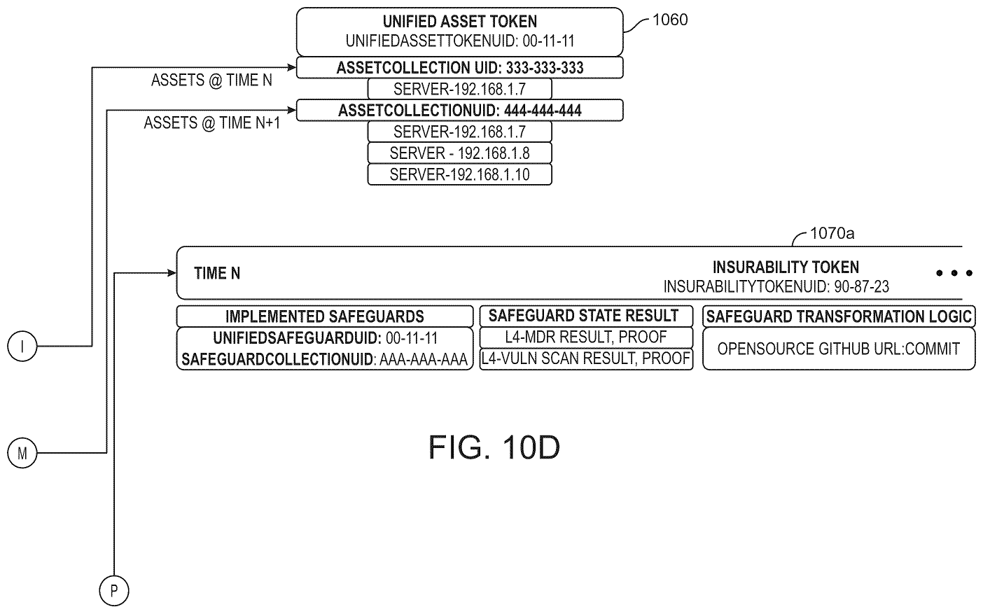

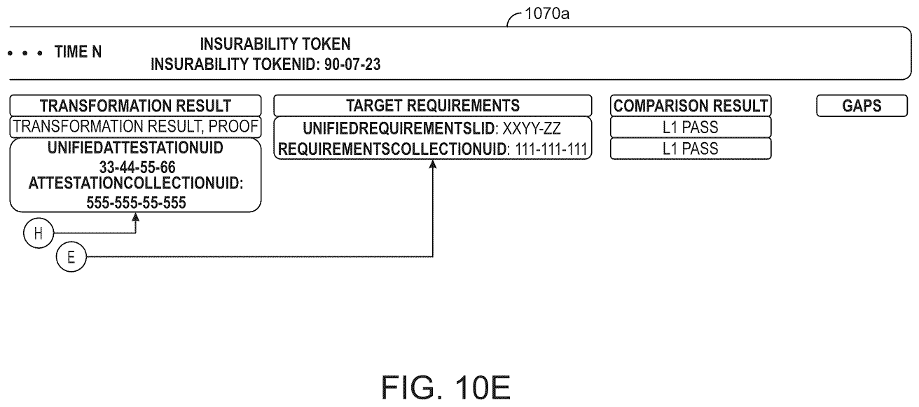

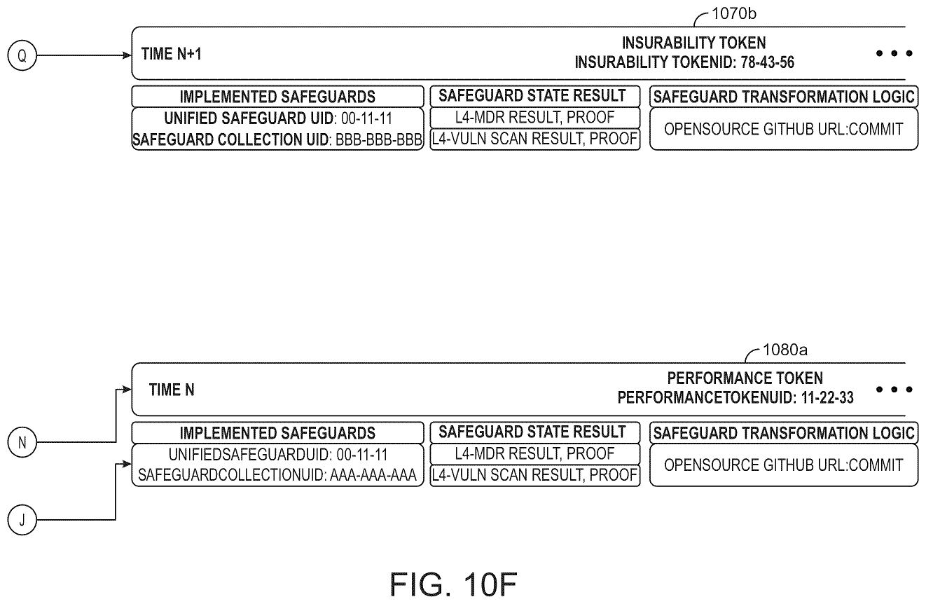

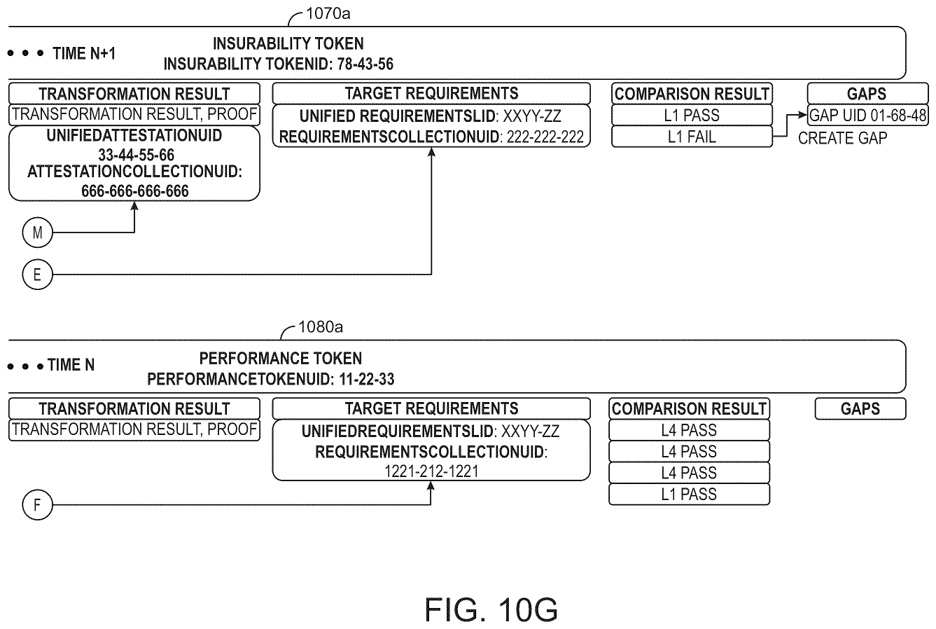

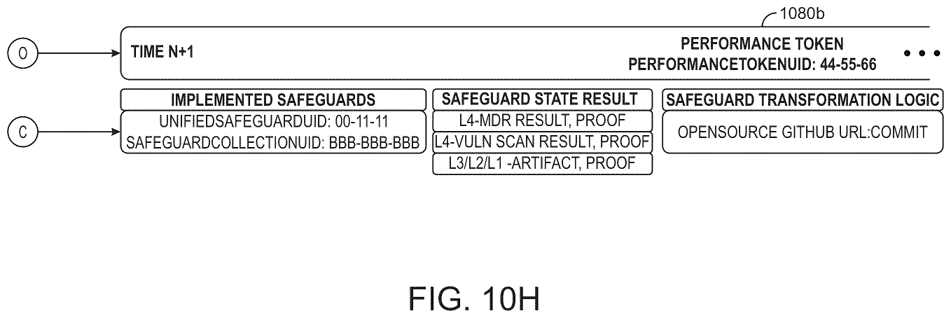

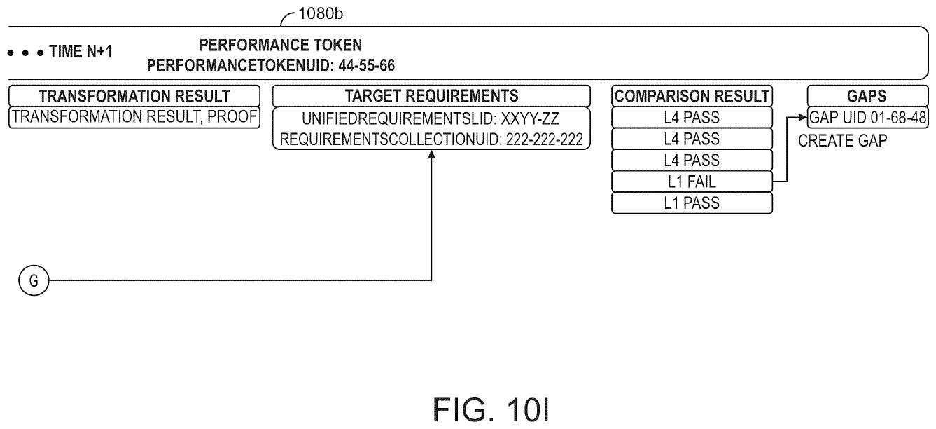

Referring generally to FIGS. 10A-10I, an architecture for tokenized cyber resilience data is shown, according to some implementations. Referring now to FIG. 10A, the dynamic passport 832 can include various cyber resilience data, such as firmographics data, unified safeguards token 1010, unified requirements token 1020, unified attestation token 1040, effectiveness token 1030, insurability token 1070a, gap information, users, partners, customers, offerings, and so on. In some examples, the unified safeguards token 1010 can receive data/be linked with other systems or data via point A, the unified attestation token 1040 can receive data/be linked with other systems or data via point B, the effectiveness token can receive data/be linked with other systems or data via point C, and the insurability token 1070a can receive data/be linked with other systems or data via point D, as further described herein. In some implementations, entities can interact with and/or access the dynamic passport 832 and/or linked tokens (e.g., unified safeguards token 1010, unified requirements token 1020) based on various rules (e.g., access controls with various access parameters).

In some implementations, FIG. 10A illustrates tokenized cyber security data over various times (e.g., time N/N+1, time N, time N+1, etc.). In some implementations, unified tokens (e.g., unified safeguards token 1010, unified requirements token 1020, unified attestation token 1040, etc.) can store metadata of cyber resilience data over a time period. For example, the unified requirements token 1020 can be generated by the token system 726 and can include a unified requirements UID and an insurability grouping with grouped cyber resilience data. In another example, the unified requirements token 1020 can include a first requirements collection UID corresponding to requirements (e.g., cyber resilience standards for a policy) at a first time (e.g., time N/N+1), which can be linked with other systems/and or data via point E, as further described herein. In another example, the unified requirements token 1020 can include a second requirements collection UID corresponding to requirements at a second time (e.g., time N+1), which can be linked with other systems/and or data via point F, as further described herein. Still yet, in another example, the unified requirements token 1020 can include a third requirements collection UID corresponding to requirements at a third time (e.g., time N), which can be linked with other systems/and or data via point G, as further described herein. For example, the first, second, and/or third UID can correspond to various internal and/or third party cyber resilience requirements at different times, such as risk assessment data, threat assessment data, other testing data, MDR data, pen test data, vulnerability scan data, broker requirements, insurer requirements, and so on.

Referring now to FIG. 10B, the unified attestation token 1040 can be linked to the dynamic passport 832 via point A. As described regarding the unified requirements token 1020, the unified attestation token 1040 can include groupings and/or data corresponding to attestations at various times. For example, the unified attestation token 1040 can be generated by the token system 726 and can include an insurability grouping with a first attestation collection UID corresponding with assets (e.g., attestation 1) at a first time (e.g., time N), and the first attestation collection UID can be linked with other systems/data via point H. Further, the unified attestation token 1040 can include a second attestation collection UID corresponding with assets (e.g., attestation 1, attestation 2, attestation 3, etc.) at a second time (e.g., time N+1), and the second attestation collection UID can be linked with other systems/data via point M. In some implementations, the unified safeguard token 1010 can be linked to the dynamic passport 832 via point B. For example, as described above, the unified safeguard token 1010 can include groupings and/or data corresponding to safeguards at various times. For example, the unified safeguard token 1010 can include a first safeguard collection UID corresponding with safeguards (e.g., MDR, vulnerability scans, penetration test rules, etc.) at a first time (e.g., time N), and the first safeguard collection UID can be linked with other systems/data via point I. The unified safeguard token 1010 can further include a first configuration, which can be linked to other data/systems via point J and include data corresponding to cyber resilience systems and/or protection techniques implemented in the cyber resilience architecture (e.g., MDR configurations, vulnerability scan configurations, etc.) of the organization. Further, the unified safeguard token 1010 can include a second safeguard collection UID corresponding with safeguards implemented at a second time (e.g., time N+1), and the second attestation collection UID can be linked with other systems/data via point K. The unified safeguard token 1010 can further include a second configuration, which can be linked to other data/systems via point L.

Referring now to FIG. 10C, a coverage token 1090 can be linked to the dynamic passport 832 via point C. In some examples, the coverage token 1090 can be generated by the token system 726 can include cyber protection information such as policy information (e.g., policy number, type, etc.) and various tokens including insurability information (e.g., an insurability token). In some implementations, the effectiveness token 1030 can be linked to the dynamic passport 832 via point D. The effectiveness token 1030 can include various data corresponding to cyber resilience outcomes, such as incident data (e.g., via incident tokens 1 through N), corresponding breach data (e.g., via incident tokens 1 through N), and corresponding claims data or data (e.g., via claims tokens 1 through N associated with incident tokens 1 through N). In some implementations, the effectiveness token 1030 can include various data corresponding to cyber resilience compliance history, such as performance data. For example, the performance data can include multiple performance tokens including respective timestamps or identifiers corresponding to cyber resilience performance of an entity during one or more incidents/breaches or claims associated with incident tokens and/or claims tokens, and the performance tokens (e.g., performance tokens 1080a-1080b) can be linked to other data/systems via point N and point O. In some implementations, the effectiveness token 1030 can include insurability data, such as one more insurability tokens (e.g., received via coverage token 1090). In some examples, the insurability tokens (e.g., insurability tokens 1070a-1070b) can be linked to other data/systems via point P and point Q.

Referring now to FIG. 10D, the dynamic passport 832 can be linked to the unified asset token 1060 via point I and/or via point M. For example, the unified asset token 1060 can be generated by the token system 726 and can include a first grouping of assets (e.g., server identifier 1) at a first time (e.g., time N) and a second grouping of assets (e.g., server identifier 1, server identifier 2, server identifier 3, etc.) at a second time (e.g., time N+1). In some implementations, the insurability token 1070a can be linked to the dynamic passport 832 via point P with the effectiveness token 1030. For example, the insurability token 1070a can include insurability data at a first time (e.g., time N), such as implemented safeguards and associated identifiers, safeguard state results (e.g., L4-MDR result and proofs, L4-vulnerability scan results and proofs), and/or safeguard transformation logic (e.g., accessible via a URL or other link). Referring now to FIG. 10E, the insurability token 1070a can further include a transformation result and/or proof, which can be linked via UIDs to point H with the unified attestation token 1040. The insurability token 1070a can further include target requirements, which can be linked via UIDs or other identifiers with the unified requirements token 1020. The insurability token 1070a can further include comparison results (e.g. L1) pass, gap data (e.g., data of missing and/or inadequate cyber protections), and more.

Referring now to FIG. 10F, the dynamic passport 832 can be linked to the insurability token 1070b via point Q. As shown in FIG. 10F, the insurability token 1070b can be generated by the token system 726 and can include insurability data at a second time (e.g., time N+1), such as implemented safeguards and associated identifiers, safeguard state results, and/or safeguard transformation logic. For example, the insurability token 1070b can include encrypted data of implemented safeguards, such as firewall configurations or endpoint protection settings, verified against cyber resilience requirements. The encrypted data can be encapsulated within a control structure configured to restrict updates or access based on cryptographic proofs, allowing authorized entities (e.g., those with permitted access based on RBACs) to modify, create, view, and/or retrieve the data in accordance with access controls defined for the dynamic passport 832. In some implementations, the dynamic passport 832 can be linked to the performance token 1080a via point N with the effectiveness token 1030. In some examples, the performance token 1080a can include performance data of an entity at a first time (e.g., time N), including implemented safeguards, results, transformation logic, and so on. In some implementations, the implemented safeguards can be linked, via point J, with a configuration of the unified safeguard token 1010.

Referring now to FIG. 10G, the insurability token 1070b can further include a transformation result and/or proof, which can be linked via UIDs to point M with the unified attestation token 1040. In some implementations, the insurability token 1070b can be generated by the token system 726 and can further include target requirements, which can be linked via UIDs or other identifiers with the unified requirements token 1020 via point E. Further, the insurability token 1070a can further include comparison results (e.g. L1 pass/fail), gap data (e.g., gap UIDs), and so on. In some implementations, the performance token 1080a can further include transformation results and/or proofs, comparison results (e.g., L4 pass/fail), and gaps. Further, the insurability token 1070b (or another token) can store cryptographic proofs of provenance corresponding with and entity and/or associated cyber resilience data. In some examples, the performance token 1080a can include target requirements and associated IDs, accessible via point F, from the unified requirements token 1020.

Referring now to FIG. 10H, the dynamic passport 832 can be linked to the performance token 1080b via point O with the effectiveness token 1030. In some examples, the performance token 1080b can be generated by the token system 726 and can include performance data of an entity at a second time (e.g., time N+1), including implemented safeguards, results, transformation logic, and so on. For example, the performance token 2080a and the performance token 2080b can include performance data sets encapsulated within a control structure corresponding to the dynamic passport 832, and access to data of the performance tokens 1080a-1080b can be granted based on a specific access data structure compatible with a control structure (e.g., allowing authorized entities to retrieve and/or update metadata of the performance token 1080b based on access controls, restricting access and/or updates to the performance data based on access controls, etc.). In some implementations, the implemented safeguards can be linked, via point L, with a configuration of the unified safeguard token 1010. Referring now to FIG. 10I, the performance token 1080b can further include transformation results and/or proofs, comparison results, and gaps. The performance token 1080b can also include target requirements and identifiers received via point G with the unified requirements token 1020.

### End Point Integration and Mapping

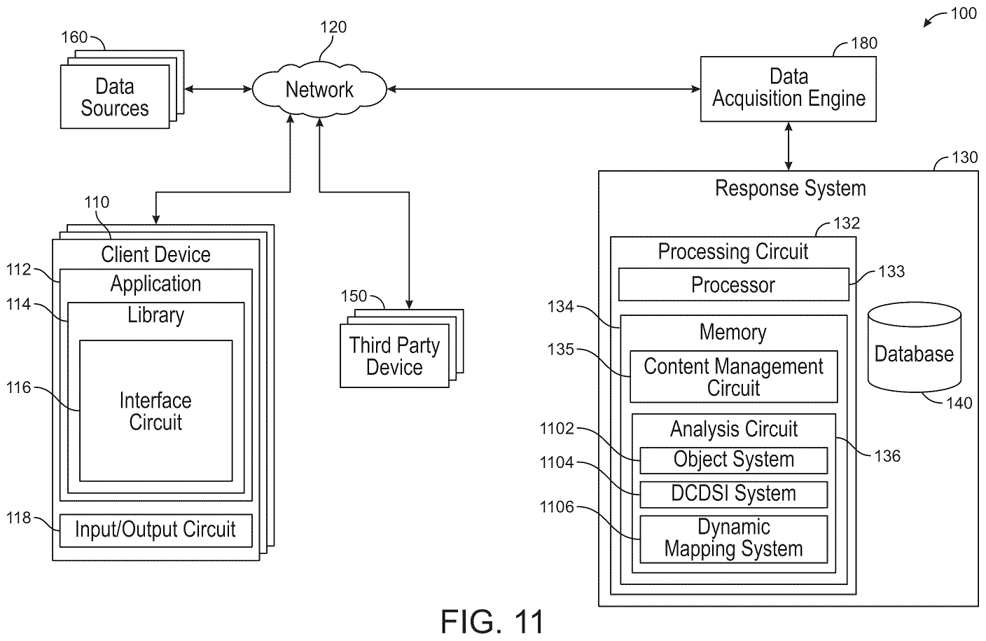

Referring to FIG. 11, a block diagram of an implementation of a system for endpoint integration and mapping is shown, according to some implementations. The implementation shown in FIG. 11 includes a client device 110 (also referred to herein as “client devices 110” and/or “user computing system(s) 110”), response system 130, third party device 150 (also referred to herein as “third party system(s) 150” and/or “third party devices 150”), data sources 160, and/or data acquisition engine 180. The various components of FIG. 11 can be interconnected through a network 120 that supports secure communications profiles (e.g., TLS, SSL, HTTPS, etc.). In some implementations, the elements shown in FIG. 11 can incorporate similar features and functionality as described regarding the elements shown on FIG. 1A and/or FIG. 7. For example, the response system 130, as shown in FIG. 11, incorporates similar functionality as described regarding the response system 130 of FIG. 1A, and the database 140, can incorporate the same or similar functionality as described regarding the database 140 of FIG. 1A, and so on. Specifically, like callout references of FIG. 1A are now further described, however the features and functionalities of components like the response system 130 in FIG. 11 still correspond to those referred to with the same callout reference in FIG. 1A. For example, response system 130 described in FIG. 11 can include additional functionality and features related to endpoint integration and mapping (also referred to herein as “linking”).

In some implementations, the client device 110 can include an application 112 and an input/output circuit 118. The application 112 can include a library 114, and the library 114 can include an interface circuit 116. In some implementations, the response system 130 can include a processing circuit 132 and a database 140. The processing circuit 132 can include a processor 133 and memory 134. The memory 134 can further include a content management circuit 135 and an analysis circuit 136. In some implementations, the analysis circuit 136 can include an object system 1102, a DCDSI system 1104, and/or dynamic mapping system 1106, as further described herein.

At least one (e.g., each) system or device of FIG. 11 can include one or more processors, memories, network interfaces (sometimes referred to herein as a “network circuit”) and user interfaces. The memory (e.g., memory 134) can store programming logic (e.g., content management circuit 135) that, when executed by the processor, controls the operation of the corresponding computing system or device. The memory can also store data in databases. For example, memory can store programming logic that when executed by a processor within a processing circuit, causes a database to update parameters or store a system or event log. The network interfaces can allow the computing systems and devices to communicate wirelessly or otherwise. The various components of devices in system 100 can be implemented via hardware (e.g., circuitry), software (e.g., executable code), or any combination thereof. Devices, systems, and/or components in FIG. 11 can be added, deleted, integrated, separated, and/or rearranged in various implementations of the disclosure.

Generally, the client device 110, response system 130, third party devices 150, analysis circuit 136, object system 1102. DCDSI system 1104, and/or dynamic mapping system 1106 can include one or more logic devices, which can be one or more computing devices equipped with one or more processing circuits that run instructions stored in a memory device to perform various operations. The processing circuit can be made up of various components such as a microprocessor, an ASIC, or an FPGA, and the memory device can be any type of storage or transmission device capable of providing program instructions. The instructions can include code from various programming languages commonly used in the industry, such as high-level programming languages, web development languages, and/or systems programming languages. The client device 110, response system 130, and/or other various components of FIG. 11 can also include one or more databases for storing data that receive and provide data to other systems and devices on the network 120.

In some implementations, one or more elements of FIG. 11 can be communicably coupled (connected) to a distributed ledger (e.g., blockchain 170 of FIG. 1B) or other authoritative data source to provide data integrity and security. For example, as described above regarding FIG. 1A, the database 140 can be a private ledger and data source 160 can be a public ledger, and data transactions (e.g., updates to proof/posture state data, cybersecurity parameters, entity data, etc.) recorded on the database 140 can be validated against entries recorded on the data source 160 to verify that updates to entries are accurately reflected and can be audited against an immutable record. In some implementations, the application 112 can be configured to integrate with technology and databases (e.g., database 140, response system 130, etc.) to access information used synchronizing or protecting data. The user can access the application 112 through a variety of devices, including client device 110. In some implementations, the response system 130 is operably connected to data acquisition engine 180 and includes analysis circuit 136 for endpoint integration and mapping.

In some implementations, third party devices 150 can include one or more endpoints. For example, third party devices 150 can include vendor endpoints, insurer systems, cloud service providers, threat intelligence platforms, or other external systems. Third party devices 150 can include various application programming interfaces (APIs) and can integrate with response system 130 to exchange data and improve the security posture of an organization. For example, third party devices 150 can communicate with the analysis circuit 136 of the response system 130 using a data communication link (e.g., network 120) maintaining the confidentiality and integrity of data transmitted between third party devices 150 and response system 130. Further, the third party devices 150 can provide a response to an endpoint call addressed to one or more of the third party devices 150 (e.g., a call performed by analysis circuit 136, etc.). In some examples, the data received from third party devices 150 can be processed by the response system 130 and/or analysis circuit 136 to assess and address potential cybersecurity threats.

In some implementations, third party devices 150 can include data sources that provide cybersecurity-related information to response system 130. For example, third party devices 150 could include cloud-based security services, threat intelligence platforms, or other external systems that monitor and report on cybersecurity incidents. The data provided by third party devices 150 can be integrated into response system 130 via dynamic mapping system 1106, which can map the received data to relevant cybersecurity parameters within the infrastructure of the organization. Additionally, third party devices 150 can operate in conjunction with DCDSI system 1104 to perform automated cybersecurity tasks. For example, third party devices 150 can response to DCDSI calls and execute various tasks (e.g., detecting threats, initiating a security audit, updating access controls, executing remediation protocols, etc.). DCDSI system 1104 can facilitate interaction between third party devices 150 and the internal systems of the organization by transmitting the appropriate data and commands (e.g., to integrate endpoint data and/or access information with the internal cybersecurity framework of the organization.

In some implementations, the response system 130 can execute various processes and/or functions for endpoint mapping and integrations. In some implementations, the response system 130 can include one or more processing circuits 132, including processor(s) (e.g., processor 133) and memory (e.g., memory 134). The memory 134 can have instructions stored thereon that, when executed by processor(s), cause the one or more processing circuits 132 to perform the various operations described herein. The operations described herein can be implemented using software, hardware, or a combination thereof. The processor(s) 133 can include a microprocessor, ASIC, FPGA, etc., or combinations thereof. In many implementations, the processor(s) 133 can be a multi-core processor or an array of processors. Memory 134 can include, but is not limited to, electronic, optical, magnetic, or any other storage devices capable of providing processor(s) with program instructions. The instructions can include code from any suitable computer programming language.

In some implementations, the response system 130 can include various systems and/or subsystems for endpoint mapping and integration, including analysis circuit 136. In some implementations, the analysis circuit 136 can identify one or more decentralized compute and data store interface (DCDSI) endpoints and corresponding access information. That is, identifying can include the analysis circuit 136 determining, locating, or categorizing decentralized interfaces across various platforms, such as APIs, blockchain nodes, cloud services, or other external systems that interact with cyber resilience data (e.g., insurer data, customer data, etc.). For example, the analysis circuit 136 can identify APIs provided by external services to be integrated into the cybersecurity infrastructure of the organization. Additionally, the analysis circuit 136 can extract access credentials and endpoint addresses from a third party security documentation of the service.

In some implementations, the analysis circuit 136 can generate an object package corresponding to the one or more DCDSI endpoints. That is, generating can include the analysis circuit 136 forming, initializing, calling, or otherwise creating a data structure that includes operations and information to interact with various types of decentralized compute and data store interface (DCDSI) endpoints. For example, in generating the object data package, the analysis circuit 136 can further initiate the object package based on an identifier corresponding to at least one DCDSI endpoint type (e.g., based on an insurer type). Additionally, the analysis circuit 136 can initiate an object package configured for a cloud storage API endpoint, structuring methods of the object package according to the endpoint. In another example, the analysis circuit 136 can initiate an object package for a blockchain endpoint that follows the protocols and data formats of the blockchain network. In some implementations, the object package is structured according to the at least one DCDSI endpoint type (e.g., vendor API endpoint, insurance API endpoint, cybersecurity tool endpoint, blockchain endpoint, cloud storage endpoint, or any other endpoint category). That is, the object package can include data formatting rules and access protocols customized to a category (e.g., user, insurer, administrator, third party service, or any system) corresponding to the identified DCDSI endpoint (e.g., a template/workflow based on an endpoint type).

In some implementations, in generating the object data package, the analysis circuit 136 can further map, in the object package, the access information to an access scheme corresponding to one or more formatted requests to access the one or more DCDSI endpoints. That is, mapping can include the analysis circuit 136 linking, providing, and/or associating access parameters and credentials with the corresponding data structure to facilitate communication with the identified DCDSI endpoints. For example, the analysis circuit 136 can map API request parameters (e.g., query strings, authentication keys, endpoint addresses, request methods, or any request parameter) and authentication tokens (e.g., OAuth tokens, API keys, session tokens, or any security credential) to a predefined access scheme for a cloud storage endpoint. In another example, the analysis circuit 136 can configure the object package to include headers and payload structures for a blockchain API call. In some implementations, the one or more formatted requests correspond with requesting protection data. Additionally, the formatted requests can include API calls to retrieve security policies, access logs, or threat intelligence from a decentralized data store.

Generally, a DCDSI endpoint can refer to any interface that allows decentralized computation or data storage across various categories. That is, the DCDSI endpoint can be a vendor API endpoint (or access point), insurance API endpoint (or access point), a cybersecurity tool interface, a blockchain node, a cloud service API, a distributed database, a peer-to-peer network interface, an edge computing node, a remote procedure call endpoint, or any distributed computing interface or third party endpoint interface. For example, a first DCDSI endpoint can be a vendor API endpoint. In another example, a second DCDSI endpoint can be an insurer API endpoint.

In some implementations, an object package can refer to a structured data payload configured to facilitate communication with an endpoint based on its category (or type, protocol, function). That is, the object package can be a configuration file, an API request template, a serialized data object, a command set, an executable script, or any structured data format dynamic to the endpoint type. For example, a first object package can be a JSON configuration file for insurance API integration. In another example, a second object package can be a serialized command object for blockchain transaction execution. In some implementations, a header of an object package can be a metadata segment that contains information about the package contents. For example, a header can be an API version identifier, a content-type specifier, a security token, a timestamp, or any metadata field. Additionally, a payload structure of an object package can be the data to be processed by the endpoint. For example, a payload structure can be a JSON object, an XML document, a binary data stream, a command list, or any structured data format.

In some implementations, an access scheme can refer to a predefined method for gaining access to an endpoint based on its category. That is, the access scheme can be an authentication protocol, a permission set, a session management routine, an API call sequence, a data retrieval strategy, or any access control method specific to the endpoint type. For example, a first access scheme can be OAuth-based token authentication for a cybersecurity tool. In another example, a second access scheme can be an API key verification process for an insurance API.

In some implementations, a formatted request can refer to a structured query or command sent to an endpoint based on its category. That is, the formatted request can be an HTTP GET request, a SQL query, a blockchain transaction, a remote procedure call, a file upload command, or any data retrieval or submission command suited to the endpoint type. For example, a first formatted request can be an HTTP POST request with JSON payload for an insurance API. In another example, a second formatted request can be a blockchain transaction submission.

In some implementations, the analysis circuit 136 can further perform a DCDSI endpoint request. In some implementations, the analysis circuit 136 can further perform a DCDSI endpoint request. That is, performing the DCDSI endpoint request can include accessing various decentralized interfaces, such as APIs, smart contracts, or blockchain nodes, to retrieve or verify data. For example, to perform the DCDSI endpoint request, the analysis circuit 136 can initiate an API call to a third party service to retrieve encrypted data logs or verify the integrity of transaction records. Additionally, in performing the DCDSI endpoint request, the response system 130 can access other decentralized endpoints, including cloud-based services or distributed ledgers, to process or store cybersecurity-related data. In some implementations, the analysis circuit 136 can initiate an API call to a third party API (e.g., insurer API) to retrieve encrypted data logs. In another example, the analysis circuit 136 can perform a request to a blockchain-based service to verify the integrity of transaction records.

In some implementations, in performing the DCDSI endpoint call, the analysis circuit 136 can invoke the object package to execute the DCDSI endpoint request using at least one formatted request of the one or more formatted requests. That is, invoking the object package can include calling methods within the object package that interact with decentralized endpoints, such as APIs, blockchain services, or cloud-based systems, to initiate data retrieval or processing operations. For example, to invoke the object package, the analysis circuit 136 can call a method within the object package that executes a formatted API request to retrieve cybersecurity metrics (e.g., threat intelligence data, incident response metrics, compliance status reports, quote data, product offerings) from a decentralized compute service. Additionally, when the analysis circuit 136 invokes the object package, the object package can execute methods linked to other decentralized interfaces, such as smart contracts or distributed storage systems, to perform or manage cybersecurity-related tasks.

In some implementations, in performing the DCDSI endpoint call, the analysis circuit 136 can receive output data including a response to the DCDSI endpoint request by a DCDSI system. That is, the output data can include a response to the endpoint call with various cyber resilience data, such as encrypted data sets, transaction verification results, security compliance report, quotes, product offerings, and more. For example, the output data can include an API response returned by the DCDSI endpoint in response to an API call made to a DCDSI endpoint address of the DCDSI endpoint. Additionally, the output data can include a formatted response to an API call (e.g., formatted cybersecurity metrics, threat intelligence data, incident response metrics, compliance status reports, quote data, and/or product offerings from a decentralized compute service. Additionally, when the analysis circuit 136 invokes the object package, the system can execute methods linked to other decentralized interfaces, such as smart contracts or distributed storage systems, to perform or manage cybersecurity-related tasks.

In some implementations, the analysis circuit 136 can update a distributed ledger, token, or data source based on the output data. That is, updating can include the analysis circuit 136 recording or modifying entries in a distributed system, such as a blockchain ledger, token-based system, or local data storage, based on data received from the DCDSI endpoint. For example, the analysis circuit 136 can store the retrieved compliance data or audit logs in a blockchain ledger (e.g., blockchain 170), and/or using various cyber resilience tokens (e.g., as described regarding FIGS. 7-10I). Additionally, the analysis circuit 136 can synchronize the updated data with local storage systems or replicate the data across decentralized networks such that output data can be accessed by various cybersecurity resources.

In some implementations, the analysis circuit 136 can include various systems and/or subsystems for endpoint mapping and integration, including object system 1102, DCDSI system 1104, and/or dynamic mapping system 1106. In some implementations, the DCDSI system 1104 can identify one or more decentralized compute and data store interface (DCDSI) endpoints and corresponding access information. DCDSI endpoints can be decentralized interfaces for computing and data storage, such as APIs, smart contracts, and/or other decentralized systems that interact with various services and platforms. For example, the DCDSI system 1104 can identify APIs, smart contract interfaces, decentralized storage gateways, or blockchain nodes associated with cloud storage services to be integrated into the cybersecurity framework of the organization. In another example, the DCDSI system 1104 can extract endpoint data such as URLs, authentication credentials, and/or parameters from technical documentation of a third party service (e.g., OpenAPI specification from third party devices 150). That is, the DCDSI system 1104 can extract the endpoint data by analyzing and/or parsing the documentation, extracting relevant metadata, and/or generating configuration templates. Further, the DCDSI system 1104 can analyze logs from previous endpoint communications and responses to identify recurring access patterns and optimize future endpoint integrations. For example, the DCDSI system 1104 can analyze response times and error rates to adjust retry logic and timeout settings. In another example, the DCDSI system 1104 can identify frequently accessed endpoints and prioritize their integration within the cybersecurity framework.

In some implementations, the object system 1102 can generate an object package corresponding to the one or more DCDSI endpoints. That is, generating the object package can include obtaining, creating, or providing a data structure. For example, the object system 1102 can generate an object package based on an endpoint type and modify the object template based on a workflow corresponding to the endpoint type. For example, the object package can be a software construct in object-oriented programming (OOP) containing methods configured for API calls, data exchange, and/or response handling specific to at least one (e.g., each) DCDSI endpoint. In another example, the object package can be a dynamic and/or modular data structure configured to interface with various endpoint protocols, facilitate integration, data transformation, and/or execution of automated workflows and other actions across decentralized platforms.

In some implementations, in generating the object package, the object system 1102 can further initiate the object package based on an identifier corresponding to at least one DCDSI endpoint type. That is, the object package can be configured based on an endpoint identifier or category (e.g., insurer, vendor, provider, etc.). For example, the object system 1102 can initiate an object package configured for an insurer API endpoint, structuring the object package according to the protocol requirements of the API. In another example, the object system 1102 can initiate an object package for an insurer or vendor endpoint, including data structures and communication protocols for the blockchain network.

In some implementations, the object package is structured according to the at least one DCDSI endpoint type. That is, a DCDSI endpoint type can include a range of categories, including but not limited to cloud service APIs, blockchain interfaces, insurance data providers, customers/users, cybersecurity tools, decentralized storage systems, financial transaction networks, IoT device gateways, machine learning model endpoints, remote sensing systems, edge computing nodes, healthcare data exchanges, digital identity verification services, content delivery networks (CDNs), smart contract platforms, federated learning systems, supply chain tracking interfaces, digital payment processors, environmental monitoring sensors, and/or telecommunication network interfaces. For example, the object system 1102 can incorporate data formatting rules and authentication mechanisms within the object package to match the endpoint type.

In some implementations, in generating the object package, the dynamic mapping system 1106 can further map the access information to an access scheme corresponding to one or more formatted requests to access the one or more DCDSI endpoints. That is, mapping can include the dynamic mapping system 1106 associating, providing, or otherwise linking various cyber resilience data and/or systems. For example, the dynamic mapping system 1106 can configure the object package to include predefined API request formats, authentication tokens, and/or headers customized to the DCDSI endpoint. In another example, the dynamic mapping system 1106 can align the access scheme with security protocols of the endpoint.

In some implementations, the one or more formatted requests correspond with requesting protection data. For example, the formatted requests can include API calls to retrieve compliance reports, incident logs, threat intelligence feeds, vulnerability assessments, security policy updates, access control lists, encryption keys, audit trails, system configuration files, real-time monitoring data, user activity logs, breach notifications, risk assessment scores, intrusion detection alerts, malware signatures, software patch statuses, regulatory compliance certificates, penetration testing results, encryption certificates, network traffic analyses, forensic investigation reports, data classification labels, endpoint protection statuses, phishing detection metrics, security training records, firewall configurations, tokenized credentials, multi-factor authentication logs, as well as quotes, pricing information, product data, service level agreements (SLAs), inventory status, purchase orders, contract terms, customer support tickets, billing records, and/or other cybersecurity-related data or business data from a decentralized compute service.

In some implementations, the DCDSI system 1104 can further perform a DCDSI endpoint request. For example, the DCDSI system 1104 can execute an API call to a vendor to obtain cyber resilience information responsive to the executed call. That is, the DCDSI system 1104 can perform a call or otherwise transmit a request to an endpoint to receive cyber resilience information. In another example, the DCDSI system 1104 can initiate a request to an insurer to access cyber insurance information. In some implementations, in performing the DCDSI endpoint call, the object system 1102 can invoke the object package to execute the DCDSI endpoint request using at least one formatted request of the one or more formatted requests. For example, the object system 1102 can trigger a formatted API call to access encrypted cybersecurity data stored on a remote server.

In some implementations, in performing the DCDSI endpoint call, the DCDSI system 1104 can receive output data including a response to the DCDSI endpoint request by a DCDSI system. That is, receiving can include the DCDSI system 1104 retrieving various cyber resilience data via a network. For example, the DCDSI system can access threat analysis reports, compliance metrics, vulnerability scans, incident response summaries, audit logs, encryption status updates, security policy adherence checks, access control validations, breach investigation reports, real-time monitoring alerts, user activity analytics, risk assessment results, intrusion detection logs, malware detection signatures, software patch compliance reports, regulatory compliance validations, penetration testing outcomes, encryption certificate verifications, network traffic summaries, forensic analysis findings, data classification compliance, endpoint protection statuses, phishing attempt detections, security training completion records, firewall rule evaluations, token authentication logs, multi-factor authentication activity reports, as well as retrieved quotes, pricing models, product specifications, service level agreement (SLA) compliance data, inventory updates, purchase order statuses, contract fulfillment metrics, customer support resolutions, billing summaries, and/or other security-related or business data returned by the DCDSI endpoint.

In some implementations, the dynamic mapping system 1106 can update a distributed ledger or data source based on the output data. For example, the dynamic mapping system 1106 can record the received data on blockchain 170 or in an internal database. That is, updating can include the analysis circuit 136 recording or modifying entries in a distributed system, such as a blockchain ledger, token-based system, or local data storage, based on data received from the DCDSI endpoint. For example, the analysis circuit 136 can store the retrieved cyber resilience data a blockchain ledger (e.g., blockchain 170), and/or using various cyber resilience tokens (e.g., as described regarding FIGS. 7-10I).

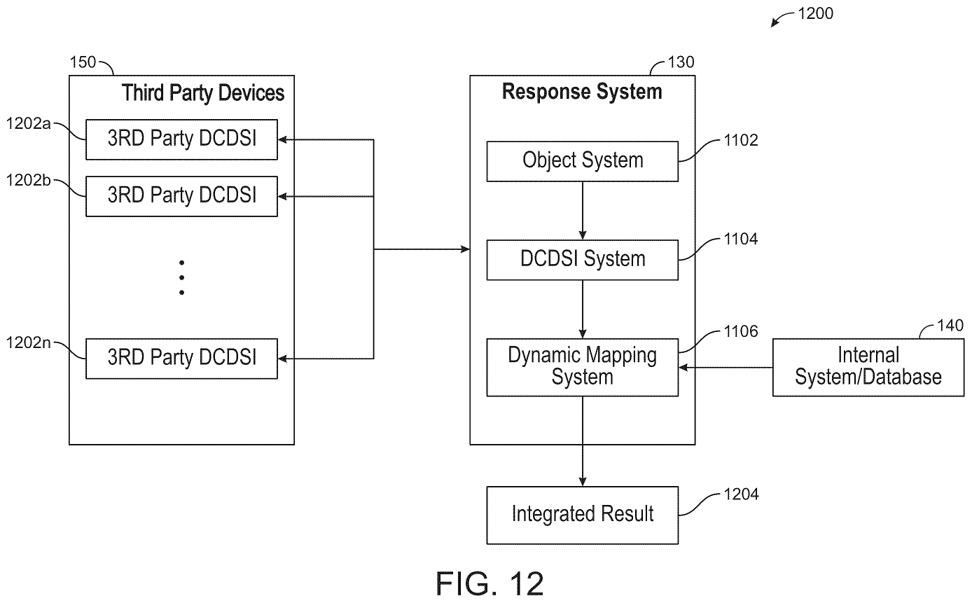

Referring now to FIG. 12, a block diagram 1200 of a more detailed architecture of certain systems or devices of FIG. 11 is shown, according to some implementations. The implementation shown in FIG. 12 can include response system 130, database 140, and/or third party devices 150. In some examples, the response system 130 can include the object system 1102, DCDSI system 1104, and dynamic mapping system 1106. The third party devices 150 can include one or more endpoints 1202a-1202n (e.g., third party DCDSIs). The implementation shown on FIG. 12 can also include an integrated result 1204. In some examples, the various components of FIG. 12 can communicate and/or be linked via a network (e.g., as described regarding FIGS. 1A and 7).

In some implementations, the response system 130 can integrate and map endpoint data for interfacing with the endpoints 1202a-1202n. For example, the DCDSI system 1104 can identify and catalog the endpoints 1202a-1202n and corresponding access information by analyzing the data provided by third party devices 150, data sources 160, etc. In some implementations, the object system 1102 can create an object package corresponding to at least one (e.g., each) identified endpoint 1202a-1202n, structuring the package based on the endpoint type (e.g., the endpoint 1202a corresponding to at least one of third party devices 150 including an insurer type, etc.). That is, the object package can include methods and/or data structures configured for interacting with the endpoint, such as predefined API request formats or templates, authentication tokens, and communication protocols corresponding to the endpoint. For example, the object package for an API endpoint can include JSON formatting rules, a package for a blockchain endpoint can incorporate data serialization methods and consensus verification steps, an object package for a vendor can include methods for purchasing a cyber resilience plan, and so on.

The dynamic mapping system 1106 can map the access information to an access scheme that aligns with the standards or other parameters corresponding to the endpoint. For example, mapping can include formatting various requests to determine that formatted requests are correctly configured for accessing the data (e.g., cybersecurity protection data) of the endpoint. That is, mapping can include linking or otherwise associated data and/or systems (e.g., matching the security protocols of the endpoint with the internal security policies of the organization to create an integration aligning with external and internal standards). Additionally, the dynamic mapping system 1106 can adapt the access scheme dynamically and adjust to changes in the requirements of the endpoint or the security posture of the organization.

Still referring to FIG. 12. In some implementations, in performing an endpoint request, the DCDSI system 1104 can invoke the object package generated by the object system 1102 to execute the request. That is, the DCDSI system 1104 can implement, execute, or otherwise trigger an API call using a formatted request that complies with the protocol of the endpoint for retrieving data and/or performing a call. Further, the DCDSI system 1104 can receive a response to the request from the endpoint as output data, which can be processed by the dynamic mapping system 1106 to generate the integrated result 1204. For example, the output data can be received as unstructured data and further transformed by the dynamic mapping system 1106 to correspond to formatting and/or other predefined requirements. That is, the integrated result 1204 can include a consolidated and/or processed outcome of the endpoint interactions (e.g., formatted response). In some examples, the dynamic mapping system 1106 can store the integrated resulted in a database or data store (e.g., database 140), or further transmit the integrated result 1204 to other systems within the cybersecurity framework of the organization. In some examples, the dynamic mapping system 1106 can also update a distributed ledger, such as blockchain 170, or other internal data sources based on the output data such that the cybersecurity posture of the organization is accurately reflected and/or stored in relevant systems and records. For example, after retrieving compliance data from an external API, the dynamic mapping system 1106 can record the results on a blockchain or internal system.

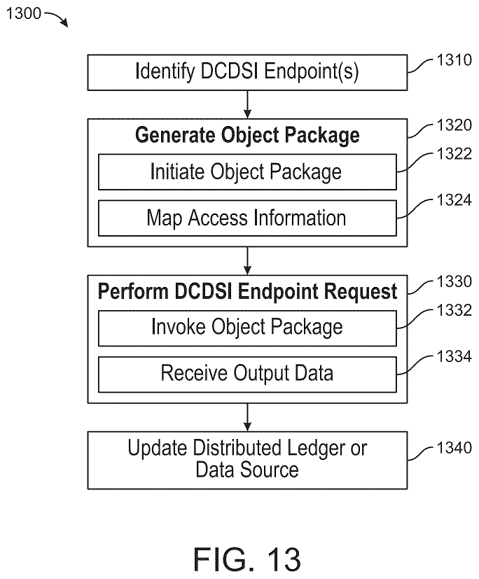

Referring now to FIG. 13, a flowchart for a method 1300 of modeling cyber resilience data using cyber resilience identities and associated metadata is shown, according to some implementations. One or more of the components described with respect to FIGS. 1A-1B or FIG. 11 can be used to perform the steps of method 1300. For example, the response system 130 of FIGS. 1A-1B or the analysis circuit 136 of FIG. 11 can perform one or more of the steps of the method 2600. Additional, fewer, or different operations can be performed depending on the particular implementation. In some implementations, some, or all operations of method 1300 can be performed by one or more processors executing on one or more computing devices, systems, or servers. In some implementations, at least one (e.g., each) operation can be re-ordered, added, removed, or repeated.

In a broad overview of method 1300, at block 1310, the one or more processing circuits (e.g., analysis circuit 136 of FIG. 11) can identify DCDSI endpoint(s). At block 1320, the one or more processing circuits can generate an object package. At block 1322, the one or more processing circuits can initiate the object package. At block 1324, the one or more processing circuits can map access information. At block 1330, the one or more processing circuits can perform a DCDSI endpoint request. At block 1332, the one or more processing circuits can invoke an object package. At block 1334, the one or more processing circuits can receive output data. At block 1340, the one or more processing circuits can update a distributed ledger or data source.

In some implementations, at block 1310, the one or more processing circuits (e.g., analysis circuit 136 of FIG. 11) can identify DCDSI endpoint(s). In some implementations, at block 1310, the one or more processing circuits can identify one or more decentralized compute and data store interface (DCDSI) endpoints and corresponding access information. For example, the analysis circuit 136 can access various data sources 160 to extract information about the DCDSI endpoints. This access information can include elements such as endpoint addresses, authentication credentials (e.g., API keys, OAuth tokens, cryptographic keys), request parameters (e.g., query parameters, HTTP headers), and/or response formats (e.g., JSON, XML). For example, an endpoint address can refer to locations (e.g., URLs or IP addresses) used to access decentralized services. Further, request parameters can include instructions for interacting with the endpoints (e.g., query parameters, HTTP headers). In another example, response formats can include the structure or type of data returned by the endpoints (e.g., JSON, XML). The analysis circuit 136 can also retrieve metadata associated with these endpoints, including data transfer protocols (e.g., REST) and security requirements (e.g., encryption standards, authentication methods).

Additionally, the analysis circuit 136 can analyze historical data to identify patterns in how endpoints have been accessed in the past, which can provide information to inform the integration of new or additional endpoints. For example, the analysis circuit 136 can prioritize frequently accessed endpoints or adjust the access information based on past connection issues. The processing circuits can also apply predictive models to anticipate access parameters for new or updated DCDSI endpoints by referencing similar, previously integrated endpoints. In another example, the analysis circuit 136 can dynamically update a catalog of endpoints as new DCDSI endpoints are added, or existing ones are modified. Moreover, the identified DCDSI endpoints can include a range of decentralized interfaces, such as APIs for cloud services, blockchain nodes, and/or smart contracts. For example, the analysis circuit 136 can identify an API endpoint linked to a cloud-based data storage service, a smart contract for processing insurance claims, or a blockchain node for verifying cybersecurity incident logs.

In some implementations, at block 1320, the one or more processing circuits can generate an object package. For example, the object package can be a structured data object configured to facilitate communication with one or more DCDSI endpoints. The object package can include methods and data structures specifically configured for interacting with decentralized interfaces, such as APIs, blockchain nodes, or smart contracts. The object package can be generated based on the identified DCDSI endpoints and corresponding access information, encapsulating the data for making endpoint requests, such as the address of the endpoint, authentication credentials (e.g., API keys, OAuth tokens), and/or predefined request formats. For example, the object package can include a set of methods for executing various endpoint calls, such as HTTP requests, and/or additional methods for managing session tokens, handling encryption and decryption of data, and/or parsing responses returned by the endpoint. Additionally, the object package can be adapted to or customized based on different types of endpoints (e.g., an insurer endpoint can correspond to a predefined object package with predefined methods or functions for interacting with insurers, a vendor endpoint can correspond to an object including methods for interacting with vendors, etc.). For example, if the DCDSI endpoint is an API, the object package can include methods for constructing API calls (e.g., GET, POST) and handling standard response formats like JSON or XML. If the endpoint is a blockchain node, the package can include methods for interacting with smart contracts, validating transaction signatures, or retrieving data stored on the blockchain.

In some implementations, in generating an object package at block 1320, the one or more processing circuits can initiate the object package at block 1322. In some implementations, at block 1322, the one or more processing circuits can initiate the object package based on an identifier corresponding to at least one DCDSI endpoint type. For example, the analysis circuit 136 can use the Object-Oriented Programming (OOP) concept of reflection to dynamically identify and instantiate the appropriate class corresponding to the endpoint type. Reflection can allow the analysis circuit 136 to examine metadata about the endpoint at runtime, determining the methods, attributes, and/or interfaces to include in the object package. For example, if the DCDSI endpoint corresponds to a third party insurer, the analysis circuit 136 can initiate an object package configured to handle insurance workflows, such as processing claims or retrieving policy data. The analysis circuit 136 can select the appropriate class definitions using reflection, ensuring that the object package includes the logic and data structures for these operations. In another example, for a customer management endpoint, the one or more processing circuits can initiate an object package that includes methods for accessing and updating customer records. The analysis circuit 136 can dynamically load the correct classes and/or interfaces configured to interact with the endpoint based on the endpoint type. In some implementations, the object package is structured according to the at least one DCDSI type. For example, the one or more processing circuits can organize the object package to include data serialization formats, communication protocols, and/or security mechanisms that align with the endpoint type, facilitating the use of the object package for endpoint calls.

In some implementations, in generating an object package at block 1320, the one or more processing circuits can map access information at block 1324. In some implementations, at block 1324, the one or more processing circuits can map access information to an access scheme corresponding to one or more formatted requests to access the one or more DCDSI endpoints. For example, the analysis circuit 136 can structure access information, such as API keys, authentication tokens, endpoint URLs, and/or request parameters, into a format aligned with the access scheme for the endpoints. That is, as access scheme can include various information for accessing an API endpoint and/or provide a format configured to be accepted by the API endpoint. For example, the analysis circuit 136 can actively map data used for an endpoint call to predefined fields within the access scheme, aligning at least one (e.g., each) formatted request with the protocol of the endpoint and security requirements such that the endpoint provides a valid response or output responsive to an endpoint request conforming to the access scheme. The access scheme can include an endpoint address, structure and/or formatting requirements corresponding to an endpoint, and so on. For example, the analysis circuit 136 can incorporate OAuth tokens and endpoint-specific parameters when configuring API calls to cloud services, structuring the requests to comply with the security policies of third party devices 150. Additionally, if the DCDSI endpoints include blockchain nodes, the analysis circuit 136 can map access information to include cryptographic signatures and/or consensus parameters for interacting with the blockchain. In some implementations, the one or more formatted requests correspond with requesting protection data. For example, the analysis circuit 136 can format API calls to retrieve cybersecurity-related data, such as threat intelligence reports, incident logs, or compliance checklists, structuring these requests to match the specifications of the endpoint and support secure data retrieval.

In some implementations, at block 1330, the one or more processing circuits can perform a DCDSI endpoint request. For example, the analysis circuit 136 can execute an API call to a cloud service provider to retrieve real-time cybersecurity threat intelligence. The API call can include formatted requests, such as GET or POST requests, structured with the authentication tokens and query parameters specific to the cloud service endpoint. In another example, the analysis circuit 136 can initiate a request to a blockchain node, where the request involves submitting a transaction to verify the integrity of recent cybersecurity-related events. Initiating can include invoking smart contracts on the blockchain that manage the validation of incident reports or the authentication of security audits. Additionally, the analysis circuit 136 can perform a DCDSI endpoint request to a third party security service, such as a Managed Security Service Provider (MSSP), to gather data on detected vulnerabilities or security patches. In performing the DCDSI endpoint request, the analysis circuit 136 can adapt the request formats (e.g., endpoint calls) to meet the requirements of at least one (e.g., each) endpoint such that the requests are properly authenticated and routed through secure channels. For instance, when interacting with a decentralized storage network, the analysis circuit 136 can include commands to retrieve encrypted cybersecurity data, such as encrypted log files or configuration backups, from distributed nodes or tokens, and then process the responses to decrypt and analyze the retrieved data.

In some implementations, in performing a DCDSI endpoint call at block 1330, the one or more processing circuits can invoke an object package at block 1332. In some implementations, at block 1332, the one or more processing circuits can use the object package to execute or perform the DCDSI endpoint request using at least one formatted request of the one or more formatted requests. For example, the analysis circuit 136 can invoke the object package by activating methods within the package that correspond to the type of endpoint being accessed. Invoking can include calling or executing a method configured to communicate with a cloud-based API, where the formatted request includes the headers, authentication tokens, and/or query parameters tailored to the protocol of the endpoint. In another example, the analysis circuit 136 can invoke the object package for a blockchain-based DCDSI endpoint, where the request can include executing a smart contract function to verify the status of a cyber resilience token. The object package can be structured to dynamically adjust its methods based on the endpoint type such that the analysis circuit 136 can handle various types of DCDSI endpoints without rewriting core request logic. Additionally, the object package can include routines to manage potential issues during the endpoint interaction, such as timeouts or invalid responses, and can trigger alternative methods or retries to complete the DCDSI endpoint request.

In some implementations, in performing a DCDSI endpoint call at block 1330, the one or more processing circuits can receive output data at block 1334. In some implementations, at block 1334, the one or more processing circuits can receive output data, specifically as a response to the DCDSI endpoint request by a DCDSI system. For example, the analysis circuit 136 can receive output data from an API endpoint in direct response to the request, such as a set of compliance metrics or security incident reports. The output data can be in a structured format, such as JSON or XML, which allows the analysis circuit 136 to parse and process the information for further use. In another example, the output data received from a blockchain-based DCDSI system can include transaction records or verification results related to cyber resilience tokens corresponding to the initiated request. The analysis circuit 136 can process this data to update internal records or to trigger additional actions based on the results (e.g., response) received from the endpoint.

In some implementations, at block 1340, the one or more processing circuits can update a distributed ledger or data source based on the output data. For example, the dynamic mapping system 1106 can record the received output data in a blockchain ledger (e.g., blockchain 170), facilitating secure, immutable, and/or verifiable data storage. In another example, the one or more processing circuits can update an internal data source, such as database 140, by appending the output data to existing records. In some examples, updating can include mapping the output data to fields within the database, such as cybersecurity metrics, incident logs, or compliance reports such that that the information is categorized appropriately for future use. Additionally, the one or more processing circuits can create associations between the newly recorded output data and pre-existing records, facilitating data analysis and access to related information.

In some implementations, the one or more processing circuits can further determine entity data of an entity based on at least one token stored on the distributed ledger or data source. For example, the analysis circuit 136 can access the distributed ledger (e.g., blockchain 170) to retrieve a token associated with the entity, such as a unique identifier or an encrypted data block. The analysis circuit 136 can decode or decrypt the token to extract the entity data, which can include data like entity credentials, cybersecurity posture, or other relevant data for the endpoint request. In some implementations, performing the DCDSI endpoint request further includes providing the entity data and the access information as input to the object package. For example, the object system 1102 can integrate the retrieved entity data with the access information, structuring them within the object package for precise communication with the DCDSI endpoint. The object system 1102 can prepare the object package to include entity-specific parameters, such as authentication credentials or request parameters associated with the entity, aligning the DCDSI endpoint request with the requirements of the entity.

In some implementations, the access information comprises a taxonomy including at least one endpoint address and one or more (i) authentication credentials, (ii) request parameters, or (iii) response formats corresponding to the one or more DCDSI endpoints. That is, the taxonomy can include a structure or classification system that organizes and categorizes elements for interacting with decentralized services, such as endpoint addresses, based on various parameters (e.g., authentication credentials, communication parameters, etc.). For example, the analysis circuit 136 can implement the taxonomy to identify and organize relevant data to facilitate communication with DCDSI endpoints. Additionally, the taxonomy can include categories for security protocols, data formats, or other classifications relevant to the interaction with the endpoints.

In some implementations, performing the DCDSI endpoint request further includes providing, by the one or more processing circuits, the one or more (i) authentication credentials, (ii) request parameters, or (iii) response formats as the input to the object package based on the taxonomy. That is, providing can include organizing various inputs according to a received taxonomy (e.g., based on an API specification, for example) such that endpoint calls or requests can be received and/or processed by an identified endpoint. For example, the analysis circuit 136 can extract and arrange the necessary credentials and parameters from the taxonomy to facilitate the request. In some implementations, performing the DCDSI endpoint request further includes invoking, by the one or more processing circuits, the object package to perform the DCDSI endpoint request to the endpoint address. That is, invoking can involve instantiating an object and/or executing methods included within or corresponding to the object such that the object causes the request to be transmitted to the appropriate endpoint and further processed for providing a response. For example, the analysis circuit 136 can execute a method within the object package corresponding to an API “GET” function of an endpoint to transmit a request according to the endpoint standards or other endpoint data included in the taxonomy.

In some implementations, in accessing the token, the one or more processing circuits can further establish a data communication link with the ledger. For example, the analysis circuit 136 can initiate a secure connection with a blockchain network or a database that serves as the ledger, utilizing encrypted communication protocols to protect the integrity of the transmitted data. In some implementations, the ledger includes a blockchain network or database. For example, the blockchain 170 can store tokens associated with various entities, where at least one (e.g., each) token can represent unique identifiers, security credentials, or other encrypted information relevant to the entity. In some implementations, the one or more processing circuits can transmit, via the data communication link, a query to the blockchain network or database to identify the token, and the query can include an identifier or address corresponding with the entity. For example, the analysis circuit 136 can formulate and transmit a query that specifies the unique identifier or blockchain address of the entity, directing the query to the appropriate node within the blockchain network. In some implementations, the one or more processing circuits can retrieve, via the data communication link, the token from the blockchain network or database using the identifier or address. For example, upon receiving a response from the blockchain network, the analysis circuit 136 can extract the token data, which can include encrypted information specific to the entity. In some implementations, the one or more processing circuits can verify the authenticity of the token. For example, the analysis circuit 136 can apply cryptographic techniques to validate the digital signature of the token or check its provenance against a stored ledger of trusted entities. The verification process helps to confirm that the token has not been tampered with and is legitimate. In some implementations, the one or more processing circuits can extract the entity data from the token. For example, the analysis circuit 136 can decrypt the token to reveal the underlying entity data, such as access credentials, compliance history, or other relevant information for the DCDSI endpoint request.

In some implementations, in identifying the one or more DCDSI endpoints and the access information, the one or more processing circuits can extract, using a machine learning model, the access information from at least one document or content corresponding with the one or more endpoints. For example, the analysis circuit 136 can employ various machine learning models, such as natural language processing (NLP) models, supervised learning models, or deep learning neural networks, to analyze and extract relevant endpoint data from diverse sources. These sources can include unstructured data from API documentation, technical manuals, configuration files, and/or log files from previous interactions with the endpoints. The models can be trained and implemented to identify access information, such as endpoint URLs, authentication credentials, API keys, request parameters, and/or response formats. For instance, an NLP model might process API documentation to recognize and extract structured access data, while a deep learning model could analyze historical data to detect patterns and predict optimal configurations for new endpoints. Additionally, a supervised learning model can be used to continuously improve the accuracy of access information extraction by learning from labeled data sets and refining its predictions over time, and the analysis circuit 136 can then map the extracted information to the appropriate DCDSI endpoints.

In some implementations, the one or more processing circuits can detect an update to the one or more DCDSI endpoints based on monitoring the at least one document or content using the machine learning model. For example, the analysis circuit 136 can utilize a combination of machine learning models, such as recurrent neural networks (RNNs) for time-series analysis, and/or anomaly detection algorithms to monitor API documentation, configuration files, or change logs for any alterations or updates to the endpoints. These models can identify changes in endpoint URLs, new authentication protocols, updated request parameters, or modifications in response formats. In some implementations, the one or more processing circuits can modify the access information based on the detected update. For example, upon detecting an update, the analysis circuit 136 can automatically adjust the relevant access data, such as updating the endpoint URL, revising authentication credentials, or altering the structure of API requests to match the new specifications. In some implementations, the one or more processing circuits can map the modified access information to the access scheme corresponding to the one or more formatted requests. For example, the dynamic mapping system 1106 can reconfigure the object package to incorporate the modified access information such that future DCDSI endpoint requests are aligned with the updated endpoint requirements. For example, mapping can include updating the formatted request templates, adjusting security protocols, and/or verifying that the modified access scheme maintains compatibility with the new configuration of the endpoint.

In some implementations, in generating the object package, the one or more processing circuits can receive an object data structure including operations for communicating with and exchanging data with the one or more DCDSI endpoints based on the type. For example, the analysis circuit 136 can apply object-oriented programming (OOP) principles, such as reflection, to dynamically generate an object data structure tailored to the type of DCDSI endpoint. The object data structure can include predefined methods for API calls, data exchange protocols, and/or error handling routines that align with the requirements of the endpoint. By utilizing reflection, the analysis circuit 136 can identify and incorporate the appropriate classes, methods, and/or properties for interacting with different types of endpoints, allowing the object package to adjust its behavior based on the DCDSI endpoint (e.g., cloud-based APIs, blockchain nodes, smart contracts). In some implementations, in generating the object package, the one or more processing circuits can modify a state of the object data structure to cause the object data structure to perform the DCDSI endpoint request based on the access information. For example, the analysis circuit 136 can manage the state of the object data structure by tracking the current status of the DCDSI endpoint request, such as whether the request has been initiated, is in progress, or has been completed. The state can include data fields that store the current parameters of the endpoint, authentication status, or any intermediate data used for the request. By actively modifying the state, the analysis circuit 136 can trigger actions within the object data structure, such as sending an API request, adjusting request parameters based on real-time data, or handling a response from the endpoint.

In some implementations, in updating the distributed ledger or data source, the one or more processing circuits can map the output data to an output information scheme corresponding to one or more outputs from accessing the one or more DCDSI endpoints. For example, the analysis circuit 136 can map the output data to an output information scheme that organizes and categorizes the data based on predefined formats, making the data compatible with the structure of the distributed ledger or internal data source. In some examples, mapping can include translating raw data into structured formats, such as converting JSON responses from an API into a tabular format suitable for blockchain storage or database entries. The integrated result 1204 can be generated as part of a mapping process, consolidating and aligning the data with the output information scheme to provide a record of the interactions with the DCDSI endpoints. Additionally, the analysis circuit 136 can manage various types of output data, such as transaction records, audit logs, compliance reports, or other cybersecurity-related information, and/or map these outputs to the appropriate sections of the ledger or data source, facilitating efficient data retrieval and analysis in future operations.

In some implementations, the one or more DCDSI endpoints include one or more application programming interfaces (APIs). For example, the DCDSI endpoints can encompass APIs that interact with various third party services, such as cloud storage providers, financial transaction systems, or cybersecurity monitoring tools. These APIs can serve as interfaces for retrieving data, executing transactions, or interacting with decentralized compute and data storage systems. In some implementations, the access scheme includes one or more rules. For example, the access scheme can include a set of predefined conditions or parameters, such as authentication requirements, access permissions, or data format specifications, that govern how the DCDSI endpoints are accessed. In some implementations, the one or more processing circuits can validate the access information against at least one of the one or more rules to determine compatibility with the access scheme either (i) before performance of a data retrieval corresponding to the DCDSI endpoint request or (ii) after performance of the data retrieval. For example, before executing the DCDSI endpoint request, the analysis circuit 136 can compare the provided access credentials and parameters with the access rules to verify that the request complies with the security of the endpoint and access protocols of the endpoint. For example, validating can include checking for valid API keys, ensuring that the request is properly formatted, and verifying that the user has the permissions to access the requested data. In another example, after performing the data retrieval, the analysis circuit 136 can validate the retrieved data against post-retrieval rules, such as verifying that the data meets integrity checks and confirming that the data format aligns with the expected schema.

### Mapping Interfaces

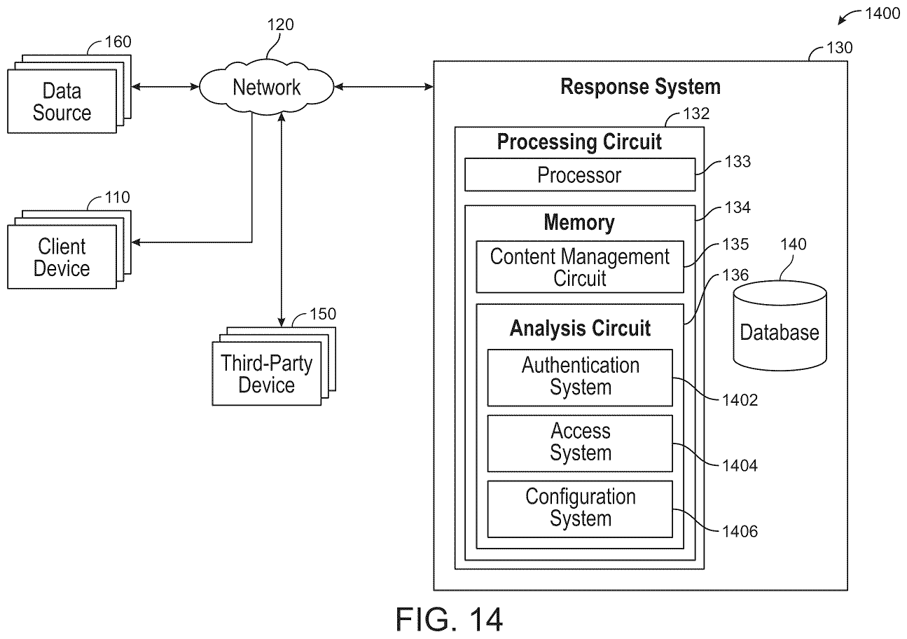

Referring now to FIG. 14, a block diagram of a system 1400 for mapping interfaces is shown, according to some implementations. In some implementations, the system 1400 includes a client device 110 (also referred to herein as “client devices 110” and/or “user computing system(s) 110”), response system 130, third party device 150 (also referred to herein as “third party system(s) 150” and/or “third party devices 150”), and data sources 160. The various components of FIG. 14 can be interconnected through a network 120 that supports secure communications profiles (e.g., TLS, SSL, HTTPS, etc.). In some implementations, the elements shown in FIG. 14 can incorporate similar features and functionality as described regarding the elements shown on FIG. 1A, FIG. 1B, FIG. 7, and/or FIG. 11. For example, the response system 130, as shown in FIG. 14, can incorporate similar functionality as described regarding the response system 130 of FIG. 1A, FIG. 1B, and/or FIG. 11, and the database 140, can incorporate the same and/or similar functionality as described regarding the database 140 of FIG. 1A and/or FIG. 11, and so on. Specifically, like callout references of FIG. 1A, FIG. 1B, and/or FIG. 11 are now further described, however the features and functionalities of components like the response system 130 in FIG. 14 still correspond to those referred to with the same callout reference in FIG. 1A, FIG. 1B, and/or FIG. 11. In some implementations, response system 130 described in FIG. 14 can include functionality and/or features related to mapping interfaces. Systems and/or devices shown in FIG. 14 can be modified, added, removed, and/or otherwise adjusted in various implementations.

In some implementations, the client device 110 can include an application 112 and an input/output circuit 118. The application 112 can include a library 114, and the library 114 can include an interface circuit 116. In some implementations, the response system 130 can include a processing circuit 132 and a database 140. The processing circuit 132 can include a processor 133 and memory 134. The memory 134 can further include a content management circuit 135 and an analysis circuit 136. In some implementations, the analysis circuit 136 can include an authentication system 1402, an access system 1404, and a configuration system 1406, as further described herein.

In some implementations, the systems and devices of FIG. 14 (e.g., client device 110, response system 130, third party device 150, data sources 160, authentication system 1402, access system 1404, configuration system 1406, etc.) can include one or more processors, memories, network interfaces (sometimes referred to herein as a “network circuit”) and user interfaces. For example, the client device 110, response system 130, third party device 150, data sources 160, authentication system 1402, access system 1404, and configuration system 1406 can include one or more logic devices, which can be one or more computing devices equipped with one or more processing circuits that run instructions stored in a memory device to perform various operations. The processing circuit can be made up of various components such as a microprocessor, an ASIC, or an FPGA, and the memory device can be any type of storage or transmission device capable of providing program instructions. The instructions can include code from various programming languages commonly used in the industry, such as high-level programming languages, web development languages, and systems programming languages.

In some implementations, the memory (e.g., memory 134) can store programming logic (e.g., content management circuit 135) that, when executed by the processor, controls the operation of the corresponding computing system or device. The memory can also store data in databases. For example, memory can store programming logic that when executed by a processor within a processing circuit, causes a database to update parameters and/or store a system event log. The network interfaces can allow the computing systems and devices to communicate wirelessly or otherwise. The various components of devices in system 100 can be implemented via hardware (e.g., circuitry), software (e.g., executable code), or any combination thereof. Devices, systems, and components in FIG. 14 can be added, deleted, integrated, separated, and/or rearranged in various implementations of the disclosure. In some implementations, the client device 110, response system 130, third party device 150, data sources 160, authentication system 1402, access system 1404, and configuration system 1406 can include one or more databases for storing data that receive and provide data to other systems and devices on the network 120. In some implementations, one or more elements of FIG. 14 can be communicably coupled (connected) to a distributed ledger (e.g., blockchain 170 of FIG. 1B) and/or other authoritative data source to provide data integrity and security.

In some implementations, the client device 110 can include any electronic device or computing system configured to execute software applications and/or facilitate interactions with components of the system 1400. For example, the client device 110 can include various devices including smartphones, tablets, laptops, desktop computers, and/or other computing platforms. In some implementations, the client device 110 can be configured to generate, format, and/or transmit requests and/or data to other systems or devices over the network 120. In some implementations, the client device can include an application and/or library, which can include various data, information, and/or instructions used by the client device 110 (e.g., configured routines, communication protocols, encryption mechanisms, and/or data formatting rules). In some implementations, the client device 110 can include an input/output circuit configured to receive inputs, provide outputs, and/pr perform data exchanges with one or more components of the system 1400 (e.g., response system 130 or third party devices 150). In some implementations, the client device 110 can include interface circuit configured to generate one or more user interfaces (e.g., graphical user interfaces) and present the user interface(s) via a display of the client device 110.

In some implementations, the database 140 can include any data storage system or repository configured to store, manage, and/or provide access to data associated with the system 1400. For example, the database 140 can include relational databases, non-relational databases, object-oriented databases, graph databases, and/or distributed ledger systems. In some implementations, the database 140 can store various data and/or data structures related to mapping decentralized compute and data store interface (DCDSI) endpoints (e.g., one or more formatted requests, access schemes for endpoints, etc.). For example, the database 140 can include operational data (e.g., session logs, transaction records, and/or access parameters), configuration data (e.g., formatted request(s), access schemes, integration mappings, communication protocols, and/or authentication schemes), security data (e.g., encryption keys, token credentials, and/or private identifiers), metadata (e.g., endpoint-specific attributes, request headers, and/or formatting rules), performance data (e.g., response times, error rates, and/or usage statistics), analytics data (e.g., trend analyses, predictive models, and/or behavioral insights), historical data (e.g., archived communications, previous integration configurations, and/or legacy system parameters), compliance data (e.g., audit trails, regulatory adherence records, and/or role-based access control data), infrastructure data (e.g., server allocations, network topology configurations, and/or load-balancing parameters), and/or user interaction data (e.g., activity logs, user preferences, and/or interface event streams). In some implementations, the database 140 can provide one or more stored data objects or structures responsive to a request or query transmitted by one or more systems and/or components of the system 1400.

In some implementations, the third party devices 150 can include one or more computing systems or devices providing and/or corresponding with one or more integrations. For example, the third party devices 150 can include various devices or services configured to process DCDSI endpoint requests and/or transmit responses to the one or more DCDSI endpoint requests. That is, the third party devices 150 can include one or more computing systems or servers (e.g., desktop computers, mobile devices, application servers and/or database servers), cloud-based or scalable services (e.g., Infrastructure as a Service (IaaS), Platform as a Service (PaaS), etc.), virtual machines (e.g., virtualized environments for running applications), databases (e.g., relational databases, ledgers, and/or distributed database), and/or other hardware, resources, and/or data configured to provide access to and/or perform various operations using one or more integrations, as further described herein.

In some implementations, the data sources 160 can include any internal and/or external data sources, services, and/or systems configured to provide data and/or information for mapping interfaces (e.g., DCDSI endpoints). For example, the data sources 160 can include internal and/or external data streams, API feeds, databases, repositories, and/or other systems or services that transmit information to one or more systems or components of FIG. 14 (e.g., response system 130). For example, the data sources 160 can provide access information and/or access schemes (e.g., API specifications) associated with an integration provided via one or more third party devices 150 to the response system 130, and the response system 130 can process the received information to establish a communication channel with the integration, as further described herein.

In some implementations, the response system 130 can perform and/or execute various processes and/or functions for mapping interfaces. In some implementations, the response system 130 can include various systems and/or subsystems (e.g., analysis circuit 136, authentication system 1402, access system 1404, configuration system 1406, etc.) and can cause the various systems and/or subsystems to perform and/or execute various processes and/or functions for mapping interfaces. In some implementations, the analysis circuit 136 can receive a request corresponding with at least one decentralized compute and data store interface (DCDSI) endpoint of an integration. For example, the authentication system 1402 of the analysis circuit 136 can receive a message, notification, and/or other signal (e.g., integration request) from client device 110 and/or third party devices 150 corresponding with one or more integrations. In some examples, the request or signal can include one or more parameters or associated metadata, such as access constraints (e.g., role-based access permissions, token validity periods) and/or configuration details (e.g., communication protocols, supported data formats) associated with one or more integrations. An integration can include or refer to any application (e.g., software applications, mobile apps, web-based platforms), system (e.g., distributed systems, enterprise environments, cloud-based infrastructures), or process (e.g., automated workflows, data synchronization routines, distributed task orchestration) configured to perform one or more functions by interacting with one or more associated DCDSI endpoints. That is, the analysis circuit 136 and/or authentication system 1402 can process an integration request to identify DCDSI endpoints associated with the integration, validate access parameters, and extract configuration metadata to configure the integration within an integration environment (e.g., API gateway). In some implementations, the request can include an automated request transmitted by and/or on behalf of an integration (e.g., initiated by a software application, system, and/or process) to facilitate another system or device interacting with the DCDSI endpoint (e.g., responsive to purchase of a protection plan that includes providing endpoint services).

In some implementations, the request can include and/or refer to at least a public identifier and a private identifier. For example, a public identifier can include and/or refer to a client identifier, such as a unique string (e.g., globally unique identifier, UUID), application ID (e.g., app-specific client identifier), or resource locator (e.g., API endpoint URL) associated with an integration. That is, the public identifier can identify a DCDSI endpoint of an integration targeted by the request, and the analysis circuit 136 and/or authentication system 1402 can use the public identifier to identify data associated with configuring the integration (e.g., endpoint metadata, communication parameters) in the integration environment. For example, the public identifier can include an account ID (e.g., user identifier, organization identifier), application identifier and/or name (e.g., “ResponseServiceAPI.” “ClaimsInterface”), and/or other data. The public identifier can be used by the analysis circuit 136 to map the DCDSI endpoint to specific integration information (e.g., access parameters, scopes, communication settings) associated with the integration. In some implementations, the public identifier provides a reference to the DCDSI endpoint while minimizing exposure of sensitive information during the integration process.

In implementations, the private identifier can include and/or refer to a client secret, such as a cryptographic key (e.g., pre-shared key, symmetric key), access token (e.g., OAuth token), and/or dynamically generated credential (e.g., time-limited session token). For example, a private identifier can authenticate the request by verifying that the request originates from an authorized system or device associated with the integration. In some examples, the public identifier can be publicly shared and/or accessible to various systems, devices, and/or entities associated with an integration environment (e.g., client devices 110, third party devices 150, and/or other systems interacting with the DCDSI endpoint for routing and/or reference purposes). In some examples, the private identifier can be confidential and/or isolated to secure systems (e.g., the client device 110, analysis circuit 136, authentication system 1402, and the one or more integrations) associated with verifying a request and can be used to restrict access to the DCDSI endpoint to authorized entities. In some implementations, the analysis circuit 136 and/or authentication system 1402 can receive and/or analyze the public identifier and private identifier to process the integration request, identify one or more DCDSI endpoints associated with the integration, and retrieve data for configuring the integration environment, as further described herein.

In some implementations, the analysis circuit 136 can authenticate and/or otherwise provide access to the integration using at least one of the public identifier or the private identifier. That is, the analysis circuit 136 and/or authentication system 1402 can use the public identifier to confirm that the request targets a recognized DCDSI endpoint associated with the integration. For example, the analysis circuit 136 can access database 140, which can include mappings of public identifiers to DCDSI endpoints and corresponding integrations, and the analysis circuit 136 can compare the public identifier in the request to entries in database 140 to determine an address for routing a request and/or other communications to an authorized endpoint associated with the integration. In some examples, the analysis circuit 136, authentication system 1402, and/or one or more integrations can use the private identifier to verify an authenticity of the request. For example, the authentication system 1402 and/or an integration can generate and/or otherwise issue a private identifier (e.g., client secret) during a registration or setup and securely share the private identifier with trusted or secure systems or applications, the systems or applications (e.g., client device 110, etc.) can include the private identifier in the integration request or formatted requests, and the integration or endpoint can identify and compare the private identifier to stored values to determine the request originates from a trusted source. That is, the authentication system 1402 can verify the integration request by comparing an included private identifier to a stored credential or derived value (e.g., a hashed version of the client secret in database 140) and determining that the request is secure (e.g., corresponds to an authorized source based on having access to the securely shared private identifier). That is, the public identifier can identify the DCDSI endpoint and associate the request with an appropriate integration, and the private identifier can validate that the request originates from an authorized source.

In some implementations, the access system 1404 of the analysis circuit 136 can determine and/or otherwise identify an access scheme of the at least one DCDSI endpoint based at least on the request. In some examples, an access scheme can include and/or refer to any configuration, structure, and/or set of rules (e.g., data formats, communication protocols, authentication methods, and/or permission hierarchies) used to facilitate interaction with a DCDSI endpoint of an integration. That is, the access scheme can define a sequence of operations, request structure (e.g., header style, format, etc.), fields and/or parameters (e.g., authentication tokens, encryption keys, data formats, session identifiers), communication protocols (e.g., HTTPS, gRPC, WebSocket), and/or procedural rules (e.g., handshake sequences, rate limits, timeout thresholds) that govern interpretation, initiation, maintenance, and/or termination of communications with the DCDSI endpoint. In some examples, the analysis circuit 136 and/or access system 1404 can analyze the request to determine and/or identify an access scheme. For example, the request can include parameters and/or metadata, such as access constraints (e.g., role-based permissions, token validity periods) and/or configuration details (e.g., supported communication protocols, endpoint-specific requirements) used for accessing an integration. In some examples, the database 140 can store access schemes and/or associated information, and the analysis circuit 136 and/or access system 1404 can retrieve information from database 140 to identify configuration values (e.g., protocol types, endpoint-specific fields, authentication parameters, and/or connection timeouts) corresponding with DCDSI endpoints.

In some implementations, the access scheme corresponds with one or more formatted requests for the at least one DCDSI endpoint. That is, the access scheme can define a structure (e.g., data formatting rules, header configurations, and/or field organization) and/or content (e.g., authentication tokens, request parameters, and/or metadata) of requests such that the DCDSI endpoint appropriately recognizes and responds to the request. For example, the formatted requests can include template requests with predefined data structures, authentication credentials, and/or protocol-specific commands that are modified and/or adjusted by the configuration system 1406 and used to initiate communication with the DCDSI endpoint based on the access scheme. In some implementations, at least one formatted request of the one or more formatted requests corresponds with establishing a communication channel with the integration via the at least one DCDSI endpoint. That is, the analysis circuit 136 can use the access scheme to generate a formatted or validated request that includes credentials, parameters, and/or instructions to establish a secure and authorized communication channel for exchanging data (e.g., transmitting requests and receiving responses) via the integration. For example, the formatted request can include fields or parameters such as an authentication token and/or other data derived from the private identifier, endpoint-specific configuration parameters (e.g., encryption protocols, data payload schemas), and/or connection settings (e.g., timeout intervals, protocol negotiation steps) used to initiate and maintain a communication channel with the integration.

In some implementations, the analysis circuit 136 and/or configuration system 1406 can generate and/or otherwise provide one or more configurations of an object package corresponding with the at least one formatted request. That is, the analysis circuit 136 or configuration system 1406 can generate an object package to facilitate the automated management and execution of formatted requests associated with the DCDSI endpoint. For example, the object package can include execution logic configured to transmit formatted requests, operational parameters for managing communications (e.g., retry intervals, sequencing rules), and/or embedded security parameters (e.g., session tokens, encryption keys) associated with the integration. In some examples, the object package can include instructions and/or metadata that govern the interaction between the formatted requests and the DCDSI endpoint, such as message ordering, communication timing, and/or endpoint-specific configurations. In some implementations, the object package is structured based on at least the access scheme. That is, the structure of the object package can include and/or correspond with one or more executable functions or template requests (e.g., formatted requests), hierarchical data structures (e.g., layered configurations for authentication and operations), operational parameters (e.g., communication protocols, rate limits), and/or execution rules (e.g., sequencing instructions, error-handling logic) associated with the DCDSI endpoint or integration. For example, the analysis circuit 136 and/or configuration system 1406 can construct and/or generate an object package that can organize communication parameters (e.g., protocol-specific settings, encryption requirements) and execution logic (e.g., request sequencing, error handling) into a structured framework configured to automate the generation, validation, and transmission of formatted requests.

In some implementations, the analysis circuit 136 can invoke the object package to establish the communication channel with the integration by executing a DCDSI endpoint request to the at least one DCDSI endpoint using the at least one formatted request. For example, the analysis circuit 136 and/or configuration system 1406 can identify and/or utilize configurations within the object package, such as authentication parameters (e.g., session tokens, cryptographic keys) and communication logic (e.g., protocol-specific commands, sequencing rules), to generate and transmit a validated request to the DCDSI endpoint. For example, the at least one formatted request or DCDSI endpoint request can include the private identifier (e.g., client secret) used by the analysis circuit 136, the integration, and/or the endpoint to authenticate access to the integration or endpoint. In some examples, the analysis circuit 136 and/or configuration system 1405 can execute logic within the object package to send and/or transmit a formatted request to one or more DCDSI endpoints that includes endpoint-based instructions (e.g., connection initialization, token verification) and operational parameters (e.g., protocol commands, session metadata) used to establish a communication channel. That is, a communication channel can include and/or refer to a link or connection between the DCDSI endpoint of the integration and the analysis circuit 136 that facilitates the exchange of data over a network (e.g., network 120). For example, the communication channel can support operations such as transmitting requests to one or more DCDSI endpoints, receiving responses and/or endpoint outputs, and/or synchronizing data between the analysis circuit 136 and the endpoint or integration using various protocols (e.g., HTTP, HTTPS, WebSocket) or techniques (e.g., encryption, token-based authentication, etc.).

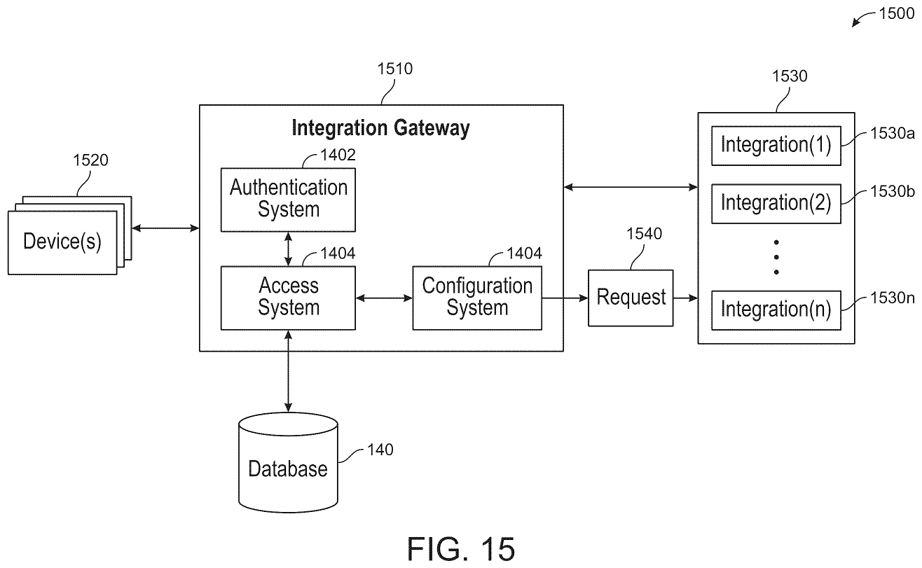

FIG. 15 depicts a block diagram of an implementation of a system 1500 for mapping interfaces, according to some implementations. In some implementations, the system 1500 can include integration gateway 1510, device(s) 1520, integrations 1530a-1530n (collectively, integrations 1530), database 140, and formatted request(s) 1540. In some implementations, the integration gateway can include the authentication system 1402, access system 1404, and configuration system 1406. In some implementations, the integration gateway 1510 can include the same and/or similar features and/or functionality as described regarding the analysis circuit 136 of FIG. 14. In some implementations, the device(s) 1520 can include the same and/or similar features and/or functionality as described regarding the client devices 110 and/or third party devices 150 of FIG. 14. The systems and devices shown in FIG. 15 can be modified, added, removed, and/or otherwise adjusted in various implementations.

In some implementations, the integration gateway 1510 can include and/or refer to any system, interface, application, or service configured to facilitate the automated management of software integrations by coordinating communication and configuration tasks associated with one or more DCDSI endpoints of one or more integrations 1530. That is, the integration gateway 1510 can intermediate and/or otherwise interface between device(s) 1520 and integrations 1530 by handling requests, enforcing access controls, and managing operational parameters used for endpoint calls. In some examples, the integration gateway 1510 can establish a communication channel between device(s) 1520, the integrations 1530, and the integration gateway 1510. For example, the integration gateway 1510 can authenticate incoming requests from device(s) 1520, apply predefined access schemes configured for one or more endpoints, and transmit formatted request(s) 1540 to one or more DCDSI endpoints of integrations 1530, as further described herein.

In some implementations, the integration gateway 1510 can receive data from device(s) 1520 or integrations 1530. For example, the integration gateway 1510 can receive a request from an entity computing system and/or third party computing system to configure an integration 1530 for subsequent interactions and/or communications with integration gateway 1510. For example, the device(s) 1520 can transmit an integration request to the integration gateway 1510 to configure one or more endpoints to exchange protection data (e.g., cyber resilience metrics, performance logs, entity asserts and/or safeguards, threat intelligence updates, etc.), automate security tasks (e.g., monitoring entity networks, performing vulnerability scans, integrating a safeguard, reconfiguring security tools, etc.), process and/or manage claims (e.g., determining catastrophic incidents, initiating incident analysis workflows, validating submitted evidence and/or claims, retrieving forensic data and/or claims data, etc.), synchronize operational parameters (e.g., updating encryption protocols, managing access control templates, distributing session timeout policies across connected systems), and so on. For example, an entity computing system can send a request to configure endpoints to monitor compliance across a networking infrastructure to facilitate adherence to regulatory and/or organizational security standards, activate threat response mechanisms triggered by security incidents to automate mitigation processes and reduce response times, and/or deploy automated safeguards to proactively address identified vulnerabilities and protect entity computing or networking systems. In some examples, a third party computing system (e.g., vendor, insurer, protection provider, etc.) can transmit a request to configure one or more endpoints to share data with entity networks, audit and/or monitor entity computing environments, verify compliance with security protocols, process claims, provide protections and/or safeguards, and/or synchronize security policies and/or other data.

In some implementations, the integration gateway 1510 can authenticate a request using the authentication system 1402 and integrations 1530, determine an access scheme using the access system 1404, and generate one or more configurations of an object package using the configuration system 1406 to execute formatted request(s) 1540. For example, device(s) 1520 can transmit an integration request to configure integration 1530a. Integration 1530a can include an automated monitoring application with one or more decentralized compute and data store interface (DCDSI) endpoints used for cybersecurity operations. For example, device(s) 1520 can transmit the integration request to configure endpoints of the integration 1530a for cybersecurity operations such as aggregating telemetry data, scanning systems for vulnerabilities, retrieving compliance metrics, and/or initiating automated remediation workflows. In some implementations, the authentication system 1402 of the integration gateway 1510 can process authentication parameters included in the integration request. For example, the authentication system 1402 can route an integration request to one or more endpoints of integrations 1530 by using the client identifier to query database 140 and retrieve a DCDSI endpoint address corresponding with the client identifier. For example, the integrations 1530 can compare a client secret provided via the integration request (e.g., provided to integrations 1530 during transmission of the formatted request(s) 1540) to stored or derived credentials (e.g., hashed credentials) to verify that the integration request corresponds to an authorized source (e.g., an authorized client device, an authorized third party device, etc.).

In some implementations, the access system 1404 of the integration gateway 1510 can determine an access scheme based on the integration request. For example, the access system 1404 can analyze the integration request to identify access parameters such as token policies, role-based permissions, communication protocols (e.g., HTTPS. WebSocket), and/or session configurations used to establish communications with integration 1530. For example, the integration gateway 1510 and/or access system 1404 can parse and/or retrieve data stored in database 140) and/or query endpoints or other data sources endpoint to retrieve an access scheme corresponding with a target endpoint of an integration (e.g., using automated or self-executing requests). In some implementations, the configuration system 1406 of the integration gateway 1510 can generate an object package based on the access scheme. For example, the configuration system 1406 can create a data structure or package that includes and/or is configured to execute formatted request(s) 1540. In some examples, the formatted request(s) 1540 can include fields and/or parameters (e.g., session timeout intervals, encryption protocols, instructions for initiating scans, identifiers for retrieving cyber data, etc.) that correspond to the access scheme used to define communicate protocols with the integration 1530a. In some examples, the integration gateway 1510 can transmit the formatted request(s) 1540 to one or more endpoints of integration 1530a by executing the object package including formatted request(s) 1540.

In some implementations, the integration 1530a can process the formatted request(s) 1540 received from the integration gateway 1510 to configure one or more decentralized compute and data store interface (DCDSI) endpoints for cybersecurity operations. For example, integration 1530a can parse received fields or parameters (e.g., authentication tokens, communication protocols, session configurations, etc.) of the formatted request(s) 1540 to establish permissions, scopes, mappings and/or data associations, and/or other settings used for communication with the integration 1530a. In some implementations, integration 1530a can transmit a response to the integration gateway 1510 indicating the status of the endpoint configuration. For example, integration 1530a can transmit a success response confirming the applied settings (e.g., active session policies, registered cryptographic credentials, validated access roles) and/or an error response detailing issues encountered during the configuration process (e.g., invalid parameters, rejected authentication tokens, unsupported protocols). In some examples, the integration gateway 1510 and/or device(s) 1520 can transmit commands or operational instructions to the configured endpoint of integration 1530a for various purposes. For example, the integration gateway 1510 can initiate cybersecurity operations by sending formatted request(s) 1540 to perform tasks such as retrieving cyber resilience metrics, executing vulnerability scans, synchronizing updated threat intelligence, and/or logging incident response actions. For example, formatted request(s) 1540 can include a first formatted request configured to establish and validate a communication channel with the endpoint of integration 1530a. Additionally, a second formatted request can initiate data retrieval operations, such as pulling cyber resilience metrics or threat intelligence updates, while a third formatted request can cause the endpoint to execute tasks, such as triggering vulnerability scans and/or logging security events. In some implementations, formatted request(s) 1540 can be structured to combine a channel establishment request with operational instructions for performing tasks into a single request.

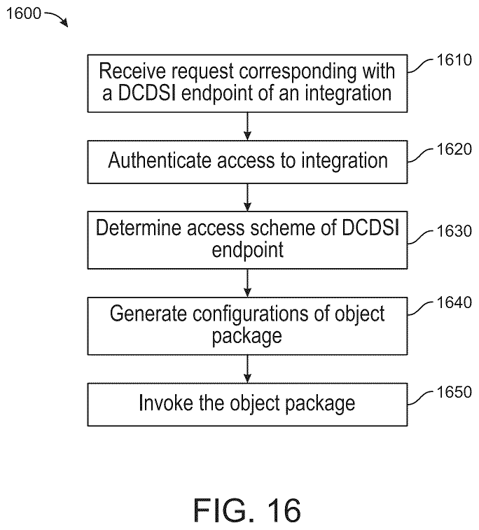

Referring now to FIG. 16, a flowchart for a method 1600 for mapping interfaces is shown, according to some implementations. In some implementations one or more of the systems, devices, or components described with respect to FIG. 1A, FIG. 1B, FIG. 11, FIG. 14, or FIG. 15 can be used to perform the steps of method 1300. For example, the analysis circuit 136 of FIG. 14 and/or the integration gateway 1510 of FIG. 15 can perform one or more of the steps of the method 1600. Additional, fewer, or different operations can be performed depending on the particular implementation. In some implementations, some, or all operations of method 1600 can be performed by one or more processors executing on one or more computing devices, systems, and/or servers. In some implementations, each operation can be re-ordered, added, removed, and/or repeated.

In a broad overview of method 1600, at block 1610, the one or more processing circuits (e.g., analysis circuit 136 of FIG. 14, integration gateway 1510 of FIG. 15, etc.) can receive a request corresponding with a DCDSI endpoint of an integration. At block 1620, the one or more processing circuits can authenticate access to the integration. At block 1630, the one or more processing circuits can determine an access scheme of the DCDSI endpoint. At block 1640, the one or more processing circuits can generate configurations of an object package. At block 1650, the one or more processing circuits can invoke the object package.

In some implementations, at block 1610, the one or more processing circuits (e.g., analysis circuit 136 of FIG. 11) can receive and/or otherwise identify a request corresponding with at least one decentralized compute and data store interface (DCDSI) endpoint of an integration. That is, the request can include a targeted endpoint (e.g., API, distributed node, interface, microservice, etc.), and the one or more processing circuits can receive the request from a client device associated with an entity, a third party computing system (e.g., vendor, service provider), and/or an integration. For example, a client device can transmit and/or issue a request to configure one or more DCDSI endpoints to automate cybersecurity tasks, synchronize operational parameters, or exchange cyber resilience data in response to the deployment of a new security protocol, the detection of anomalous activity, the purchase of a protection plan, and/or any other operation and/or condition. For example, a third party computing system can transmit a request to set up shared endpoints for collaborative threat intelligence, validate security compliance, and/or initiate vulnerability scans across interconnected systems in response to a contractual obligation to share security metrics, a scheduled audit, and/or a service-level agreement to maintain threat visibility. In some examples, an integration can generate a request to establish endpoints for continuous monitoring, real-time data synchronization, and/or automated incident response workflows in response to predefined operational triggers, periodic security updates, and/or system events prompting dynamic reconfiguration. In some implementations, the request includes at least a public identifier and a private identifier. For example, the public identifier can include a client identifier, API address, endpoint ID, and/or other value associated with a software application that defines scopes and/or permissions of the integration, and the private identifier can include a client secret, ID, cryptographic data, or other values used to establish trust between the requesting system (e.g., client device 110, third party devices 150, etc.) and the integration gateway 1510.

In some implementations, at block 1620, the one or more processing circuits can authenticate and/or otherwise provide access to the integration. In some implementations, the one or more processing circuits can authenticate access to the integration using at least one of the public identifier or the private identifier. That is, the one or more processing circuits can authenticate access to the integration by transmitting minimal credentials (e.g., at least one of the client identifier or the client secret) to a DCDSI endpoint and/or integration. For example, the analysis circuit 136 or integration gateway 1510 can process the public identifier to confirm the targeted endpoint, and the integration or endpoint can use the private identifier to verify that the request originates from an authorized source associated with the integration (e.g., verifying that the identifier was previously shared with the requesting system). In some implementations, confirming the targeted endpoint can include the one or more processing circuits comparing the client identifier to a registry of authorized endpoints and/or a stored mapping to verify the request is directed to a correct computing system, application, interface, node, and/or service. In some implementations, verifying that the request originates from an authorized source can include the one or more processing circuits matching the client secret to a securely stored cryptographic value or identifier (e.g., ID shared between an integration and gateway, such as a hash and/or a session-related token), to confirm the authenticity of the request and/or requesting device or system. For example, the analysis circuit 136 and/or integration gateway 1510 can match an application ID and/or user account number against a database entry to confirm the ID and/or number corresponds to a valid integration endpoint, and the integration or endpoint can compare an OAuth token or pre-shared key to a stored hash value to confirm the requests originates from a secure system, application, endpoint, and/or service.

In some implementations, at block 1630, the one or more processing circuits can determine and/or otherwise identify an access scheme of the DCDSI endpoint. In some implementations, the one or more processing circuits can determine an access scheme of the at least one DCDSI endpoint based at least on the request. That is, the one or more processing circuits can parse metadata and/or fields in the request to identify parameters such as role-based permissions, token policies, and/or protocol references for the DCDSI endpoint. For example, the analysis circuit 136 and/or integration gateway 1510 can retrieve mapping data from database 140 to associate a targeted endpoint with a set of communication rules, permission levels, and/or authentication flows. In some examples, the request can include instructions indicating use of a communication protocol (e.g., HTTPS, WebSocket), an authentication method (e.g., token-based access, cryptographic keys), and/or a set of operational parameters (e.g., session lifespans, rate constraints) that define interactions and/or communications with the DCDSI endpoint. In some examples, the determined access scheme can define and/or otherwise include a structured request format (e.g., headers, body, payload layout, etc.) used for initiating and transmitting endpoint requests.

In some implementations, the access scheme corresponds with one or more formatted requests for the at least one DCDSI endpoint. That is, the one or more processing circuits can generate template requests that include or define structures, fields, and/or parameters used to call or query the DCDSI endpoint. For example, the formatted requests can include template requests including data such as method definitions (e.g., GET, POST, PUT), data payload formats (e.g., JSON, XML), and authentication tokens (e.g., cryptographic keys, session tokens) that align with the access scheme of an endpoint or integration. In some examples, at least one (e.g., each) formatted request can correspond with an operation, such as retrieving a list of resources (e.g., GET or pull request), posting updated configuration data (e.g., PUSH request), and/or executing a scheduled action at the endpoint. In some implementations, at least one formatted request of the one or more formatted requests corresponds with establishing a communication channel with the integration via the at least one DCDSI endpoint. That is, at least one formatted request can include a handshake request used to configure initial communication settings between an integration gateway and DCDSI endpoint. For example, the handshake request can include a structured payload containing and/or otherwise including cryptographic assertions (e.g., digital signatures, encrypted tokens), protocol negotiation parameters (e.g., preferred data transmission rates, session duration limits), and operational directives (e.g., command initiation flags, priority access levels) associated with an access scheme of the endpoint or integration.

In some implementations, at block 1640, the one or more processing circuits can generate and/or otherwise determine configurations of an object package. In some implementations, the one or more processing circuits can generate one or more configurations of an object package corresponding with the at least one formatted request. That is, the object package can include a container or wrapper that organizes instructions, parameters, and/or references associated with at least one DCDSI endpoint request into an executable structure. For example, the one or more processing circuits can generate and/or otherwise provide an object package including concurrency rules, session tokens, scheduled triggers, and/or other values or parameters used to coordinate interactions and/or communication with a DCDSI endpoint. In some examples, the object package can incorporate self-executing logic and/or methods that manage transmission timing, transmit formatted requests to the DCDSI endpoint, and/or process corresponding responses to facilitate communications with the endpoint or integration based on an identified access scheme. In some implementations, object package is structured based on at least the access scheme. For example, the one or more processing circuits can define method references (e.g., GET, POST), data transformation routines (e.g., JSON-to-XML conversion), and/or batch processing triggers (e.g., scheduled data pulls) within the object package. In some examples, the object package can include reusable and/or invokable function references for retrieving, updating, and/or transforming data associated with one or more DCDSI endpoints (e.g., transmitting requests).

In some implementations, at block 1650, the one or more processing circuits can invoke and/or otherwise cause execution of the object package. For example, invoking can include activating and/or otherwise causing the object package to initiate and/or transmit a structured request to a DCDSI endpoint address. That is, the object package can include and/or reference executable code and/or scripts that manage the ordering and timing of request execution and/or transmission during invocation. In some implementations, the one or more processing circuits can invoke the object package to establish the communication channel with the integration by executing a DCDSI endpoint request to the at least one DCDSI endpoint using the at least one formatted request. For example, the one or more processing circuits can establish a communication using a handshake protocol by transmitting a first formatted request structured for the DCDSI endpoint including the public identifier, receiving a response (e.g., challenge) from the DCDSI endpoint requesting a private identifier for validation, and transmitting a second formatted request structured for the DCDSI endpoint including the private identifier. In some examples, a first formatted request can include both the public identifier and the private identifier. In some examples, upon successful validation of the private identifier, the DCDSI endpoint can respond with an acknowledgment and/or token that confirms the establishment of the communication channel with the analysis circuit 136 and/or integration gateway 1510 and authenticates subsequent data exchanges under a defined access scheme associated with the endpoint. That is, the communication channel can facilitate subsequent requests and/or responses between the analysis circuit 136 and/or integration gateway 1510 and one or more endpoints associated with various integrations 1530.

In some implementations, the one or more configurations include one or more access roles or access permissions of the integration. For example, access roles can include or refer to roles and/or categories associated with users and/or devices (e.g., “administrator,” “user,” “guest,” etc.) that define permissions for interacting with the DCDSI endpoint. For example, access permissions can include and/or refer to allowable actions and/or operations (e.g., “read.” “write.” “edit,” “delete”) associated with a category and/or access role. In some examples, the object package can configure API request headers and/or query parameters based on access roles or permissions by inserting and/or embedding data corresponding to the access roles or permissions into an endpoint request and/or by granting or denying access to types of formatted requests based on the access roles or permissions (e.g., providing access to requests to write data to system administrators and restricting access to other roles, etc.).

In some implementations, establishing the communication channel includes registering, by the one or more processing circuits, the public identifier with the at least one DCDSI endpoint. For example, registering can include storing and/or logging a public identifier transmitted via an endpoint request in an access control list (e.g., database that records entities authorized to interact with an endpoint) and/or other data source associated the endpoint. In some examples, registering can include the integrations 1530 and/or integration gateway 1510 transmitting and/or receiving a digital certificate and/or token to validate future requests to the endpoint. In some implementations, establishing the communication channel includes configuring, by the one or more processing circuits, the one or more access roles or access permissions based on the access scheme for the at least one DCDSI endpoint. That is, the one or more processing circuits can associate a public identifier with the DCDSI endpoint and define one or more permission scopes that control access to data or operations within the integration based on defined permissions and/or roles associated with the endpoint or the integration gateway 1510. For example, the one or more processing circuits can adjust the object package and/or formatted requests to include API calls or data requests permissible based on authorized activities designated by an endpoint for at least one (e.g., each) role (e.g., user or device category).

In some implementations, registering the public identifier can include transmitting, by the one or more processing circuits, a registration request based on the one or more formatted requests to the at least one DCDSI endpoint, the registration request including the public identifier. For example, the analysis circuit 136 or integration gateway 1510 can send and/or issue one or more handshake requests. That is, the one or more processing circuits can transmit a structured payload including the public identifier and associated metadata (e.g., endpoint ID, protocol version, etc.) to an address designated for an endpoint. In some implementations, registering the public identifier can include receiving, by the one or more processing circuits, a registration response from the at least one DCDSI endpoint, the registration response including a unique identifier and/or token corresponding to the public identifier. That is, the integrations 1530 can transmit a response to the registration request including a signed token and/or session identifier configured for use in validating future interactions with the DCDSI endpoint. For example, the registration response can include a cryptographic token encoded with endpoint-related attributes, such as access roles and/or communication parameters, used by the DCDSI endpoint to validate and/or process subsequent communications. In some implementations, registering the public identifier can include storing, by the one or more processing circuits, the unique identifier or token in a configuration database or ledger. That is, the one or more processing circuits can log the unique identifier or token in a database or other data source accessible to a DCDSI endpoint and/or the integration gateway 1510. In some examples, storing can include the one or more processing circuits indexing the public identifier or token for subsequent retrieval operations and/or storing the public identifier or token with metadata (e.g., registration date, access roles or permissions, etc.).

In some implementations, configuring the one or more access roles or permissions can include identifying, by the one or more processing circuits, a set of available roles or permissions available to the at least one DCDSI endpoint based on accessing the at least one DCDSI endpoint using the one or more formatted requests. That is, the one or more processing circuits can query the DCDSI endpoint to return one or more available roles or permissions (e.g., “admin” role, “read only” access, “create” permission, etc.) used to manage interactions with the DCSDI endpoint as a response to the query. For example, identifying can include transmitting or sending a discovery request to determine various data associated with the DCDSI endpoint and/or integration using a structured and/or formatted query configured based on parameters associated with the endpoint. In some implementations, configuring the one or more access roles or permissions can include determining, by the one or more processing circuits, the one or more access roles or access permissions from the set of available roles or permissions based at least on the access scheme. That is, the DCDSI endpoint can respond to the discovery request with a data structure and/or payload, and the one or more processing circuits can analyze or process the data structure or payload to extract or identify role names, descriptions, and associated permissions or actions that can be performed at the endpoint (e.g., “view data,” “modify settings,” “access logs,” etc.).

In some implementations, configuring the one or more access roles or permissions can include mapping and/or otherwise associating, by the one or more processing circuits, the one or more access roles or access permissions to the public identifier based on interfacing with the at least one DCDSI endpoint to cause the at least one DCDSI endpoint to apply and/or enforce to the one or more access roles or access permissions responsive to at least one communication corresponding with the public identifier. For example, the one or more processing circuits can associate the public identifier with one or more roles and/or associated actions and enforce access controls by updating the configuration of formatted requests used to access an endpoint or by restricting or granting access to endpoint data or operations based on the assigned roles or permissions. That is, the one or more processing circuits can define or update the structure of an endpoint or DCDSI request to include or exclude one or more operations based on the identified roles or permissions.

In some implementations, determining the access scheme can include transmitting, by the one or more processing circuits, a plurality of self-executing requests to the at least one DCDSI endpoint, and the plurality of self-executing requests can include instructions configured to cause the at least one DCDSI endpoint to retrieve data corresponding with the access scheme. For example, self-executing request can include and/or refer to any pre-configured and/or formatted API calls that initiate one or more data retrieval processes at the DCDSI endpoint. That is, the self-executing requests can be include code and/or scripts to automatically and/or programmatically query the DCDSI endpoint for data such as available permissions, role-based constraints, and/or operational parameters that define access rules within an integration. In some examples, the plurality of self-executing requests can be transmitted at pre-defined intervals (e.g., daily) and/or in response to an event and/or condition (e.g., integration request).

In some implementations, determining the access scheme can include identifying and/or otherwise generating, by the one or more processing circuits, the access scheme based at least on a response to the plurality of self-executing requests from the at least one DCDSI endpoint, and the response can include the data corresponding with the access scheme. For example, the endpoint and/or integration can transmit a response payload and/or data structure defining the access scheme (e.g., structured list of role definitions, permission matrices, access control lists (ACLs), etc.) for identification by the analysis circuit 136 and/or integration gateway 1510. In some examples, the endpoint and/or integration can transmit one or more parameters and/or values (e.g., portions of roles definitions, permission values, subsets of ACLs) used by the analysis circuit 136 and/or integration gateway 1510 to construct and/or otherwise generate the access scheme. In some examples, the one or more processing circuits can query public data repositories, crawl online sources, and/or access internal data sources to supplement and/or generate an access scheme for subsequent endpoint operations (e.g., calls, requests, etc.).

In some implementations, the one or more processing circuits can validate and/or otherwise verify the one or more configurations based on simulating one or more access requests on the at least one DCDSI endpoint to invoke the object package. That is, the analysis circuit 136 and/or integration gateway 1510 can generate test requests configured to simulate and/or mimic various endpoint interactions with an integration (e.g., a push/pull request, read/write request, etc.) using the one or more formatted requests. For example, the one or more processing circuits can transmit one or more structured requests (e.g., JSON objects) including commands, operational parameters, and/or authorization data (e.g., tokens) used to interface with one or more DCDSI endpoints. In some examples, the one or more processing circuits can transmit simulated or test request at pre-determined intervals (e.g., daily, weekly, etc.) and/or in response to a command, event, and/or condition (e.g., detection of errors and/or failures to receive endpoint response, etc.).

In some implementations, invoking the object package to perform validation includes determining and/or otherwise identifying at least one response to the one or more simulated access requests corresponds with an expected access outcome based on the one or more configurations. That is, the one or more analysis circuit 136 or integration gateway 1510 can analyze or identify responses to at least one (e.g., each) simulated request to determine an expected outcome, such as a first expected outcome (e.g., the request has prompted or caused the transmission of a response from the DCDSI endpoint based on determining a response is received) and/or a second expected outcome (e.g., the received response aligns with access permissions or restrictions configured within the analysis circuit 136 and/or integration gateway 1510 and/or the integrations 1530). For example, the one or more processing circuits can verify an expected successful outcome based on identifying that a request to update security posture data including “admin” permissions was successfully performed by the endpoint. That is, an expected outcome can include and/or refer to a denial and/or error response transmitted in response to a non-compliance request (e.g., request to access sensitive configuration data without a defined role and/or permission).

In some implementations, responsive to at least one of (i) failing to receive a response to the one or more simulated access requests from the at least one DCDSI endpoint or (ii) a passage of period of time, the one or more processing circuits can reconfigure and/or otherwise adjust the one or more configurations. For example, failing to receive a response to the simulated access requests can include determining and/or identifying a lack of data transmission from the DCDSI endpoint (e.g., failing to receive endpoint data). In some examples, a passage of a period of time can include and/or refer to a timeout or any interval or duration configured to prompt the one or more processing circuits to reconfigure and/or re-transmit requests (e.g., the passage of 30 seconds, the occurrence of an event or condition, the passage of a dynamic interval, etc.). That is, in sending the one or more simulated access requests, the one or more analysis circuit 136 or integration gateway 1510 can establish an interval (e.g., activate a timer) and reconfigure or update simulated access requests based on failing to receive an endpoint response (e.g., failing to identify data and/or identifying data from one or more sources dissociated with the target endpoint) within the interval.

In some implementations, the one or more processing circuits can reconfigure the one or more configurations by updating one or more parameters of the object package, and the one or more parameters can include rules or settings for generating or transmitting the at least one formatted request to the at least one DCDSI endpoint. That is, reconfiguring can include the analysis circuit 136 or integration gateway 1510 adjusting execution schemes, timeout parameters, and/or command sequences used by the object package to send formatted endpoint requests or simulated requests based detecting a passage of a period of time. For example, the one or more processing circuits can increase and/or decrease the frequency of request dispatches, modify timeout parameters to provide longer response intervals, and/or update command sequences to include additional error-checking steps.

In some implementations, the one or more processing circuits can reconfigure the one or more configurations by updating the access scheme or the one or more formatted requests by modifying one or more fields, values, or structures corresponding with the DCDSI endpoint request. That is, responsive to determining the passage of the period of time, the analysis circuit 136 and/or integration gateway 1510 can adjust the formatted requests and/or simulated requests by changing an endpoint address used to transmit the requests, modifying request headers, restructuring the request format, including additional and/or alternative fields, removing and/or appending data from a payload, adjusting roles or permissions, and/or otherwise updating requests, which can transmitted and/or re-transmitted to the endpoint. In some examples, modifying the one or more fields, values, or structures can include analysis circuit 136 or integration gateway 1510 identifying a formatted request based on comparing fields, values, or structures of previous requests with corresponding fields, values, or structures of candidate requests (e.g., determining templates, structures, or values better aligning with an access scheme of a target DCDSI endpoint).

In some implementations, the one or more processing circuits can re-transmit and/or otherwise provide the one or more access requests to the at least one DCDSI endpoint. That is, the analysis circuit 136 and/or integration gateway 1510 can re-initiate the transmission of adjusted and/or reconfigured access requests to test a responsiveness and/or configurational integrity of the DCDSI endpoint based on the modified requests. For example, the one or more processing circuits can transmit and/or re-transmit a single request and/or a series of requests including updated parameters configured to prompt a response and/or correct an error associated with one or more previous requests. In some implementations, the one or more processing circuits can receive a response from the at least one DCDSI endpoint indicating a validation of the communication channel with the integration. For example, responsive to re-transmitting the requests, the analysis circuit 136 and/or integration gateway 1510 can receive data from integrations 1530 including one or more success codes, status messages, and/or data payloads that confirm and/or indicate an operational readiness and/or capability of the endpoint with applied configurations. For example, the one or more processing circuits can validate the communication channel based on receiving any endpoint response from the DCDSI endpoint or integration. In some examples, the one or more processing circuits can validate the communication channel based on determining a received response aligns with access schemes configured within the integration gateway 1510 and/or associated with the integrations 1530.

In some implementations, responsive to validating the one or more configurations, the one or more processing circuits can provide an indication via a graphical user interface. In some implementations, the indication corresponds to a confirmation of the communication channel established with the integration. That is, the analysis circuit 136 and/or integration gateway 1510 can display a user interface or GUI including one or more graphical elements (e.g., content items, user input fields, images, text, icons, etc.) associated with one or more integrations 1530 on a viewport of client device 110, third party devices 150, and/or another system or device. For example, the indication can include a visual element or graphic (e.g., green check mark, status bar, etc.) and/or text (e.g., a notification message) indicating that a communication channel between the integration gateway 1510 and the target DCDSI endpoint is active and/or operational. In some examples, the one or more processing circuits can use the indication to confirm that the access requests have been successfully transmitted and acknowledged by the DCDSI endpoint following reconfiguration and/or re-transmitting the requests (e.g., to validate success of the tests and/or re-transmitted requests). In some examples, the one or more processing circuits can update the indication in real-time responsive to, subsequent to, and/or based on any event, condition, and/or occurrence (e.g., in response to detecting an endpoint error and/or authentication failure, based on a successful validation and/or integration, etc.).

In some implementations, invoking the object package can include retrieving and/or otherwise identifying, by the one or more processing circuits, the one or more configurations of the object package. That is, the object package can extract and/or load configuration data (e.g., endpoint address, authentication credentials, request formats, operational parameters, etc.) for population and/or transmission via formatted requests to one or more DCDSI endpoints. For example, the analysis circuit 136 or integration gateway 1510 can execute one or more database queries or commands (e.g., parse configuration files) to access or retrieve information corresponding with one or more target endpoints (e.g., access schemes, metadata values, etc.) and programmatically insert (e.g., populate) the accessed or retrieved information into the one or more formatted requests (e.g., request templates).

In some implementations, invoking the object package includes populating and/or otherwise inputting, by the one or more processing circuits, one or more fields or parameters of the at least one formatted request based at least on the access scheme and the one or more configurations, and the one or more fields or parameters can correspond with one or more data structures or instructions configured to cause the at least one DCDSI endpoint to perform one or more cyber resilience operations. That is, the analysis circuit 136 and/or integration gateway 1510 can dynamically populate, update, insert, and/or modify data within pre-formatted request structures to include user roles, permission levels, and/or operational commands configured to initiate and/or prompt cybersecurity measures and/or data synchronization tasks with a DCDSI endpoint or integration. For example, the requests can be populated with data or commands to initiate real-time monitoring or threat analysis operations, process or manage cyber claims, implement and/or configure safeguards and/or security tools, perform incident response and/or remediation actions, purchase a protection plan, analyze historical performance data, and so on.

In some implementations, invoking the object package includes transmitting, by the one or more processing circuits, the at least one formatted request to the at least one DCDSI endpoint. For example, the analysis circuit 136 and/or integration gateway 1510 can encode a template request with endpoint-related data and transmit and/or otherwise provide the request using a network protocol (e.g., HTTPs). For example, the one or more processing circuits can populate fields within the request template by assigning values derived from the object package and the associated configurations, such as by writing an endpoint identifier into a designated address field to route the request to the intended DCDSI endpoint, inserting data into predefined fields corresponding to role identifiers and access control parameters to define the scope of access for the request, and populating command fields with structured instructions that indicate endpoint actions to be executed by the DCDSI endpoint (e.g., push/pull request, etc.). In some examples, populating or transmitting the formatted request(s) can include encoding authentication data (e.g., cryptographically signed tokens) into authorization fields for endpoint security verification.

In some implementations, authenticating access to the integration can include determining, by the one or more processing circuits, the public identifier is stored or maintained in a registry of authorized public identifiers accessible to the integration. That is, one or more of the integrations 1530 can query a database or registry to retrieve and confirm the existence of a public identifier associated with a client device and/or user that transmitted and/or initiated the request. For example, authenticating access to the integration can include the one or more processing circuits validating that the identifier is recognized band authorized for interaction with the DCDSI endpoint based on determining the identifier matches a stored and/or authorized identifier associated with integrations 1530 and recorded in the registry. That is, the one or more processing circuits can fetch a public identifier from an authorized registry and/or data source (e.g., blockchain, ledger storage, database, etc.) associated with integrations 1530 in response to receiving, transmitting, and/or otherwise providing and/or identifying one or more incoming endpoint requests.

In some implementations, authenticating access to the integration can include comparing and/or otherwise modeling, by the one or more processing circuits, the private identifier to a cryptographically hashed value or token stored in association with the public identifier. For example, the one or more processing circuits can apply a cryptographic hashing algorithm (e.g., SHA-256) to generate a hashed identifier and store the hashed identifier in a registry and/or database for comparison with identifiers included in subsequent requests. In another example, the integration gateway 1510 or integrations 1530 can generate or provide an authentication token for inclusion in subsequent requests. In some implementations, authenticating access to the integration can include authenticating, by the one or more processing circuits, the access to the integration based on matching the private identifier and the cryptographically hashed value and/or token. For example, the analysis circuit 136 and/or integration gateway 1510 can validate access by comparing a hash of private identifier received from the request with a list of pre-stored hashes and confirming that the request originates from an authenticated source. In another example, the one or more processing circuits can issue a security token to client and/or third party systems with embedded user permissions and timestamps that can be encrypted with a private key, and the analysis circuit 136 and/or integration gateway can include the security token in subsequent access requests sent to the DCDSI endpoint. Upon receiving a request containing a security token, the analysis circuit 136 and/or integration gateway 1510 can utilize a corresponding public key to decrypt the token, verify the embedded permissions and the timestamp to authenticate the request, and authorize access based on the decrypted data.

### CONFIGURATION OF EXEMPLARY IMPLEMENTATIONS

While this specification contains many specific implementation details and/or implementation details, these should not be construed as limitations on the scope of any implementations or of what can be claimed, but rather as descriptions of features specific to particular implementations and/or implementations of the systems and methods described herein. Certain features that are described in this specification in the context of separate implementations and/or implementations can also be implemented and/or arranged in combination in a single implementation and/or implementation. Conversely, various features that are described in the context of a single implementation and/or implementation can also be implemented and arranged in multiple implementations and/or implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Additionally, features described with respect to particular headings can be utilized with respect to and/or in combination with illustrative implementation described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing can be advantageous. Moreover, the separation of various system components in the implementations and/or implementations described above should not be understood as requiring such separation in all implementations and/or implementations, and it should be understood that the described program components and systems can generally be integrated together in a single software product or packaged into multiple software products.

Having now described some illustrative implementations, implementations, illustrative implementations, and implementations it is apparent that the foregoing is illustrative and not limiting, having been presented by way of example. In particular, although many of the examples presented herein involve specific combinations of method acts or system elements, those acts, and those elements can be combined in other ways to accomplish the same objectives. Acts, elements and features discussed only in connection with one implementation and/or implementation are not intended to be excluded from a similar role in other implementations or implementations.

The phraseology and terminology used herein is for the purpose of description and should not be regarded as limiting. The use of “including” “including” “having” “containing” “involving” “characterized by” “characterized in that” and variations thereof herein, is meant to encompass the items listed thereafter, equivalents thereof, and additional items, as well as alternate implementations and/or implementations consisting of the items listed thereafter exclusively. In one implementation, the systems and methods described herein consist of one, each combination of more than one, or all of the described elements, acts, or components.

Any references to implementations, implementations, or elements or acts of the systems and methods herein referred to in the singular can also embrace implementations and/or implementations including a plurality of these elements, and any references in plural to any implementation, implementation, or element or act herein can also embrace implementations and/or implementations including a single element. References in the singular or plural form are not intended to limit the presently disclosed systems or methods, their components, acts, or elements to single or plural configurations. References to any act or element being based on any information, act or element can include implementations and/or implementations where the act or element is based at least in part on any information, act, or element.

Any implementation disclosed herein can be combined with any other implementation, and references to “an implementation,” “some implementations,” “an alternate implementation,” “various implementation.” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

Any implementation disclosed herein can be combined with any other implementation, and references to “an implementation.” “some implementations,” “an alternate implementation,” “various implementations,” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein can be implemented in other specific forms without departing from the characteristics thereof. Although the examples provided herein relate to controlling the display of content of information resources, the systems and methods described herein can include applied to other environments. The foregoing implementations and/or implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for configuring an integration environment, the method comprising:
receiving, by one or more processing circuits, a request corresponding with at least one decentralized compute and data store interface (DCDSI) endpoint of an integration, wherein the request comprises at least a public identifier and a private identifier;
authenticating, by the one or more processing circuits, access to the integration using at least one of the public identifier or the private identifier;
determining, by the one or more processing circuits, an access scheme of the at least one DCDSI endpoint based at least on the request, wherein the access scheme corresponds with one or more formatted requests for the at least one DCDSI endpoint, and wherein at least one formatted request of the one or more formatted requests corresponds with establishing a communication channel with the integration via the at least one DCDSI endpoint;
generating, by the one or more processing circuits, one or more configurations of an object package corresponding with the at least one formatted request, wherein the object package is structured based on at least the access scheme; and
invoking, by the one or more processing circuits, the object package to establish the communication channel with the integration by executing a DCDSI endpoint request to the at least one DCDSI endpoint using the at least one formatted request.

2. The method of claim 1, wherein the one or more configurations comprise one or more access roles or access permissions of the integration, and wherein establishing the communication channel comprises:
registering, by the one or more processing circuits, the public identifier with the at least one DCDSI endpoint; and
configuring, by the one or more processing circuits, the one or more access roles or access permissions based on the access scheme for the at least one DCDSI endpoint.

3. The method of claim 2, wherein registering the public identifier comprises:
transmitting, by the one or more processing circuits, a registration request based on the one or more formatted requests to the at least one DCDSI endpoint, the registration request comprising the public identifier;
receiving, by the one or more processing circuits, a registration response from the at least one DCDSI endpoint, the registration response comprising a unique identifier or token corresponding to the public identifier; and
storing, by the one or more processing circuits, the unique identifier or token in a configuration database or ledger.

4. The method of claim 2, wherein configuring the one or more access roles or access permissions comprises:
identifying, by the one or more processing circuits, a set of available roles or permissions available to the at least one DCDSI endpoint based on accessing the at least one DCDSI endpoint using the one or more formatted requests;
determining, by the one or more processing circuits, the one or more access roles or access permissions from the set of available roles or permissions based at least on the access scheme; and
mapping, by the one or more processing circuits, the one or more access roles or access permissions to the public identifier based on interfacing with the at least one DCDSI endpoint to cause the at least one DCDSI endpoint to apply or enforce to the one or more access roles or access permissions responsive to at least one communication corresponding with the public identifier.

5. The method of claim 1, wherein determining the access scheme comprises:
transmitting, by the one or more processing circuits, a plurality of self-executing requests to the at least one DCDSI endpoint, wherein the plurality of self-executing requests comprise instructions configured to cause the at least one DCDSI endpoint to retrieve data corresponding with the access scheme; and
identifying or generating, by the one or more processing circuits, the access scheme based at least on a response to the plurality of self-executing requests from the at least one DCDSI endpoint, wherein the response comprises the data corresponding with the access scheme.

6. The method of claim 1, further comprising:
validating, by the one or more processing circuits, the one or more configurations based on simulating one or more access requests on the at least one DCDSI endpoint to invoke the object package, wherein invoking the object package to perform validation comprises determining at least one response to the one or more simulated access requests corresponds with an expected access outcome based on the one or more configurations.

7. The method of claim 6, further comprising:
responsive to at least one of (i) failing to receive a response to the one or more simulated access requests from the at least one DCDSI endpoint or (ii) a passage of period of time, reconfiguring, by the one or more processing circuits, the one or more configurations by at least one of:
updating one or more parameters of the object package, wherein the one or more parameters comprise rules or settings for generating or transmitting the at least one formatted request to the at least one DCDSI endpoint; or
updating the access scheme or the one or more formatted requests by modifying one or more fields, values, or structures corresponding with the DCDSI endpoint request;
re-transmitting, by the one or more processing circuits, the one or more access requests to the at least one DCDSI endpoint; and
receiving, by the one or more processing circuits, a response from the at least one DCDSI endpoint indicating a validation of the communication channel with the integration.

8. The method of claim 7, further comprising:
responsive to validating the one or more configurations, providing, by the one or more processing circuits, an indication via a graphical user interface, wherein the indication corresponds to a confirmation of the communication channel established with the integration.

9. The method of claim 1, wherein invoking the object package comprises:
retrieving, by the one or more processing circuits, the one or more configurations of the object package;
populating, by the one or more processing circuits, one or more fields or parameters of the at least one formatted request based at least on the access scheme and the one or more configurations, wherein the one or more fields or parameters correspond with one or more data structures or instructions configured to cause the at least one DCDSI endpoint to perform one or more cyber resilience operations; and
transmitting, by the one or more processing circuits, the at least one formatted request to the at least one DCDSI endpoint.

10. The method of claim 1, wherein authenticating access to the integration comprises:
determining, by the one or more processing circuits, the public identifier is stored or maintained in a registry of authorized public identifiers accessible to the integration;
comparing, by the one or more processing circuits, the private identifier to a cryptographically hashed value or token stored in association with the public identifier; and
authenticating, by the one or more processing circuits, the access to the integration based on matching the private identifier and the cryptographically hashed value or token.

11. A system for configuring an integration environment, the system comprising:
one or more processing circuits configured to:
receive a request corresponding with at least one decentralized compute and data store interface (DCDSI) endpoint of an integration, wherein the request comprises at least a public identifier and a private identifier;
authenticate access to the integration using at least one of the public identifier or the private identifier;
determine an access scheme of the at least one DCDSI endpoint based at least on the request, wherein the access scheme corresponds with one or more formatted requests for the at least one DCDSI endpoint, and wherein at least one formatted request of the one or more formatted requests corresponds with establishing a communication channel with the integration via the at least one DCDSI endpoint;
generate one or more configurations of an object package corresponding with the at least one formatted request, wherein the object package is structured based on at least the access scheme; and
invoke the object package to establish the communication channel with the integration by executing a DCDSI endpoint request to the at least one DCDSI endpoint using the at least one formatted request.

12. The system of claim 11, wherein the one or more configurations comprise one or more access roles or access permissions of the integration, and wherein to establish the communication channel, the one or more processing circuits are configured to:
register the public identifier with the at least one DCDSI endpoint; and
configure the one or more access roles or access permissions based on the access scheme for the at least one DCDSI endpoint.

13. The system of claim 12, wherein to register the public identifier, the one or more processing circuits are configured to:
transmit a registration request based on the one or more formatted requests to the at least one DCDSI endpoint, the registration request comprising the public identifier;
receive a registration response from the at least one DCDSI endpoint, the registration response comprising a unique identifier or token corresponding to the public identifier; and
store the unique identifier or token in a configuration database or ledger.

14. The system of claim 12, wherein to configure the one or more access roles or access permissions, the one or more processing circuits are configured to:
identify a set of available roles or permissions available to the at least one DCDSI endpoint based on accessing the at least one DCDSI endpoint using the one or more formatted requests;
determine the one or more access roles or access permissions from the set of available roles or permissions based at least on the access scheme; and
map the one or more access roles or access permissions to the public identifier based on interfacing with the at least one DCDSI endpoint to cause the at least one DCDSI endpoint to apply or enforce to the one or more access roles or access permissions responsive to at least one communication corresponding with the public identifier.

15. The system of claim 11, wherein to determine the access scheme, the one or more processing circuits are configured to:
transmit a plurality of self-executing requests to the at least one DCDSI endpoint, wherein the plurality of self-executing requests comprise instructions configured to cause the at least one DCDSI endpoint to retrieve data corresponding with the access scheme; and
identify or generate the access scheme based at least on a response to the plurality of self-executing requests from the at least one DCDSI endpoint, wherein the response comprises the data corresponding with the access scheme.

16. The system of claim 11, the one or more processing circuits configured to:
validate the one or more configurations based on simulating one or more access requests on the at least one DCDSI endpoint to invoke the object package, wherein invoking the object package to perform validation comprises determining at least one response to the one or more simulated access requests corresponds with an expected access outcome based on the one or more configurations.

17. The system of claim 16, wherein to validate, the one or more processing circuits are configured to:
generate the one or more simulated access requests by modifying the one or more formatted requests based on the one or more configurations; and
determine the one or more configurations are validated based at least on receiving a response to the one or more simulated access requests from the at least one DCDSI endpoint.

18. The system of claim 16, the one or more processing circuits configured to:
responsive to at least one of (i) failing to receive a response to the one or more access requests from the at least one DCDSI endpoint or (ii) a passage of period of time, reconfigure the one or more configurations by at least one of:
updating one or more parameters of the object package, wherein the one or more parameters comprise rules or settings for generating or transmitting the at least one formatted request to the at least one DCDSI endpoint; or
updating the access scheme or the one or more formatted requests by modifying one or more fields, values, or structures corresponding with the DCDSI endpoint request;
re-transmit the one or more access requests to the at least one DCDSI endpoint; and
receive a response from the at least one DCDSI endpoint indicating a validation of the communication channel with the integration.

19. The system of claim 18, the one or more processing circuits configured to:
responsive to validating the one or more configurations, provide an indication via a graphical user interface, wherein the indication corresponds to a confirmation of the communication channel established with the integration.

20. A non-transitory computer-readable medium (CRM) comprising one or more instructions stored thereon and executable by one or more processors to:
receive a request corresponding with at least one decentralized compute and data store interface (DCDSI) endpoint of an integration, wherein the request comprises at least a public identifier and a private identifier;
authenticate access to the integration using at least one of the public identifier or the private identifier;
determine an access scheme of the at least one DCDSI endpoint based at least on the request, wherein the access scheme corresponds with one or more formatted requests for the at least one DCDSI endpoint, and wherein at least one formatted request of the one or more formatted requests corresponds with establishing a communication channel with the integration via the at least one DCDSI endpoint;
generate one or more configurations of an object package corresponding with the at least one formatted request, wherein the object package is structured based on at least the access scheme; and
invoke the object package to establish the communication channel with the integration by executing a DCDSI endpoint request to the at least one DCDSI endpoint using the at least one formatted request.
